(19) United States
(12) Patent Application Publication
(10) Pub. No.: US 2003/0037287 A1
(43) Pub. Date: Feb. 20, 2003

(54) Electronic apparatus, data communication device, management system of electronic apparatus, and management method of electronic apparatus

(76) Inventors: Masakatsu Nakamura, Kashihara-shi (JP); Yasuhiro Nakai, Soraku-gun (JP)

Correspondence Address: Dike, Bronstein, Roberts & Cushman, LLP, 130 Water Street, Boston, MA, 02109, US

(21) Appl. No.: 09/961,812

(22) Filed: Sep. 24, 2001

(30) Foreign Application Priority Data
Sep. 25, 2000 (JP) 2000-291283
Sep. 5, 2001 (JP) 2001-269564

(51) Int. Cl. B41J 29/38; H04L 1/22

(52) U.S. Cl. 714/30

(57) ABSTRACT

A management system of the present invention includes an electronic apparatus having a specific function, such as a digital composite machine and a predetermined receiving end to be connected to the electronic apparatus via a network. The digital composite machine includes a self-diagnosis section for performing the self-diagnosis of a state thereof and preparing a self-diagnostic result, and an electronic mail communications section for transmitting apparatus data including the self-diagnostic result by electronic mail, and is capable of changing a receiving end of apparatus data according to the self-diagnostic result. With this structure, it is possible to surely obtain a state of said electronic apparatus as digital data, and to utilize the digital data appropriately, thereby realizing more appropriate management of the electronic apparatus than the conventional management system. As a result, a management system and a management method of an electronic apparatus which permits the electronic apparatus to be managed more appropriately by effectively utilizing beneficial features of an electronic mail.

### FIELD OF THE INVENTION

The present invention generally relates to an electronic apparatus, a data communication device connectible to electronic apparatus, a management system of electronic apparatus, and a management method of electronic apparatus, and more particularly relates to an electronic apparatus, whose beneficial features can be appreciated in its application to such apparatus as an image forming apparatus which requires in an event of an occurrence of failure, services of highly advanced techniques to be provided by a service personnel, for example, to correct the failure, and which is capable of automatically communicating various data useful to provide such services, a data communication device connectible to such electronic apparatus, and a management system and a management method of same.

### BACKGROUND OF THE INVENTION

Recently, many attempts have been made to realize various functions by connecting a computer, a printer, and other various electronic apparatuses to network such as a LAN, etc., other than simply transmitting data via network. Particularly, various techniques have been proposed which permit the electronic apparatus to be managed effectively by utilizing an electronic mail function. For example, Japanese Patent No. 2707459 (Japanese Laid-Open Patent Publication No. 2-172348/1990 (Tokukaihei 2-172348, published on Jul. 3, 1990)) discloses a facsimile apparatus provided with interface means having an electronic mail function, so that the facsimile apparatus is connected to a network via the interface means. In the above patent, the facsimile apparatus is used as the electronic apparatus.

In case a transmitter of image data inputs a user's identification data used in the computer network as transmitter's identification data (transmitter's ID data), the facsimile apparatus prepares transmission result report data that reports a transmission result after the transmission of the image data is completed, then transmits the transmission result report data in a form of electronic mail addressed to the transmitter's ID data via the computer network. Furthermore, in case the facsimile is received, when identification data (receiver's ID data) of a receiver is notified before the transmission, the facsimile apparatus prepares receipt result report data that reports a receipt result after completion of receiving the image data, then sends the receipt result report data in a form of electronic mail addressed to the receiver's ID data via the computer network, at the same time the transmission result report data is sent via the computer network.

With the above arrangement, when a facsimile message is transmitted or received by a user of the computer network which is connected to the facsimile apparatus, the transmission result and the receipt result are automatically sent respectively to the transmitter or the receiver from the facsimile apparatus. This allows the transmitter and the receiver to surely obtain the data regarding the transmission or the receipt of the image data by checking receipt of an electronic mail at their computers, without travelling to a place where the facsimile apparatus is located.

Moreover, Japanese Laid-Open Patent Publication No. 2000-181302/2000 (Tokukai 2000-181302, published on Jun. 30, 2000) discloses an image forming apparatus management system, in which a plurality of image forming apparatuses and a central management apparatus equipped with a computer are connected via a public communication network, a communication adaptor, and a wire or wireless interface, for performing central management of each image forming apparatus by using the central management apparatus.

The image forming apparatus management system has main objects to reduce a number of communication lines, communication period and a communication charge, and to shorten a processing time of the central management apparatus. To achieve the objects, each image forming apparatus is provided with data management means, while data recording means, data processing means and data transmission mean for reporting no data acquisition are provided in a management terminal to be connected to the communication adaptor. Further, the central management apparatus is provided with data transmission means for reporting a service request.

The image forming apparatus uses data management means, which is provided in the image forming apparatus, so as to manage usage data of the image forming apparatus, while outputting return mail data, which shows the usage data, upon receipt of data reading instructions from the management terminal.

The management terminal, to begin with, records in the data recording means data on types of the image forming apparatuses, the usage data, and data including data collection date or data accumulation date. Then, the management terminal automatically sends data reading instructions to each image forming apparatus on the data collection date or the data accumulation date, or a few days before that. The data processing means collects or accumulates the return mail data respectively outputted from the data management means of each image forming apparatus. Meanwhile, if no return mail data is acquired, the data transmission means for reporting no data acquisition automatically sends reporting data for reporting no data acquisition to the central management apparatus.

The central management apparatus is arranged to use the data transmission means for reporting service request so as to automatically send, to outside, a reporting data for requesting a service to find out a cause that has prevented the management terminal from acquiring the return mail data, and a correction service, when the central management apparatus receives the reporting data for reporting no data acquisition. The transmission of the reporting data can be carried via electronic mail.

The above arrangement, where the management terminal collects and accumulates the return mail data from each image forming apparatus on the predetermined data collection date or data accumulation date, reduces the number of the communication lines, the communication period, and shortens operation time, such as data processing time of the central management apparatus. Moreover, when no return mail data is acquired, the reporting data for reporting no data acquisition is automatically sent to the central management apparatus, so that the central management apparatus automatically requests a service department, for example via electronic mail as mentioned above, to do the service to find the cause preventing the data acquisition, and the correction service. This makes it possible to solve the problem of no data acquisition in a short time, even when no data is acquired.

By the way, electronic mail is so advantageous, for example, because: its transmission time is relatively short; it is easy to return electronic mail; it is simple to save and reusing electronic mail as data; and electronic mail can be transmitted or received regardless of a situation of the receiver. Therefore, the advantages of electronic mail may be utilized to manage an electronic apparatus, but no method of managing the electronic apparatus, which effectively utilizes the advantages of electronic mail for managing an electronic apparatus, has been suggested.

For example, in the technique disclosed in the Japanese Patent No. 2707459, electronic mail, as a subsidiary means to a facsimile apparatus, is utilized for informing a result of transmission and reception that has been performed by the facsimile apparatus, that is, simply for sending to a personal computer the result of the transmission and reception performed by the facsimile apparatus.

Similarly, in the technique disclosed in Japanese Laid-Open Patent Publication No. 2000-181302, electronic mail is used only for communication between a central management apparatus and the service department. In other words, electronic mail is used only when caused is a trouble such as no data is acquired.

Therefore, in the technique disclosed in those Patent and Publications, electronic mail does not play a principal role for managing the electronic apparatus. Thus, in any of the foregoing conventional techniques, the electronic mail is not utilized effectively.

Furthermore, even when electronic mail is used, there is no significant difference between a conventional management method without using electronic mail and the management method in which electronic mail is used, if the use of electronic mail is limited to simple transmission of data. Besides those advantages mentioned above, electronic mail has another advantage that electronic mail realizes a high speed and reliable communication with a remote location. Therefore, it is expected that electronic mail can be utilized in a management system for a sure management of an electronic apparatus at a remote location. However, simple use of electronic mail cannot realize such remote management system.

For example, where a management system is provided with the image forming apparatus as the electronic apparatus so as to send an electronic mail from the image forming apparatus to a manager (a service provider), the manager receives such an electronic mail message indicative of “out of sheet” or “out of toner”, from the image forming apparatus. In this way, the manager can supply sheet or toner in accordance with the notice, or can manage consumable supply such as sheet or toner so that he can place an order for the consumable supply (for example, by telephone), if necessary in accordance with the notice. In this case, however, the use of electronic mail makes no significant improvement, thereby failing to make a significant difference from the conventional management method or management system.

Therefore, even if electronic mail is used to communicate in the management system for managing the electronic apparatus, the management system is not a remote management system that enable the service provider to response surely to the needs of the electronic apparatus with much consideration of the needs of the user.

In addition, in the technique disclosed in Japanese Laid-Open Patent Publication No. 2000-181302, the service is provided only in the case where no return mail data is received from the image forming apparatus. Thus, the service is provided without determining whether the image forming apparatus itself has a problem in terms of maintenance, or the image forming apparatus has a trouble. In short, the main objects of the technique of the publication are to reduce the number of the communication lines, the communication period, and the data processing time, but the technique is not for providing a proper service to effectively solve the problem the electronic apparatus has.

Therefore, the above techniques are inadequate as a management system of the electronic apparatus, such as the image forming apparatus, which requires delicate and sophisticated services for maintenance or in an event of some failure.

### SUMMARY OF THE INVENTION

It is an object of the present invention to provide a management method of an electronic apparatus which is capable of managing the electronic apparatus appropriately by effectively utilizing advantageous features of an electronic mail, and also to provide an electronic apparatus suited for the management method, and a management system of the electronic apparatus, a program for the management system, a recording medium storing the program, and a data communication device.

In order to achieve the above object, the management method of an electronic apparatus in accordance with the present invention is arranged so as to include the steps of:

i) determining by the electronic apparatus a receiving end of a current communication process among a predetermined plurality of receiving ends according to at least either one of a) a state of the electronic apparatus and b) a time at which the apparatus data is to be informed; and

ii) preparing an electronic mail including apparatus data indicative of the state of the electronic apparatus and transmitting the electronic mail to the receiving end determined by the step i).

In order to achieve the above object, an electronic apparatus in accordance with the present invention is arranged so as to include:

a mail preparation section for preparing an electronic mail including the apparatus data indicative of a state of the electronic apparatus;

a receiving end determination section for determining a receiving end of a current communication process among a predetermined plurality of receiving ends according to at least either one of a) a current state of the electronic apparatus and b) a time at which the apparatus data is to be informed; and

a mail transmission section for transmitting the electronic mail to the receiving end determined by the receiving end determination section.

According to the foregoing structure, the receiving end of a current communication process is determined according to at least either a) a state of the electronic apparatus or b) a time at which the apparatus data is to be informed. Further, the apparatus data of the electronic apparatus is transmitted to the receiving end as determined by electronic mail, i.e., in digital data.

According to the foregoing arrangement, it is possible to surely inform the state of the electronic apparatus in which a failure has occurred to the receiving end as selected from among the plurality of receiving ends, which is capable of promptly managing the failure of the electronic apparatus. It is therefore possible for each receiving end to provide an appropriate service such as to correct the failure of the electronic apparatus, for example, by sending a salesperson, or a service personnel, etc. As a result, the management system and the management method of the present invention can always provide an appropriate service required for dealing with the current situation of the electronic apparatus in an efficient manner, thereby managing the electronic apparatus in a prompt and appropriate manner.

In order to achieve the above object, another management method of an electronic apparatus of the present invention is arranged so as to include the steps of:

i) when a data management device receives from the electronic apparatus an electronic mail including apparatus data indicative of a state of the electronic apparatus, determining by the data management device a receiving end of a current communication process among a predetermined plurality of receiving ends according to at least either a) the apparatus data or b) a time at which the apparatus data is to be informed; and

ii) preparing based on the apparatus data, an electronic mail including instruction data to be reported to the receiving end determined in the step i), and transmitting the electronic mail to the receiving end.

In order to achieve the above object, a management system of an electronic apparatus is arranged so as to include:

a receiving end determination section provided in a data management device, for determining a receiving end of a current communication process among a predetermined plurality of receiving ends according to at least either one of a) apparatus data indicative of a state of the electronic apparatus, and b) a time at which the apparatus data is to be informed, when receiving an electronic mail including the apparatus data indicative of the state of the electronic apparatus; and

an instruction data preparation section for preparing an electronic mail including instruction data to be informed to the predetermined receiving end based on the received apparatus data.

According to the foregoing arrangement, instead of determining the receiving end by the electronic apparatus based on its state or b) a time at which the apparatus data is to be informed, the receiving end of a current communication process is determined by the receiving end determination section provided in the data management device which receives an electronic mail from the electronic apparatus, according to at least one of apparatus data included in the electronic mail and a time at which the apparatus data is to be informed.

With the foregoing arrangement, as in the above management method of the electronic apparatus and the electronic apparatus, it is possible to surely inform the state of the electronic apparatus in which, for example, a failure has occurred to the receiving end, which is capable of promptly managing, for example, the failure of the electronic apparatus or providing other service to the electronic apparatus. It is therefore possible for each receiving end to provide an appropriate service such as to correct the failure of the electronic apparatus, for example, by sending a salesperson, or a service personnel, etc. As a result, the management system and the management method of the present invention can always provide an appropriate service for the current state of the electronic apparatus in an efficient manner, thereby managing the electronic apparatus quickly and appropriately.

The management method of an electronic apparatus having the foregoing arrangement of the present invention may be arranged so as to further include the step of:

iii) extracting data related to the received apparatus data from database in which stored are data related to apparatus data which are possible to be transmitted and adding the data as extracted to the instruction data. Similarly, the management system of an electronic apparatus of the present invention having the foregoing arrangement may be further arranged such that the instruction data preparation section extracts data related to the received apparatus data from database in which stored are data related to apparatus data which are possible to be transmitted to be included in the instruction data.

According to the foregoing arrangement, from the database for storing therein the data related to the apparatus data which are possible to be transmitted, the data related to the actually received apparatus data is extracted to be included in the instruction data. As a result, even if some effective data is not included in the apparatus data transmitted by the electronic apparatus which performs necessary services, the data can be compensated by extracting the necessary data from the database, and it is thus possible for the receiver of the secondary receiving end to obtain more useful instruction data to provide more appropriate services as compared to the case of receiving only the apparatus data.

Further, as long as the sufficient apparatus data for the preparation of the instruction data can be transmitted, it is not necessarily to transmit all the effective data for the necessary service. Generally, it is thus possible to reduce the required storage capacity for the electronic apparatus which are expected to be provided in larger numbers than the data management device or the database.

The management system of an electronic apparatus having the foregoing arrangement of the present invention may be arranged such that the database stores therein history data of the electronic apparatus, and

the management system further includes a registration section for registering in the database data related to the instruction data as history data.

According to the foregoing arrangement, the registration section registers as history data, the data related to the instruction data prepared according to the apparatus data received by the receiving end determination section. Therefore, even in the arrangement where a plurality of receiving ends are set, and thus the electronic apparatus is not necessarily be managed consistently by the receiver at the same receiving end, all the data related to the instruction data are collected in the database, and thus the electronic apparatus can be managed reliably. As a result, it is possible for the receiver at the receiving end to systematically recognize the current situation of the electric apparatus including the services performed by other receiver in the past.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram illustrating an example where a management system of an electronic apparatus of a first embodiment of the present invention is employed for managing a digital composite machine;

FIG. 2 is an explanatory view illustrating a state where apparatus data is transmitted by electronic mail in the management system of FIG. 1;

FIG. 3 is an explanatory view illustrating a state where apparatus data is transmitted by electronic mail after selecting a receiving end among a plurality of receiving ends in the management system of FIG. 1;

FIG. 4 is an explanatory view illustrating a state where apparatus data is transmitted to both of two receiving ends by electronic mail in the management system of FIG. 1;

FIG. 5 is an explanatory view illustrating a state of confirming a user if apparatus data is to be transmitted before transmitting the apparatus data to a receiving end by electronic mail in a management system of an electronic apparatus of a second embodiment of the present invention;

FIG. 6 is a block diagram illustrating an example where a management system of an electronic apparatus of a third embodiment of the present invention is employed for managing a digital composite machine;

FIG. 7 is an explanatory view illustrating a state where a receiving end is selected based on time in the management system of FIG. 6;

FIG. 8 is an explanatory view wherein a plurality of digital composite machines and a plurality of receiving ends are provided in a management system of an electronic apparatus of a fourth embodiment of the present invention;

FIG. 9 is an explanatory view wherein a receiving end is selected according to a type of a digital composite machine different from the case of FIG. 8;

FIG. 10 is a block diagram illustrating an example where a management system of an electronic apparatus of a fifth embodiment of the present invention is employed for managing a digital composite machine;

FIG. 11 is an explanatory view illustrating a state where instruction data is transmitted to a mobile of a secondary receiving end by electronic mail, after apparatus data is once transmitted to a service center from a plurality of digital composite machines by electronic mail in the management system of FIG. 10;

FIG. 12 is an explanatory view illustrating a state of transmitting the instruction data by electronic mail in more detail in the management system of FIG. 10;

FIG. 13 is a block diagram illustrating an example where a management system of an electronic apparatus of a sixth embodiment of the present invention is employed for managing a digital composite machine;

FIG. 14 is an explanatory view illustrating a state of transmitting the instruction data having added thereto additive data based on a support record table by electronic mail in more detail in the management system of FIG. 13;

FIG. 15 is an explanatory view illustrating a state where following the former instruction data, the latter instruction data is transmitted by electronic mail in the management system of an electronic apparatus in accordance with a seventh embodiment of the present invention;

FIG. 16 is a block diagram illustrating an example where a management system of an electronic apparatus of an eighth embodiment of the present invention is employed for managing a digital composite machine;

FIG. 17 is an explanatory view illustrating a state where return mail data is transmitted to the digital composite machine by electronic mail in the management system of FIG. 16;

FIG. 18 is an explanatory view illustrating one concrete example of the return mail data in the management system of FIG. 16;

FIG. 19 is an explanatory view illustrating another concrete example of the return mail data in the management system of FIG. 16;

FIG. 20 is an explanatory view illustrating still another concrete example of the return mail data in the management system of FIG. 16;

FIG. 21 is an explanatory view illustrating a state where secondary return mail data is transmitted from a secondary receiving end to a service center by electronic mail in the management system of an electronic apparatus in accordance with the ninth embodiment of the present invention;

FIG. 22 is a block diagram illustrating an example where a management system of an electronic apparatus of a tenth embodiment of the present invention is employed for managing a digital composite machine;

FIG. 23 is an explanatory view which explains a process of providing service in response to a support request in the case where the same trouble has occurred again in the management system of FIG. 22;

FIG. 24 is an explanatory view which explains another process of providing service in response to a support request in the case where the same trouble has occurred again in the management system of FIG. 22;

FIG. 25 is a block diagram illustrating an example where a management system of an electronic apparatus of an eleventh embodiment of the present invention is employed for managing a digital composite machine;

FIG. 26 is an explanatory view illustrating an example where an abnormality occurrence time and an abnormality correction time are stored as history data in the management system of FIG. 25;

FIG. 27 is an explanatory view illustrating another example where an abnormality occurrence time and an abnormality correction time are stored as history data in the management system of FIG. 25;

FIG. 28 is an explanatory view illustrating still another example of stored history data in the management system of FIG. 25;

FIG. 29 is an explanatory view illustrating an ability of each service personnel estimated from history data of FIG. 28;

FIG. 30 is a block diagram illustrating an example where a management system of an electronic apparatus of a twelfth embodiment of the present invention is employed for managing a digital composite machine;

FIG. 31 is a block diagram illustrating an example where one data communication device is connected to a plurality of digital composite machines in the management system of FIG. 30;

FIG. 32 is a block diagram illustrating an example where a management system of an electronic apparatus of a thirteenth embodiment of the present invention is employed for managing a digital composite machine;

FIG. 33 is an explanatory view illustrating how operation data is prepared and transmitted and how the service is provided to a user in response, in the management system of FIG. 32;

FIG. 34 is a block diagram illustrating an example where a management system of an electronic apparatus of a fourteenth embodiment of the present invention is employed for managing a digital composite machine;

FIG. 35 is an explanatory view illustrating how operation data of proper service is prepared and transmitted and how the service is provided to a user in response, in the management system of FIG. 34;

FIG. 36 is an explanatory view illustrating how operation data of improper service is prepared and transmitted and how the service is provided to a user in response, in the management system of FIG. 34;

FIG. 37 is an explanatory view illustrating how operation data of improper service is prepared and transmitted, and how the service is provided to a user in response, in the management system for an electronic apparatus of a fifteenth embodiment of the present invention;

FIG. 38 is a block diagram illustrating an example where a management system for an electronic apparatus of a sixteenth embodiment of the present invention is employed for managing a digital composite machine;

FIG. 39(a) is an explanatory view illustrating an operation panel when operation data by self-diagnosis is prepared in advance as operation data, while

FIG. 39(b) is an explanatory view illustrating an operation panel when prepared as operation data is operation data is prepared by a user who has judged a result of service;

FIG. 40 is a block diagram where a management system of an electronic apparatus of a seventeenth embodiment of the present invention is employed for managing a digital composite machine;

FIG. 41 is an explanatory view illustrating how operation data is prepared and transmitted, and how service is provided to a user in response, in the management system of FIG. 40;

FIG. 42 is an explanatory view illustrating how operation data is prepared and transmitted, and how service is provided to a user in response, in a management system for an electronic apparatus in accordance with an eighteenth embodiment of the present invention;

FIG. 43 is a block diagram illustrating an example where a management system for an electronic apparatus of a nineteenth embodiment of the present invention is employed for managing a digital composite machine;

FIG. 44 is a block diagram illustrating an essential structure of data management device in the management system for the electronic apparatus in accordance with the thirteenth embodiment of the present invention;

FIG. 45 is an explanatory view illustrating how operation data is prepared and transmitted, and how service is provided to a user in response, in the management system for the electronic apparatus of a twentieth embodiment of the present invention;

FIG. 46 is an explanatory view illustrating jam frequency log stored in a memory of a digital composite machine in a management system for an electronic apparatus of a twenty-first embodiment of the present invention;

FIG. 47 is an explanatory view illustrating the jam frequency log when more than one trouble have occurred in the management system for the electronic apparatus;

FIG. 48 is a block diagram illustrating an example where a management system for an electronic apparatus of a twenty-second embodiment of the present invention is employed for managing a digital composite machine;

FIG. 49 is an explanatory view illustrating a receiving end of a notice of a printer inferior to be stored in memory of a digital composite machine in the management system of the electronic apparatus of FIG. 48;

FIG. 50, which illustrates an example where a management system of an electronic apparatus of a twenty-third embodiment of the present invention is employed for managing a digital composite machine, is an explanatory view explaining units attachable to a digital composite machine main body, and notices informing a user of an attachment of each unit;

FIG. 51 is a block diagram illustrating an example where the management system for the electronic apparatus is employed for managing the digital composite machine of FIG. 50;

FIG. 52 is an explanatory view illustrating how operation data is prepared and transmitted when a printer board is attached to the digital composite machine main body of FIG. 50; and

FIG. 53 is an explanatory view illustrating how operation condition is notified and how operation data is prepared and transmitted, when an automatic document feeder is attached to the digital composite machine main body.

### DESCRIPTION OF THE EMBODIMENTS

[First Embodiment]

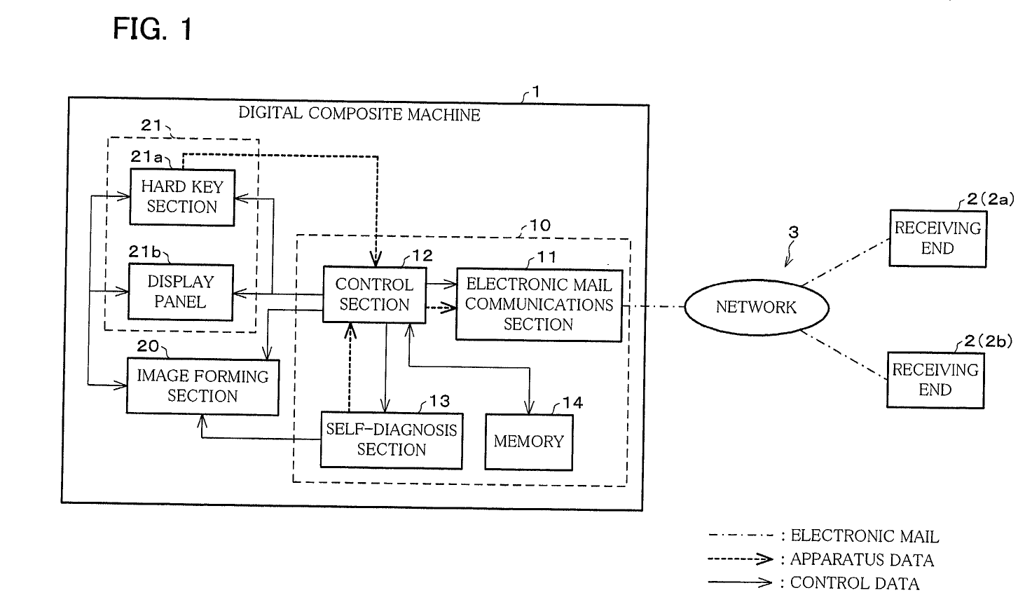

The following descriptions will explain the first embodiment of the present invention in reference to FIGS. 1 to 4. It should be noted however that the present invention is not intended to be limited to the structure of the present embodiment.

A management system of an electronic apparatus in accordance with the present invention includes an electronic apparatus having a specific function, and a predetermined receiving end to be connected to the electronic apparatus via a network. Further, the electronic apparatus performs a self-diagnosis and prepares a self-diagnostic result thereof, and then prepares apparatus data including the self-diagnostic result and transmits the apparatus data to the predetermined receiving end by electric mail. Therefore, it is possible to appropriately manage the electronic apparatus at the receiving end, and even if some failure occurs in the electronic apparatus, it is possible to reliably deal with the situation to correct such failure.

In the present embodiment, explanations will be given through the case of adopting as an electronic apparatus having a specific function to which the management system of an electronic apparatus of the present invention can be applied, a digital composite-type image forming apparatus (hereinafter referred to as a digital composite machine) having at least two of a copy function, a facsimile function, and a printer function. In the present embodiment, the present invention will be explained in details through the case of the management system of the digital composite machine.

For the image forming apparatus, a failure such as a drop in image quality, a paper jam (jammed sheet), etc., is liable to occur. Further, in the image forming apparatus, the management as to the maintenance of consumable supplies such as toner, etc., is also important. As described, the image forming apparatus requires delicate services, and thus the beneficial features of the management system of the present invention can be appreciated particularly in its application to the image forming apparatus.

As illustrated in FIG. 1, the management system of a digital composite machine (hereinafter may be referred to as a management system) includes a digital composite machine 1 and a receiving end 2 (two in the structure of FIG. 1) connected to the digital composite machine 1 via a network 3. The digital composite machine 1 is provided with a data communication section 10, and the digital composite machine 1 is connected to the network 3. For the network 3, various types of computer networks may be adopted, such as internet.

The data communication section 10 includes an electronic mail communications section 11, a control section 12, a self-diagnosis section 13, and memory 14. The electronic mail communications section 11 is connected to the network 3, and is capable of transmitting data to the predetermined receiving end 2 by electronic mail. The control section 12 controls the transmission of electric mail in accordance with an operation of an image forming section 20 of the digital composite machine 1. The self-diagnosis section 13 at least performs a self-diagnosis of the state of the image forming section 20.

The electronic mail communications section 11 transmits apparatus data (to be described later) to the receiving end 2 by electronic mail. The control section 12 prepares the apparatus data based on the self-diagnostic result Me obtained by the self-diagnosis section 13 and controls the transmission of electronic mail. However, to be described later, the control section 12 controls overall operations of the digital composite machine 1. The self-diagnosis section 13 prepares the self-diagnostic result Me to be included at least in the apparatus data. In the memory 14, stored are various data for use in controlling the preparation of apparatus data or electric mail transmission.

On the other hand, the digital composite machine 1 is provided with various means, members including the image forming section 20, which function as the image forming apparatus. For convenience in explanations, only the image forming section 20, and an operation panel 21 provided with a hard key section 21a as an input section and a display panel 21b as a display section are shown in FIG. 1. It is needless to mention, however, that the structure of the digital composite machine 1 is not limited to the foregoing, and various any other means or members provided in known image forming apparatus may be adopted.

The hard key section 21a is also connected to the data communication section 10, and performs various input operations regrading the operation of a digital composite machine 1. The display panel 21b is capable of displaying various data regarding input or data regarding the transmission of electric mail.

More specifically, the display panel 21b is capable of displaying data regarding transmission and receiving of electronic mail transmitted and received by the electronic mail communications section 11 under the control of the control section 12. For example, the determination as to whether or not the apparatus data is to be transmitted, or return mail data (to be described layer) can be displayed in the display panel 21b. For the display of the display panel 21b, explanations will be given in each of the below-explained embodiments.

In the present embodiment, the control section 12 serves as an apparatus control section for controlling not only the data communication section 10 but also the overall operations of the digital composite machine 1. Namely, in the present embodiment, the control section 12 is considered to be a part of the apparatus control means for controlling an operation of the electronic apparatus.

In FIG. 1, the thick dashed line indicates the transmission/receiving path of the electric mail to be communicated via the network 3, thick dotted line indicates an output path of the apparatus data (including the self-diagnostic result Me), and an arrow of a think line indicates an output path of control data regarding an operation control of the digital composite machine 1 (including display data regarding a display of the display panel 21b, data regarding the preparation of apparatus data by the control section 12, etc.).

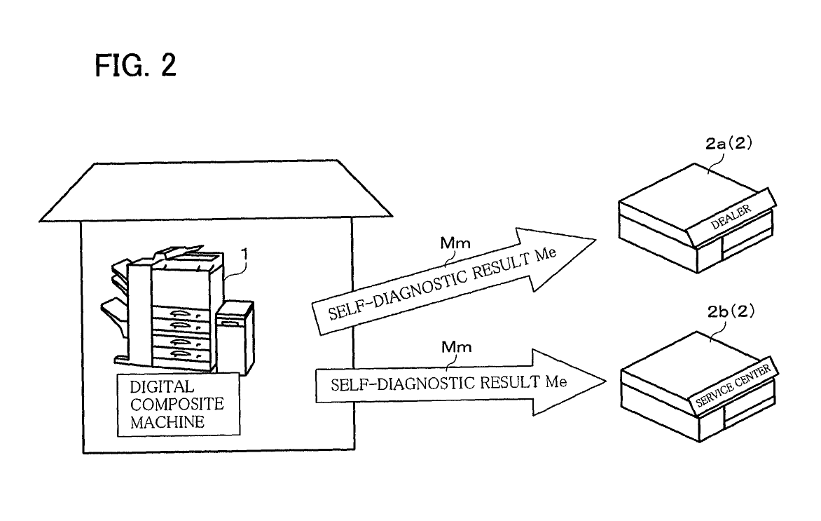

For the receiving end 2 of the electronic mail communications section 11, only one receiving end may be set. However, it is preferable to set a plurality of transmission ends 2 so that an appropriate service can be provided according to the content of the self-diagnostic result Me. As illustrated in FIG. 2, it is particularly preferable that the plurality of transmitting ends 2 be arranged so as to set a main receiving end 2a and a subsidiary receiving end 2b according to the priority.

Specifically, in FIG. 2, a dealer is set as the receiving end 2 for ordering supplies (consumable supplies, etc.,) in the digital composite machine 1, and a service center (or a support center) is set as the receiving end 2 for dealing with various failures such as a request for correcting a failure and for informing a maintenance request.

In the present embodiment, between the two receiving ends 2, the dealer is set as the main receiving end 2a, while the service center (support center) is set as the subsidiary receiving end 2b. However, it is needless to mention that the setting of the main receiving end 2a and the subsidiary receiving end 2b may be altered to be suited for each application. It is needless to mention that other receiving end 2 may be set according to the situation. As illustrated in FIG. 2, the control section 12 selects either one of the main receiving end 2a and the subsidiary receiving end 2b according to self-diagnostic result Me so as to transmit thereto the apparatus data Mm by the electronic mail communications section 11. Namely, in the foregoing structure, a predetermined receiving end 2 can be selected according to the situation.

The apparatus data Mm is minimum required data regarding the control of the electronic apparatus and contains at least self-diagnostic result Me to be described later. According to the management system of the present invention, the apparatus data Mm is transmitted from the electronic apparatus to a predetermined receiving end by electronic mail, and whereby the electronic apparatus can be managed in a prompt, reliable and efficient manner.

The self-diagnostic result Me to be prepared by the self-diagnosis operation of the self-diagnosis section 13, which is always contained in the apparatus data Mm corresponds to data representing data indicative of the current state of the electronic apparatus obtained from the self-diagnostic result Me of the apparatus data indicative of “an operational state of a specific function” possessed by the electronic apparatus. In the case of the digital composite machine 1, the specific function corresponds to the image forming function, and the digital composite machine 1 is thus arranged such that the state regarding the image forming function (operational state, etc.,) is self-diagnosed. Therefore, in the present embodiment, as illustrated in FIG. 1, the self-diagnosis section 13 performs a self-diagnosis operation with regard to at least the state of the image forming section 20.

The section subjected to the self-diagnosis by the self-diagnosis section 13 is not limited to the image forming section 20 but may be the hard key section 21a, the display panel 21b, or various other means or members (not shown). Particularly, in the case of the digital composite machine 1, not only that the image forming function is provided but also that a plurality of operation modes are available. Therefore, it is desirable for the digital composite machine 1 to perform not only the image forming section 20 but also the operation state of the entire digital composite machine 1. Furthermore, it may be arranged so as to perform the self-diagnosis of the data communication section 10 itself.

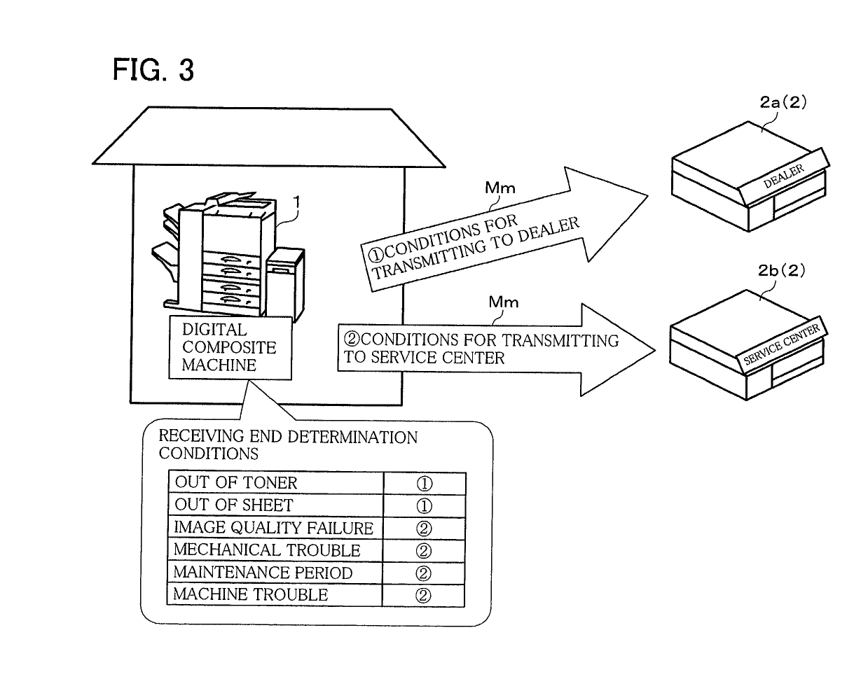

The self-diagnostic result Me includes, for example, a failed state of the digital composite machine 1, or the image forming section 20, an adjustment state of an operation of the digital composite machine 1 or the image forming section 20, the remaining amount of a consumable supply, the life of an exchangeable supply, etc., according to a type and a kind of the digital composite machine 1 or the image forming section 20. More specifically, as illustrated in the receiving end determination condition table in FIG. 3, the self-diagnostic result Me includes out of toner, out of sheet, an image quality failure, a mechanical trouble, a maintenance period, a machine trouble, etc.

In the present embodiment, the dealer is set as the main receiving end 2a, while the service center is set as the subsidiary receiving end 2b. Thus, in the digital composite machine 1, as illustrated in FIG. 3, the receiving end 2 of the apparatus data Mm including the self-diagnostic result Me is determined according to the self-diagnostic result Me. The determination of the receiving end 2 is performed by the control section 12. Specifically, it is preferable to adopt the method of setting determination conditions as a table as in the receiving end determination conditions illustrated in FIG. 3.

Out of toner or sheet corresponds to remaining state of the consumable supplies. Therefore, in the receiving end determination condition table illustrated in FIG. 3, it is set beforehand as \mathring{1} “conditions for transmitting to the dealer”. As a result, the apparatus data Mm including the self-diagnostic result Me is transmitted to the dealer as the main receiving end 2a by electronic mail.

On the other hand, an image quality failure, a maintenance period, etc., corresponds to the adjustment state of operations, while mechanical trouble, machine trouble corresponds to the failed state. Therefore, in the receiving end determination condition table, these are set beforehand as \mathring{2} “conditions for selecting service center as the receiving end”. In the present invention, it is preferable that the receiving end 2 be set according to the content of failure occurred in the digital composite machine 1 (self-diagnostic result Me).

In the present invention, it is preferable that the apparatus data Mm of the present invention includes installation place data regarding the place of the digital machine 1 is installed other than the self-diagnostic result Me. Specifically, it is preferable that the installation place data includes at least the address data of the place of installation of the digital composite machine 1, or user data (customer data) regarding the user of the digital composite machine 1 or a user manager (both are users) for managing the use of the digital composite machine 1.

According to the foregoing arrangement, for example, in the case where the service personnel visits the place of installation of the digital composite machine 1, it is possible to recognize an accurate place of installation of the digital composite machine 1. Therefore, it becomes possible for the dealer or the service center (receiving end 2) which received an electronic mail from the digital composite machine 1 to perform a prompt and appropriate support management with respect to the digital composite machine 1. Here, it is needless to mention that the installation place data may include other data.

Here, the user manager does not indicate a legal entity, or a department for managing the maintenance of the digital composite machine (electronic apparatus) 1, but indicates such case that the address of the owner of the digital composite machine 1 differs from the place of installation, and at the place of installation, the digital composite machine 1 is managed by other person (body corporate) than the owner. Here, the manager who manages the maintenance of the digital composite machine 1 may be referred to as a manager for an apparatus (manager for a machine).

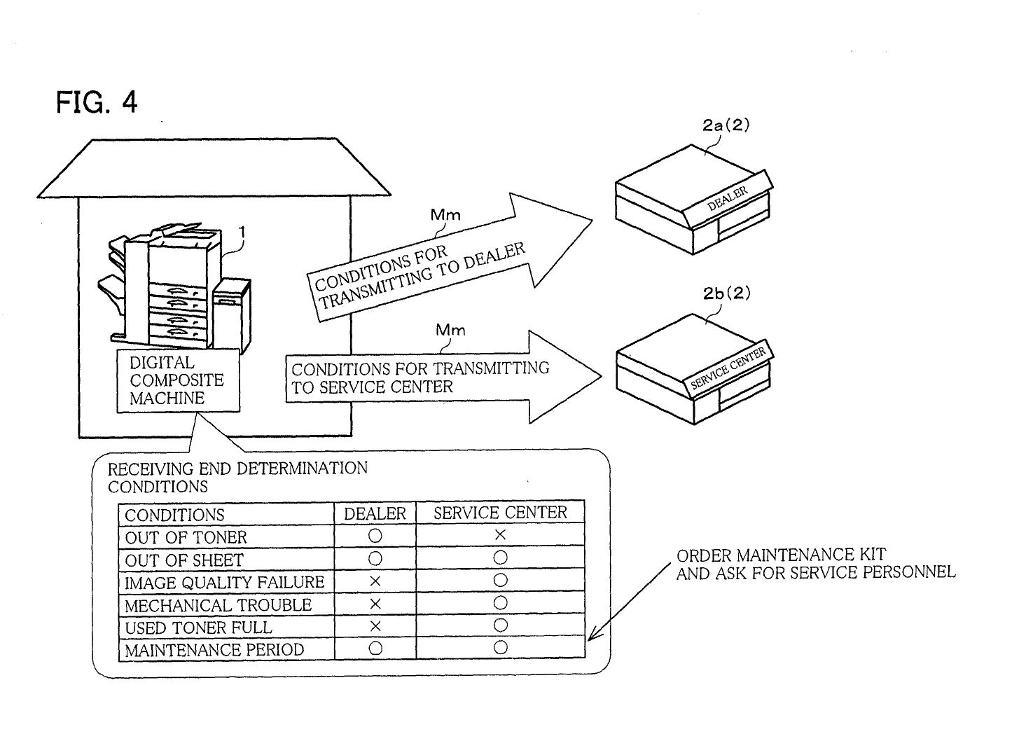

In the present embodiment, for example, the structure illustrated in FIG. 4 may be adopted. That is, the control section 12 transmits the apparatus data Mm to both the main receiving end 2a and the subsidiary receiving end 2b according to the self-diagnostic result Me.

For example, as shown in the receiving end determination condition table of FIG. 4, if the self-diagnostic result Me is indicative of out of toner or sheet, the apparatus data Mm is to be transmitted only to the dealer (main receiving end 2a) (in the table, the column dealer is marked “∘”, and the service center is marked “×”). On the other hand, if the self-diagnostic result Me indicates image quality failure, mechanical trouble, or used toner being, etc., the apparatus data Mm is to be transmitted only to the service center (subsidiary receiving end 2b) (in the table, the column dealer is marked “×”, and the service center is marked “∘”) However, for the periodic maintenance (in the table, “maintenance period”), it is required to order the dealer (main receiving end 2a) for a maintenance kit, and to request the service center (subsidiary receiving end 2b) to send a service personnel. Thus, in the receiving end determination condition table of Table 4, by marking both the dealer and the service center as “∘”, for the periodic maintenance, the control section 12 controls so as to transmit the apparatus data Mm both to the dealer (main receiving end 2a) and the service center (subsidiary receiving end 2b).

As described, by transmitting the apparatus data Mm to a plurality of receiving ends 2 according to the state of the digital composite machine 1, it is possible to deal with the current situation of the digital composite machine 1 in more accurate and smooth manner.

As described, according to the management system of the present embodiment including the digital composite machine 1 as an electronic apparatus and the receiving end 2 which are connected via a network 3, self-diagnostic result Me is prepared by the self-diagnosis section 13, and the apparatus data Mm including the self-diagnostic result Me is transmitted to a predetermined receiving end 2 by electronic mail.

Therefore, by setting the dealer or the service center as the receiving end 2 which performs the maintenance of the digital composite machine 1, in such event that some failure occurs in the digital composite machine 1, or a consumable supply is run out, or an exchangeable supply is used up, etc., it is possible for the dealer or the service center to manage such situation appropriately. As a result, it is possible to more reliably manage the digital composite machine 1 as compared to the case of the conventional management system.

In the case where a plurality of receiving ends 2 are set as the predetermined receiving ends (the main receiving end and the subsidiary receiving end, for example), it is preferable to arrange such that the digital composite machine 1 selects at least one receiving end 2 according to the self-diagnostic result Me, and selects a plurality of receiving ends 2 when need arises, and controls the electronic mail communications sections 11 as the apparatus communication means to transmit the apparatus data to the selected receiving end(s) 2. As a result, it is possible to more reliably manage the digital composite machine 1 as compared to the case of the conventional management system.

[Second Embodiment]

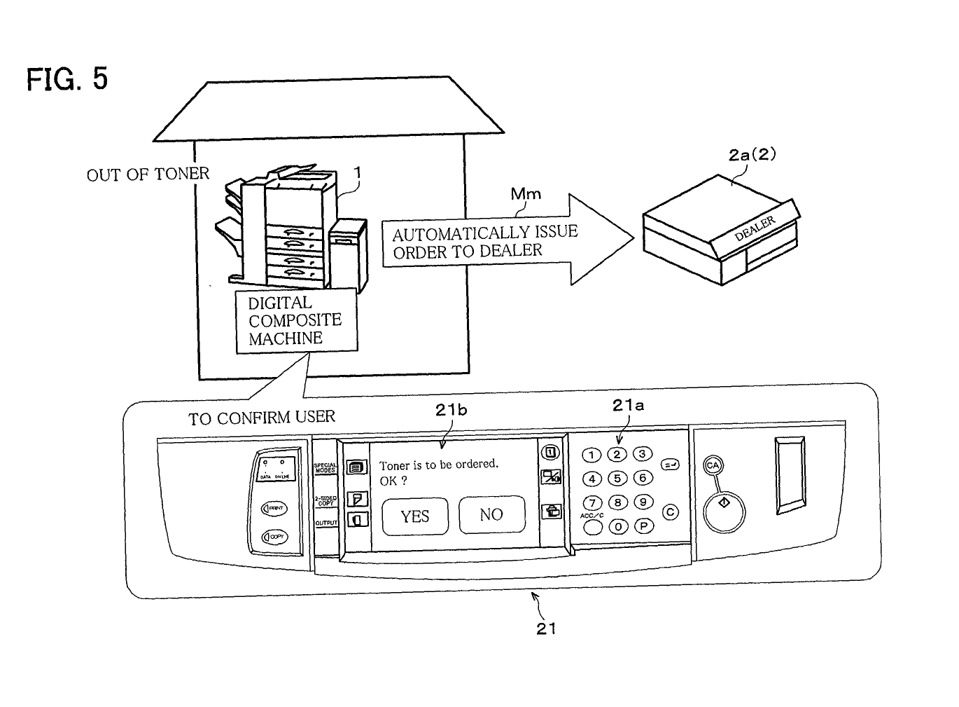

The following descriptions will explain the second embodiment of the present invention in reference to FIG. 5. It should be noted however that the present invention is not intended to be limited to the structure of the present embodiment. For ease of explanation, members (structures) having the same functions as those shown in the drawings pertaining to the first embodiment above will be given the same reference symbols, and explanation thereof will be omitted here.

The control section 12 (see FIG. 1) of the first embodiment is arranged so as to merely control the transmission of an electronic mail to the predetermined receiving end 2 based on the self-diagnostic result Me. On the other hand, a control section 12 of the present embodiment is arranged so as to determine if an electronic mail is to be transmitted based on self-diagnostic result Me, and when necessary, to transmit apparatus data Mm including self-diagnostic result Me to the receiving end 2.

According to the foregoing structure, it is possible to prepare for consumable supplies such as toner on the side of user. Here, as illustrated in FIG. 5, assuming that the self-diagnostic result Me “out of toner” (failure regarding the remaining amount of consumable supply) is obtained, then with the structure of automatically transmitting the apparatus data Mm including the self-diagnostic result Me of “ordering toner” to the dealer (main receiving end 2a) by electronic mail irrespectively of that the toner has been prepared on the side of the user beforehand, a problem of double purchase of toner on the side of user would occur, resulting in wasteful supplies in terms of both costs and consumable supplies.

Although not shown, for consumable supplies or exchangeable supplies, it is often separately charged for the purchase costs, and this purchase cost could be very high depending on the type of the consumable supplies or exchangeable supplies and therefore, these could be a heavy burden to the user. Therefore, the structure of automatically ordering a consumable supply or an exchangeable supply upon detecting the shortage of such supply by transmitting an electronic mail of the apparatus data Mm has both advantage and disadvantage for the user.

In other to counteract the foregoing problem, in the present embodiment, the control section 12 (see FIG. 1) performs a control of inquiring the user if the apparatus data Mm is to be transmitted to the user. This process of inquiring the user is performed by using the described hard key section 21a and the display panel 21b. Specifically, as illustrated in FIG. 5, a message is displayed on a display panel 21b for the user to confirm if the apparatus data Mm is to be transmitted to the predetermined receiving end 2 according to the self-diagnostic result Me, and then it is determined whether the transmission of the apparatus data Mm is executed or terminated by the input operation performed by means of the display panel 21b or the hard key section 21a.

As illustrated in FIG. 5, for example, when simply the toner runs out, in the case of automatically ordering the toner by transmitting the apparatus data Mm to the dealer (main receiving end 2a) by electronic mail, there would be no problem if the user has not purchased the toner beforehand; however, if the user has already purchased the toner, that would result in the problem that the user is charged for the purchase of unnecessary toner. In order to counteract the foregoing problem, in the display panel 21b, for example, a message for confirming the user if he wishes to purchase toner is displayed, such as “Toner is to be ordered. Is it OK?”, and in the meantime, soft keys “YES” and “NO” (keys on the display) are displayed in the screen of the display panel 21b. In this display, the soft key “NO” is to be operated if the toner has been already purchased, while the soft key “YES” is to be operated if the toner has not been purchased.

By confirming the transmission of the apparatus data Mm to the user before transmitting the apparatus data Mm to the predetermined receiving end 2, such problem of ordering unnecessary consumable supply or receiving unwanted maintenance service can be avoided.

The described display panel 21b of the digital composite machine 1 illustrated in FIG. 5 serves as a touch panel. Therefore, by operating either one of the soft keys “YES” and “NO”, the input operation for determining if the apparatus data Mm is to be transmitted is completed. Therefore, in the example of FIG. 5, the display panel 21b functions also as the input section.

Alternately, in the structure of FIG. 5, since the hard keys 21b composed of various types of keys are provided, for example, such structure wherein the transmission of the apparatus data Mm can be set by operating “1” of the ten keys (corresponding to the soft key “YES”), and the non-transmission of the apparatus data Mm can be set by operating “2” of the ten keys (corresponding to the soft key “NO”).

As described, in the present embodiment, the management system in accordance with the first embodiment is further arranged such that the digital composite machine determines if the apparatus data is to be transmitted to the predetermined receiving end based on the self-diagnostic result.

According to the foregoing structure, for example, in the case where a failure occurred in the digital composite machine can be managed on the side of the user, it may be arranged so as not to transmit an electronic mail to the dealer of a predetermined receiving end. On the other hand, if a failure occurred in the digital composite machine cannot be managed on the side of the user, a request for correcting the failure can be made by transmitting an electronic mail to the dealer.

[Third Embodiment]

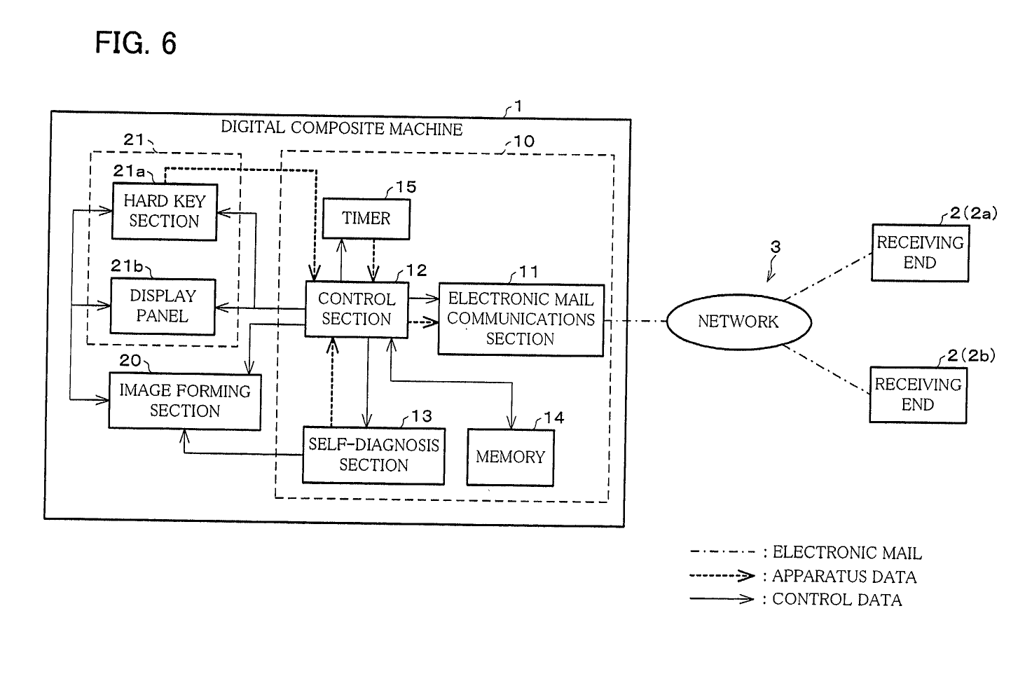

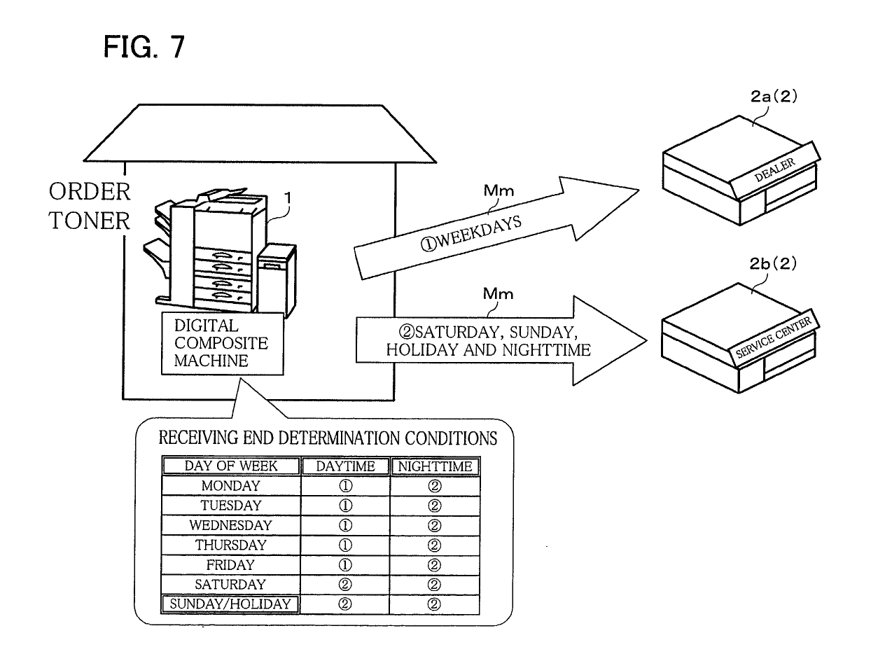

The following descriptions will explain the third embodiment of the present invention in reference to FIGS. 6 and 7. It should be noted however that the present invention is not intended to be limited to the structure of the present embodiment. For ease of explanation, members (structures) having the same functions as those shown in the drawings pertaining to the first and second embodiments above will be given the same reference symbols, and explanation thereof will be omitted here.

In the present embodiment, in addition to the structure of the first and second embodiments, the control section 12 of the present embodiment is arranged such that in the case where a plurality of receiving ends are set, the predetermined receiving end 2 is selected based on the time data.

As illustrated in FIG. 6, the basic structure of the management system of the present embodiment is the same as that of the first embodiment (FIG. 1). The management system of the present embodiment differs from that of the first embodiment in that a timer 15 is provided in the data communication section 10. The timer 15 is the time keeping means for keeping time.

In the present embodiment, as time is measured by the timer 15, the control section 12 selects the predetermined receiving end 2 from the plurality of receiving ends 2 based on the time data obtained by the timer 15. Specifically, as illustrated in FIG. 7, in the case of obtaining the self-diagnostic result “ordering toner” from the self-diagnosis section 13, the receiving end 2 of the apparatus data Mm is selected based on the time data obtained by the timer 15.

For example, in the digital composite machine 1, as illustrated in FIG. 7, the receiving end determination condition table is set beforehand according to the business conditions of each receiving end 2. For the dealer set as the main receiving end 2a, it is opened in the daytime during the week, i.e., from Monday to Friday; while it is closed on weekends, i.e., on Saturday and Sunday, holiday and at night. On the other hand, for the service center as the subsidiary receiving end 2b, a service system is fulfilled by opening 24 hours throughout the year. Therefore, in the receiving end determination condition table, it is arranged so as to transmit apparatus data Mm \mathring{1} to the dealer (main receiving end 2a) in the day time during the week, i.e., from Monday to Friday, and \mathring{2} to the service center (subsidiary receiving end) on weekends, holiday and nighttime.

Here, it may be arranged so as to obtain the time data from the timer 15 (i) at a timing of preparing the self-diagnostic result Me, or (ii) at a timing the apparatus data Mm including the self-diagnostic result Me is prepared, i.e., a timing a transmission by the electronic mail is allowed. Generally, it is preferable to obtain the time data from the timer based on the time the transmission of the apparatus data Mm by the electronic mail becomes available. In practice, however, substantially, there is no difference between the timing of preparing the self-diagnostic result Me and the timing of transmitting apparatus data Mm. Therefore, in the present embodiment, it may be arranged so as to obtain the time data from the timer 15 based on the timing of preparing any data.

The respective time setting for the “daytime” and the “nighttime” are not particularly limited, and may be varied depending on the opening hour of the dealer. For example, if the opening hour of the dealer is from 9 a.m. to 6 p.m., this time period of 9 a.m. to 6 p.m. can be set for the “daytime”, and the rest of the day can be set for the “nighttime”.

As described, by arranging so as to select the receiving end 2 of the apparatus data Mm which is capable of dealing with the situation to correct the failure in more appropriate manner than other receiving end(s), according to the time an electronic mail is to be transmitted, it becomes possible to manage the situation according to the current situation of the electronic mail in more efficient manner.

As described, the digital composite machine of the present embodiment is provided with the timer which prepares time data. With this structure of the digital composite machine, it is possible for the control section to select the receiving end from the plurality of receiving ends according to the preparation time of the self-diagnosis result. As a result, it is possible to provide services to deal with a failure occurred in the digital composite machine throughout the day.

[Fourth Embodiment]

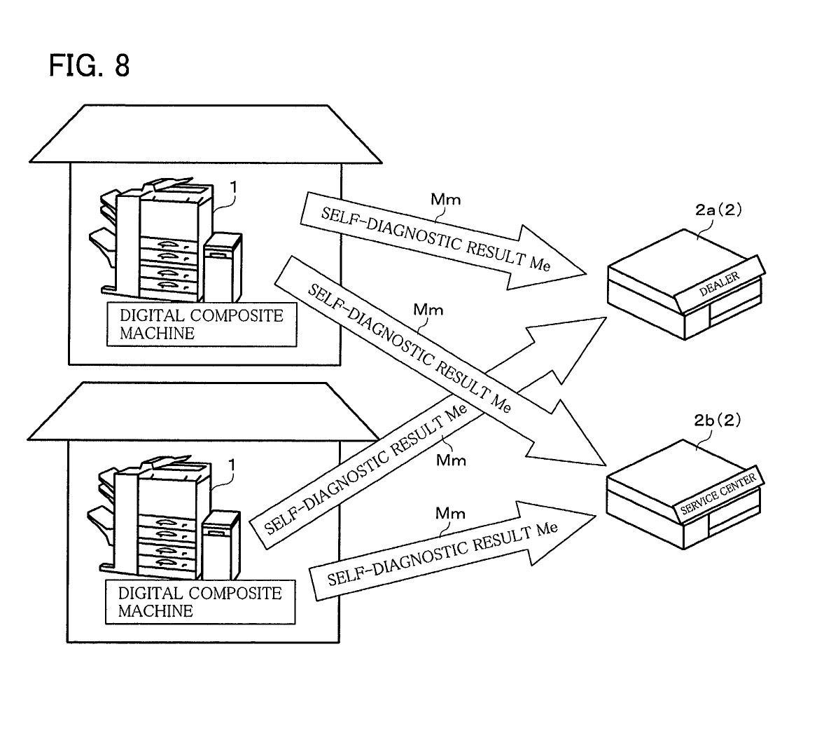

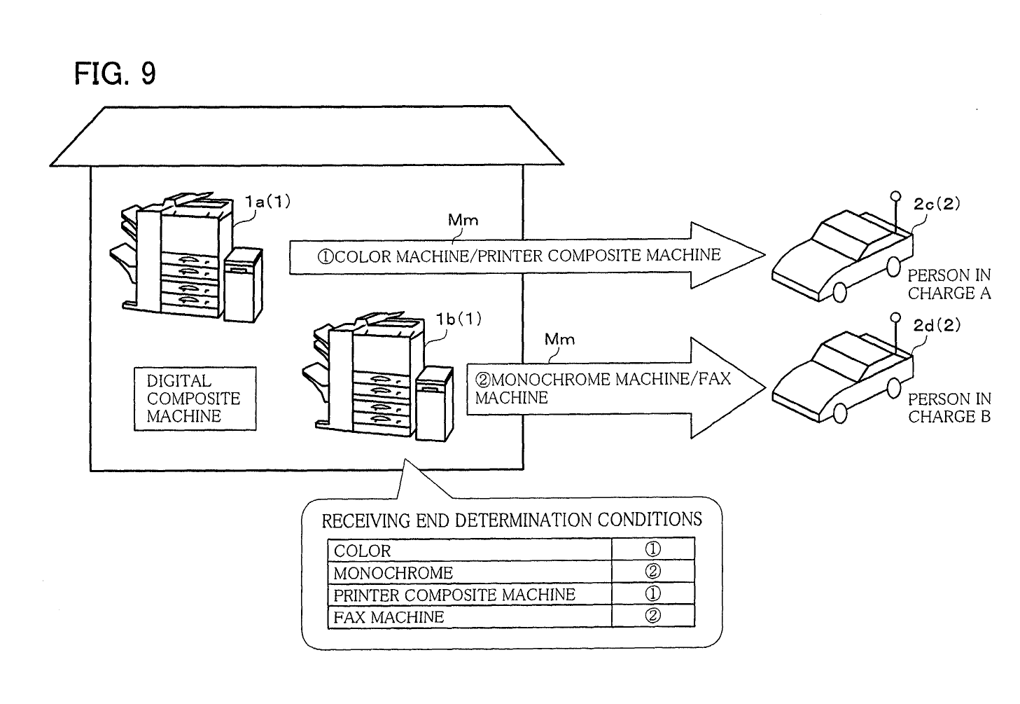

The following descriptions will explain the fourth embodiment of the present invention in reference to FIGS. 8 and 9. It should be noted however that the present invention is not intended to be limited to the structure of the present embodiment. For ease of explanation, members (structures) having the same functions as those shown in the drawings pertaining to the first, second or third embodiment above will be given the same reference symbols, and explanation thereof will be omitted here.

In the respective structures of the first through third embodiments, the main receiving end 2a and the subsidiary receiving end 2b (i.e., a plurality of receiving ends 2) are set for one digital composite machine 1. However, the present invention is not intended to be limited to the foregoing structure, and for example, the structure including a plurality of digital composite machines (electronic apparatus) 1 and a plurality of receiving ends 2 may be adopted.

As a typical example of the structure wherein a plurality of digital composite machines 1 are provided, the structure illustrated in FIG. 8 may be adopted. That is, each a plurality of users possesses the digital composite machine 1, and the main receiving end 2a and the subsidiary receiving end 2b are set for each of the digital composite machines 1 as the receiving end 2 of the apparatus data Mm. In this structure, each user possesses only one digital composite machine 1, and thus the management system for each digital composite machine 1 has the same structure as those of the first through third embodiments.

On the other hand, for example, another structure wherein some user possesses a plurality of digital composite machines 1 may be adopted. In this case, if all of the digital composite machines 1 possessed by the above user are of the same kind, the management system would have the same structure as those of the first through third embodiments as in the case of FIG. 8.

On the other hand, in the case where the plurality of digital composite machines 1 possessed by the user are of different kinds, failures which are possibly occurred or maintenance conditions may differ among the digital composite machines 1 of different kinds, and thus with the management system of the first through third embodiments, the plurality of digital composite machines 1 may not be managed in a sufficient manner.

For example, as illustrated in FIG. 9, assuming that the some user possesses two digital composite machine 1 one of which is functioned both as a color copying machine and a print composite machine (hereinafter, referred to as a color machine) la, and the other of which is functioned both as a monochrome copying machine and the FAX machine (hereinafter referred to as a monochrome machine) 1b, i.e., the case where these two digital composite machines 1 are of different kinds, i.e., the color machine la and the monochrome machine lb.

Then, in the case where the self-diagnostic result Me of “out of toner” is prepared, and based on which the apparatus data Mm is prepared as explained in examples of the second or third embodiment, toner in plural colors are used for forming a color image in the color machine 1a; on the other hand, toner of only one kind (black toner) is used in the monochrome machine lb. Therefore, even when the same self-diagnostic result Me “out of toner” is obtained, and based on which the same apparatus data “toner is to be ordered” is transmitted to the respective receiving ends 2 by electronic mail, the kind of toner needed for each of the foregoing digital composite machines 1 may differ.

Namely, in the case of adopting electronic apparatuses of different kinds, even if the same self-diagnostic result Me and the same apparatus data Mm are obtained, a kind of support management to be applied to each electronic apparatus may differ.

Therefore, in the management system of the present embodiment, it is controlled so as to select the receiving end 2 according to the kind of the electronic apparatus, or the type of the electronic apparatus.

Here, explanations can be given, for example, through the case of FIG. 9. In the Table for the receiving end determination conditions, the receiving ends 2 are set according to the kind and the type of the respective digital composite machines 1.

Specifically, the color machine 1a functions both as a color image forming apparatus and a printer, and thus, \mathring{1} the person A (receiving end 2c) is set as the service personnel in charge of respective functions provided in the color machine 1a, to whom the apparatus data Mm is to be transmitted. Specifically, in the example of FIG. 9, an electronic mail is transmitted to a data terminal provided in mobile (receiving end 2c).

Similarly, the monochrome machine 1b functions both as a monochrome image forming apparatus and a fax machine, and thus, \mathring{2} the person B (receiving end 2d) is set as the service personnel in charge of each of the above functions provided in the monochrome machine 1b, to whom the apparatus data Mm is to be transmitted.

Here, it may be arranged so as to set a plurality of receiving ends 2 for both of the color machine 1a and the monochrome machine 1b respectively. For example, for the color machine 1a, the receiving end 2c of the person A may be set as the main receiving end, and additionally, as explained in the first through third embodiments, the dealer or the service center may be set as subsidiary receiving ends, and then, an electronic mail of the apparatus data Mm is transmitted to the plurality of receiving ends 2.

According to the foregoing structure, it is possible to perform an appropriate treatment with respect to the color machine 1a in both the service center the person A in charge belongs to, and the dealer. In this way, even when the person A in charge is out of office, other service personnel can be sent from the dealer or the service center in replace of the person A in charge. Furthermore, by controlling the history of the color machine 1a on the side of the dealer or the service center, data corresponding to an appropriate support can be provided by the service personnel in replace of the person A in charge.

Therefore, although the management system of the present embodiment has the same basic structure as that of the first embodiment (FIG. 1) and that of the third embodiment (FIG. 6), the management system of the present embodiment differs from those of the first and third embodiments in that the type of each digital composite machine 1 is stored in the memory 14, and each receiving end (each person in charge, corresponding department) is set according to the type of the digital composite machine 1 stored in the memory 14. In this way, it is possible to manage the digital composite machine 1 at the receiving end 2 according to the type of each digital composite machine 1 in a prompt and appropriate manner.

The “kind” of the digital composite machine 1 is not particularly limited as long as the digital composite machine 1 can be managed in an effective manner. Non-limited examples of the digital composite machine 1 include a type, or a model type within the same type, a function of the digital composite machine 1, such as color or monochrome, an intermediate/high speed or personal speed (low speed), etc.

As described, the management system of the present embodiment having the structures of the first through third embodiments is further arranged such that a plurality of digital composite machines and a plurality of receiving ends are provided. Namely, in the management system of the present invention, a plurality of digital composite machines can be managed integrally. Moreover, since a main receiving end can be set for each digital composite machine, it is possible to manage each of the plurality of digital composite machines according the type of the digital composite machine in more appropriate manner.

[Fifth Embodiment]

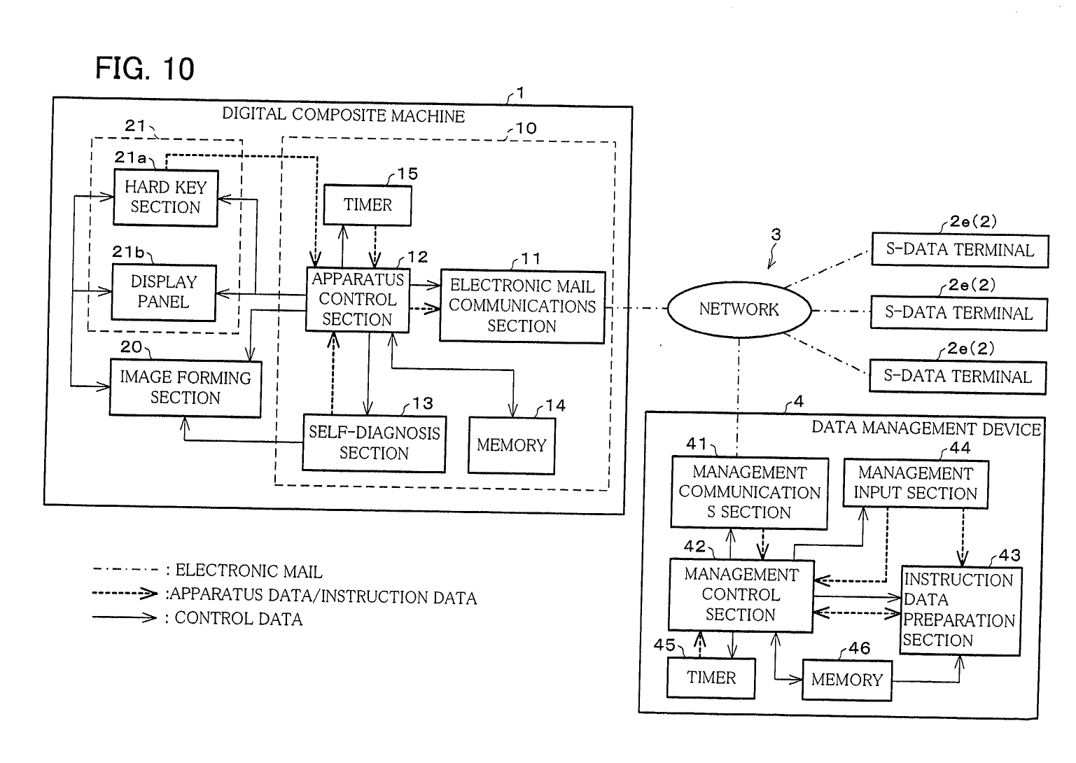

The following descriptions will explain the fifth embodiment of the present invention in reference to FIGS. 10 through 12. It should be noted however that the present invention is not intended to be limited to the structure of the present embodiment. For ease of explanation, members (structures) having the same functions as those shown in the drawings pertaining to any of the first through fourth embodiments above will be given the same reference symbols, and explanation thereof will be omitted here.

In the first through fourth embodiments, for the transmission of the apparatus data Mm, the one-step transmission process is adopted, i.e., an electronic mail is transmitted from the digital composite machine 1 directly to the receiving end 2. In the present embodiment, however, the two-step transmission process is adopted, i.e., after transmitting an electronic mail from the digital composite machine 1 to the primary receiving end, an electronic mail is transmitted from the primary transmission end to the secondary receiving end.

FIG. 10 illustrates another structure for the management system of the present invention. This management system includes the digital composite machine 1 having the same structure as those of the first through fourth digital composite machine 1, and the service personnel's data terminal 2e (hereinafter, referred to as S-data terminal) as the receiving end 2 (secondary receiving end) connected to the digital composite machine 1 via the network 3, and further includes the data management device 4 as the primary receiving end connected to the digital composite machine 1 via the network 3.

The structure of each digital composite machine 1 of the present embodiment is the same as that of the digital composite machines 1 (see FIGS. 1 and 6) adopted in the first through fourth embodiments, and thus the explanations thereof shall be omitted here. For the S-data terminal 2e as the secondary receiving end, the data terminal provided in the mobile, the portable data terminal personally possessed by the service personnel, etc., may be adopted.

The data management device 4 includes a management communications section 41 connected to the network 3, which permits data to be transmitted to the S-data terminals 2e by electronic mail, a management control section 42 for controlling an operation of the data management device 4, an instruction data preparation section 43 for preparing instruction data Md (to be described later), a management input section 44 for inputting data from an external section, a timer 45 and memory 46.

The management communications section 41 receives apparatus data Mm transmitted from the digital composite machine 1 and transmits instruction data Md to the S-data terminals 2e by electronic mail. As described, the management control section 42 controls overall operations of the data management device 4. Particularly, the management control section 42 controls various processes related to the preparation of the instruction data Md, and the transmission of the resulting instruction data Md to the S-data terminals 2e.

The instruction data preparation section 43 prepares instruction data Md to be transmitted to the S-data terminals 2e based on the apparatus data Mm received from the digital composite machine 1. The management input section 44 performs operations of inputting various data, particularly the data related to the preparation of the instruction data Md. The timer 45 serving as time keeping means for measuring time is arranged so as to prepare time data for use in the control operations by the management control section 42. The memory 46 is the memory means for storing data related to the preparation of instruction data Md or the data related to the control by the management control section 42. Specifically, the memory 46 stores various data related to the preparation of the instruction data Md, desirably in the form of data base.

As is clear from FIG. 10, the management system in accordance with the present embodiment includes two devices (electronic apparatuses), i.e., the digital composite machine 1 and the data management device 4, and each of these two devices is provided with a control means. Therefore, in the present embodiment, for the control means of the digital composite machine 1, the apparatus control section 12 is adopted to be distinguishable from the management control section 42 of the data management device 4. There are also other means than the control means which are provided in both of the two devices. For such devices provided in both of the two devices, however, by giving different reference symbols in the explanations of the management system, the one provided in the digital composite machine 1 can be distinguished from the one provided in the data management device 4, and thus such devices are referred to as the same names.

Further, in FIG. 10, the thick dotted line indicates the transmission/receiving path of the electronic mail to be transmitted and received via the network 3, while the arrow of thin line indicates the output path of the control data related to the control of the operations of the digital composite machine 1 as in the first embodiment (FIG. 1) and the third embodiment (FIG. 6). In the present embodiment, however, the output path indicated by the thick dotted line includes not only the apparatus data Mm but also instruction data Md.

Here, in the management system of the present embodiment, data to be transmitted and received by electronic mail by the management system of the present invention, such as apparatus data Mm, instruction data Md, and return mail data to be explained in the eighth embodiment (to be described later) are all referred to by the general term of “management system data”.

In the management system of the present embodiment, a plurality of digital composite machines 1 are provided in a plurality of zones. These digital composite machines 1 which are either purchased or rented by the user (customer) are installed on the side of the user. On the other hand, the data management device 4 and the S-data terminals 2e are provided in the service department such as service center, which performs various maintenance operations of the digital composite machines 1. Specifically, the data management device 4 is provided in the service center, while the S-data terminals 2e are data terminals (note-type personal computer, portable data terminal, etc.) possessed by each service personnel.

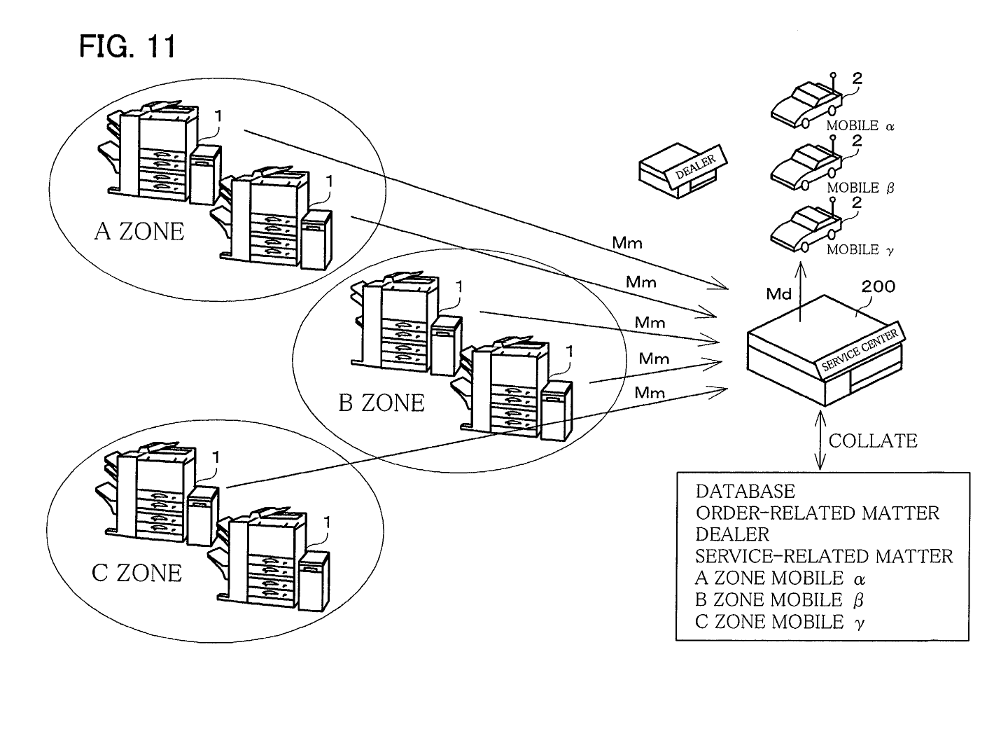

More specifically, as illustrated in FIG. 11, the plurality of digital composite machines 1 are installed in three zones A, B and C (in the example of FIG. 11, two for each zone) respectively, and these plurality of digital composite machines 1 are managed by the service center 200. The data management device 4 is installed in the service center 200, and is connected to respective digital composite machines 1 via the network 3 (not shown in FIG. 11). In the service center 200, a plurality of mobiles are provided (three mobiles in FIG. 11). Further, various data terminals (S-data terminal 2e) are provided as the S-data terminal 2e in each mobile. Therefore, the service mobile serves as the receiving end 2.

When the apparatus data Mm indicative of an occurrence of a failure in the digital composite machine 1 is transmitted from the digital composite machine 1 in each zone to the service center 200 by electronic mail, the apparatus data Mm is received and processed as required by the data management device 4 at the service center 200. The data management device 4 then transmits the apparatus data Mm as processed to the S-data terminal 2e (not shown in FIG. 11) in the mobile (receiving end 2).

As is clear from FIG. 11, according to the management system of the present embodiment, all the electronic mails of the apparatus data Mm transmitted from the plurality of digital composite machines 1 are once stored in the data management device 4 (service center 200). Then, the data management device 4 prepares new electronic mail (instruction data Md) based on the contents (apparatus data Mm) of the electronic mail received from the plurality of digital composite machines 1, and then transmits the electric mail thus prepared to the predetermined S-data terminals 2e as the receiving ends 2 (mobiles).

As described, in the present embodiment, in the structure where the plurality of digital composite machines 1 and the plurality of S-data terminals 2e (receiving ends) are connected to the network 3, the data management device 4 is also connected to the network 3. With this structure, the data management device 4 can be functioned as a “gate way” of the apparatus data Mm. It is therefore possible for the data management device 4 to once store the apparatus data Mm, and then process the apparatus data Mm into instruction data Md for terminals of secondary receiving ends (S-data terminals 2e) to be transmitted thereto respectively.

According to the foregoing structure, each service personnel of the receiving end of the secondary receiving end can systematically recognize the current state of the digital composite machine 1 for which he is responsible. In the meantime, the data management device 4 can reliably manage the respective states of the plurality of digital composite machines 1. Therefore, for example, in an event of an occurrence of some failure in the digital composite machines 1, the service personnel (receiver at the second receiving end) can deal with the current situation of the digital composite machine 1 to correct the failure. Also, the data management device 4 can provide total management service to that digital composite machines 1. As a result, it is possible to more reliably manage the digital composite machines 1 as compared to the case of the conventional management system.

The apparatus data Mm and the self-diagnostic result Me contained therein are the same as those adopted in the first through fourth embodiments, and thus the explanations thereof shall be omitted here.

Further, as explained in the first embodiment, it is preferable that the apparatus data Mm include installation place data (address data of the installation place of the digital composite machine 1, user data related to the user of the digital composite machine 1, etc.) other than the self-diagnostic result Me. In the present embodiment, it is further preferable that the apparatus data Mm include identification data (electronic apparatus identification data) for identifying each of the plurality of digital composite machines 1.

As illustrated in FIG. 11, the management system in accordance with the present embodiment includes a plurality of digital composite machines 1. As described, by adding specific data as additive data to the apparatus data Mm to be transmitted from each digital composite machine 1, the digital composite machine 1 of the transmitting end of the apparatus data Mm can be clearly recognized. Additionally, the instruction data Md which permits a specific digital composite machine 1 to be managed in more reliable manner can be received by the secondary receiving end. In the meantime, the secondary receiving end, which is capable of dealing with the given situation of the specific digital composite machine 1 in more reliable manner than other secondary receiving ends, can be selected from the plurality of secondary receiving ends. As a result, the service management system capable of providing still more reliable services suited for each of the plurality of the electronic apparatuses can be realized.

The above specific data is not particularly limited as long as the digital composite machine 1 of the transmitting end of the apparatus data Mm can be specified from the plurality of digital composite machines 1. Non-limited examples of which include, unique number assigned to individual digital composite machines 1 (production number, unique management number registered in the service center 200 or the dealer, etc.), installation place data, i.e., the data on the place of installation of the digital composite machine 1, or user data of the digital composite machine 1. Therefore, the installation place data and the specific data are often overlapped with each other.

The instruction data Md is prepared based on the apparatus data Mm by the instruction data preparation section 43 of the data management device 4. The instruction data Md include various data useful for the service personnel (owner of the S-data terminal 2e) to provide support management with respect to each digital composite machine 1.

The method of preparing the instruction data Md by processing the apparatus data Mm is not particularly limited. The instruction data Md can be prepared, for example, by obtaining additive data by searching from the data base the data corresponding to the digital composite machine 1 of the transmitting end of the apparatus data Mm to be collated with the apparatus data Mm, and adding the resulting additive data to the apparatus data Mm, and then processing the resulting apparatus data Mm into the format for the S-data terminal 2e as required.

According to the foregoing structure, the data, which permits the digital composite machine 1 to be managed in more appropriate manner according to the current situation of the digital composite machine 1, can be added to the instruction data Md as additive data to be transmitted to the receiving end 2 (S-data terminal 2e). As a result, it is possible to deal with the current situation of the digital composite machine 1 in more efficient manner.

The additive data to be stored in the memory 46 is not particularly limited, and non-limited examples of which include history data related to the apparatus data Mm received from each digital composite machine 1 in the past. Namely, history data on the adjustment and the correction performed with respect to the digital composite machine 1 in the past, or history data on the maintenance operations performed in the past, data related to the ordered consumable supplies, or other related services are prepared into the database.

Therefore, by adding the additive data on the corresponding digital composite machine 1 obtained from the database as required, it is possible for the service personnel to appropriately deal with the current state of the digital composite machine 1 in reference the instruction data Md received at the S-data terminal 2e. The described additive data to be stored in the memory 46 is desirably classified so as to correspond to the received apparatus data Mm as the database.

The database in the memory 46 can be updated automatically, for example, by the following structure. That is, the management communications section 41 receives the apparatus data Mm from the digital composite machine 1, and each time the management communications section 41 transmits the instruction data Md to the S-data terminal 2e (receiving end), the management control section 42 stores the apparatus data Mm and the instruction data Md in the memory 46 as history data, thereby automatically updating the contents of the database. Here, the history data includes time data indicative of a time at which respective data Mm and Md are transmitted and received in addition to the contents of the apparatus data Mm and the instruction data Md (for example, self-diagnostic result, i.e., data indicative of out of sheet, paper jam, etc.).

In the foregoing preferred embodiment, the data management device 4 is provided with the management input section 44. However, the present invention is not intended to be limited to the foregoing structure, and it may be arranged such that other additive data can be input from the management input section 44. It may be arranged, for example, so as to transmit the advice data related to the adjustment or checking of individual digital composite machine 1 which are input as additive data to the S-data terminal 2e. According to the foregoing structure, other data than that stored in the database can be input as additive data, and transmit the additive data as instruction data to the S-data terminal 2e. As a result, it is possible to deal with the current state of the digital composite machine 1 in more efficient manner. In this case, the management control section 42 stores the instruction data Md including the additive data or the additive data extracted from the instruction data Md in the database of the memory 46.

As described, the data management device 4 of the present embodiment is arranged so as to be capable of adding various data (apparatus data Mm or additive data) to be used or referred to by each service personnel to the instruction data Md to be transmitted to the receiving end 2 (S-data terminal 2e). Therefore, with the above instruction data Md, the service personnel can offer more accurate service to the digital composite machine 1. Concrete examples for the instruction data Md would be given later in the sixth embodiment.

As illustrated in FIG. 11, in the present embodiment, a plurality of S-data terminals 2e are set (the receiving ends 2 of three mobiles α, β, and γ). Therefore, it is particularly preferable that the management control section 42 be arranged so as to select the S-data terminal 2e as the receiving end of the instruction data Md according to the contents of the apparatus data Mm. For example, in FIG. 11, the service personnel in A zone is on the mobile α, the service personnel in B zone is on the mobile β, and the service personnel in C zone is on the mobile γ.

In this case, the management control section 42 selects the receiving end of the instruction data Md from among the plurality of S-data terminals 2e based on the apparatus data Mm received from the specific digital composite machine 1 or the instruction data Md prepared by the apparatus data Mm. Then, the management control section 42 controls so as to transmit the instruction data Md to the selected specific S-data terminal 2e.

The management method of the present embodiment may be arranged so as to include the step of determining if the electronic mail is to be transmitted to the S-data terminal 2e based on the self-diagnostic result Me as explained in the second embodiment. For example, the data management device 4 is capable of controlling not only the selection of the S-data terminal 2e (receiving end 2) but also controlling so as to determine if the electronic mail is to be transmitted based on the self-diagnostic result Me.

The concrete selection method of the S-data terminal 2e by the management control section 42 is not particularly limited. For example, in the present embodiment, the service personnel is in the mobile (receiving end 2) or possesses a data terminal as S-data terminal 2e. It is preferable that the management control section 42 be arranged so as to select the S-data terminal by setting beforehand (1) the zone in which each service personnel is responsible, or (2) a service personnel in charge for each model as will be explained below.

In the method (1), for example, in the case where there are three zones A, B and C (see FIG. 11), the mobiles (service personnel) α, β, and γ are assigned for the zones A, B and C respectively, and further this determination result is stored in the database as additive data.

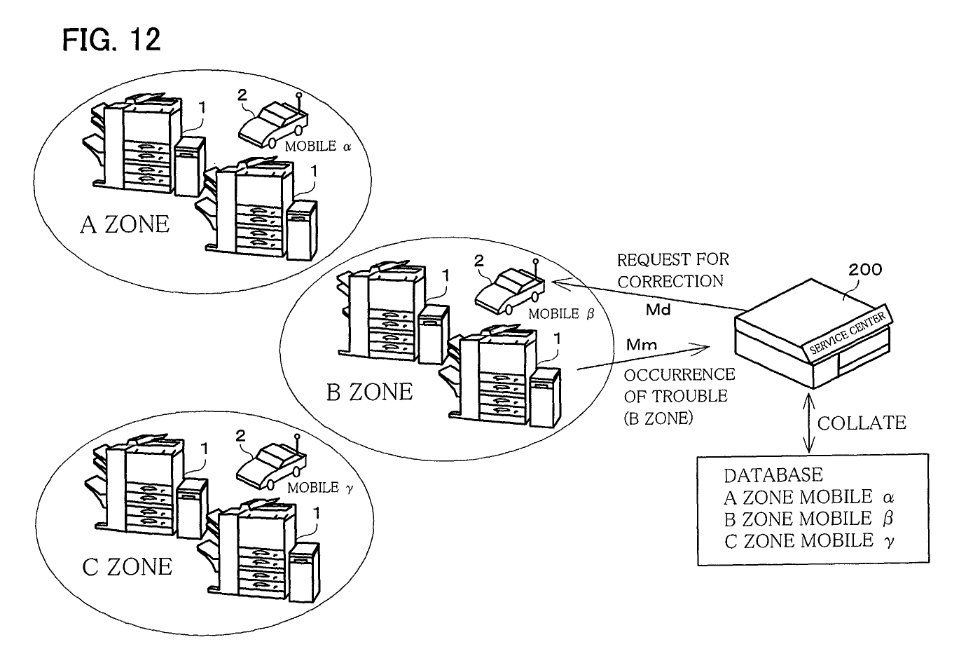

Then, assuming as illustrated in FIG. 12 that the apparatus data Mm indicative of an occurrence of a failure in the digital composite machine 1 in the B zone of the A to C zones is transmitted to the data management device 4 at the service center 200 by electronic mail. Then, the data management device 4 at the service center 200 transmits the instruction data Md indicative of a receipt of a request for correction to the mobile β in the B zone. In this way, it becomes possible for the service personnel in the mobile β to provide appropriate service to the digital composite machine 1 to correct the failure occurred therein.

On the other hand, in the second method (2), although not shown, the data management device 4 controls so as to select the S-data terminal 2e according to the kind or the type of the electronic apparatus (see FIG. 9) as explained in the fourth embodiment. Specifically, the data management device 4 stores therein the receiving end determination condition table (see FIG. 9) possessed by the digital composite machine 1, and selects the S-data terminal 2e according to the kind or the type of each digital composite machine 1.

In this method, it is possible to set the digital composite machine 1 for which each service personnel is responsible according to the speciality of the service personnel, and it is thus possible to more appropriately deal with the failure occurred in the digital composite machine 1.

As described, in the case where a plurality of receiving ends 2 (S-data terminals 2e) are set, and the corresponding zone or field differs for each receiving end 2, the data management device 4 is capable of selecting an appropriate receiving end 2, i.e., the receiving end 2 which can more surely deal with a specific digital composite machine 1 according to the contents of the received apparatus data Mm. As a result, it is possible to more reliably deal with each digital composite machine 1 to correct the failure occurred therein.

The present embodiment may be arranged so as to select the specific S-data terminal 2e based on the time data obtained by the timer 15. For example, by shifting the respective business hours of the mobiles α, β, and γ, it becomes possible to provide 24 hours services to the digital composite machines 1.

The 24 hours service can be realized, for example, by setting the work time for the service personnel on the mobile α to from 8 a.m. to 4 p.m., the work time for the service personnel on the mobile F to from 4 p.m. to 0 a.m., and the work time for the service personnel on the mobile γ to from 0 a.m. to 8 p.m. Further, by storing as additive data, the data on the respective mobiles α, β, and γ in relation to their business hours in the memory 46, it is possible to control the transmission of an electronic mail as explained in the third embodiment.

As described, the management system of the present embodiment further having the structure of the management system of the first through fourth embodiments is arranged so as to include the data management device 4. In the present embodiment, the receiving end 2 (2e) of the first through fourth embodiments serves as a secondary receiving end.

In the structure of the present embodiment, the data management device 4 functions as a gateway, and after temporarily storing the apparatus data Mm regarding the digital composite machine 1, transmits the apparatus data Mm to the secondary receiving end (terminal) 2(2e). Therefore, the service personnel of the receiver of the secondary receiving end can systematically recognize the current state of the digital composite machine 1. In the meantime, it is possible for the data management device 4, i.e., the service center 200 to provide reliable service for the management of the digital composite machines 1 to be suited for a current situation of each digital composite machine 1, and therefore, it is possible to more accurately manage the digital composite machines 1 as compared to the conventional management system.

In the present embodiment, the data management device 4 is provided with the instruction data preparation section 43 for preparing the instruction data Md and for transmitting the apparatus data Mm received from the digital composite machine 1 to the secondary receiving end. Namely, in an event of an occurrence of failure, the receiver (service personnel) of the secondary receiving end 2(2e) receives the instruction data Md obtained by further processing the apparatus data Mm, and therefore, it is possible for the receiver of the secondary receiving end 2(2e) to more appropriately deal with the current situation of the digital composite machine 1.

In the case where a plurality of secondary receiving ends are set, the data management device 4 selects a specific receiving end based on the received apparatus data Mm, and transmits thereto the instruction data Md. According to the foregoing structure, the receiving end 2(2e) which is capable of dealing with the current situation in most approximate manner can be selected from among the plurality of secondary receiving ends 2 (2e), and it is thus possible to always deal with the current situation of the digital composite machine 1 in appropriate and efficient manner.

In the memory 46 provided in the data management device 4, the additive data to be classified corresponding to the received apparatus data Mm are stored, for example, in the database. Therefore, the instruction data preparation section 43 prepares the instruction data Md by selecting the additive data corresponding to the apparatus data Mm to be added to the apparatus data Mm, and transmits the resulting instruction data Md to the predetermined secondary receiving end 2(2e). For this reason, it is possible to add the additive data with which the current situation of the digital composite machine 1 can be managed in more appropriate manner.

[Sixth Embodiment]

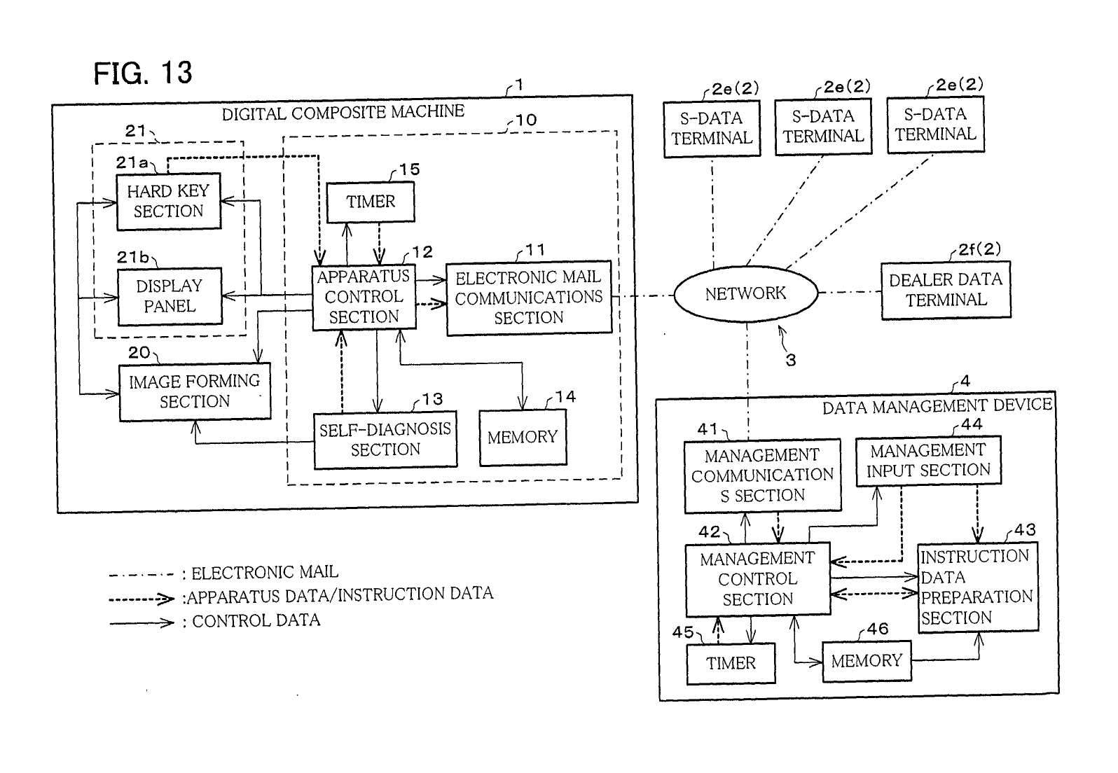

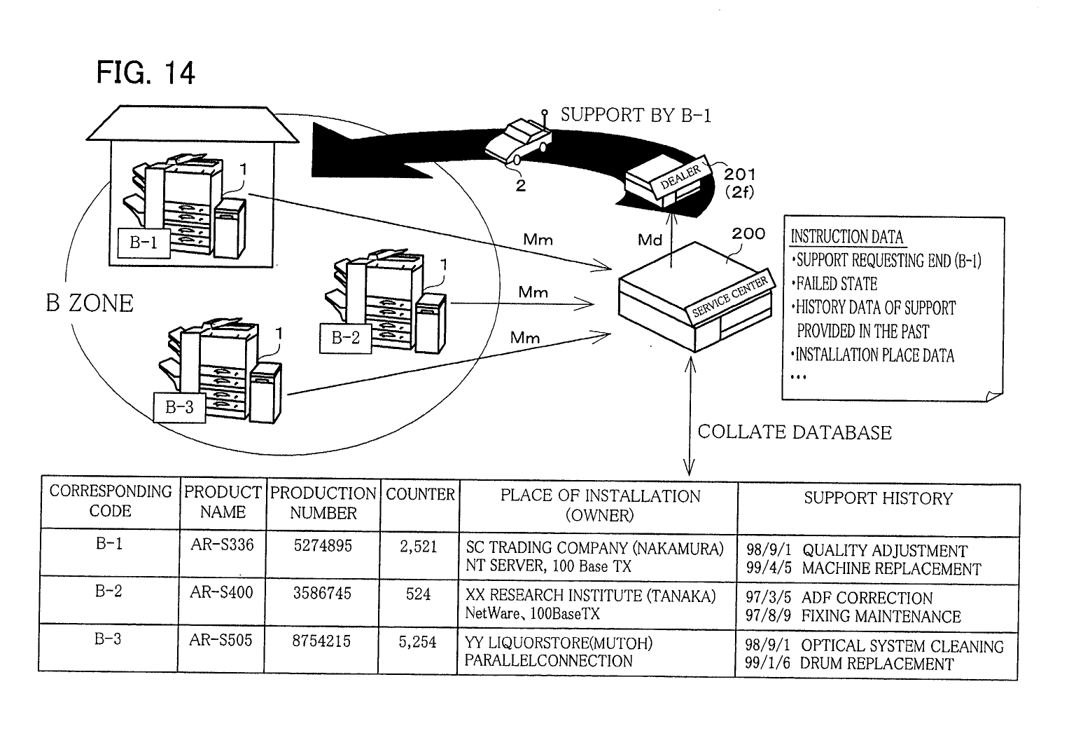

The following descriptions will explain the sixth embodiment of the present invention in reference to FIGS. 13 through 14. It should be noted however that the present invention is not intended to be limited to the structure of the present embodiment. For ease of explanation, members (structures) having the same functions as those shown in the drawings pertaining to any of the first through fifth embodiments above will be given the same reference symbols, and explanation thereof will be omitted here.

In the fifth embodiment, after transmitting the electronic mail from the digital composite machine 1 to the primary receiving end, the electronic mail is further transmitted from the primary receiving end to the secondary receiving end. In this process, for the secondary receiving end, the mobile and the data terminal is adopted. However, the secondary receiving end of the present invention is not limited to the above, and, for example, a dealer may be adopted.

Specifically, as in the previous fifth embodiment, the management system of the present embodiment includes a digital composite machine 1, a plurality of S-data terminals 2e (three in FIG. 13) as the receiving ends (secondary receiving ends) 2, and a data management device 4 which are connected via the network 3 as illustrated in FIG. 13. In the present embodiment, however, the receiving end 2 includes a dealer data terminal 2f other than a plurality of S-data terminal 2e. Here, the respective structures of the digital composite machine 1, the data management device 4, and the S-data terminal 2e are the same as those of the fifth embodiment (see FIG. 10), and thus the explanations thereof shall be omitted here.

The above dealer data terminal 2f includes a generally used personal computer, a work station, etc. Additionally, this dealer data terminal 2f can be used as data management device 4.

In the present embodiment, for the additive data additive to the instruction data, the history data regarding the digital composite machine 1 of the transmitting end of the apparatus data Mm is added.

Specifically, as explained in the fifth embodiment, assuming that there are three zones A to C, and the abnormality data is transmitted as apparatus data Mm by electronic mail from the digital composite machine 1 in B zone to the data management device 4 at the service center 200 (see FIG. 12). In the data management device 4 at the service center 200, by collating the database of the memory 46 with the apparatus data Mm, the additive data is extracted from the support history (history data) illustrated in FIG. 14.

For example, assuming that there are a plurality of digital composite machines 1 with corresponding codes in the B zone. In each digital composite machine 1, as illustrated in the support history table of FIG. 14, concrete support history are summarized in the table, such as corresponding codes, product names, production numbers, image-formed number of sheets (counter in the Table ), installation place (owner), support received in the past, etc.

For the digital composite machine 1 of the corresponding code B-1, history data summarized in the table include: the product name AR-S336, the production number 5274895, counted number of image formed 2,521, the installation place (owner) of Mr. Nakamura from SC Trading Company, support history in the past of the image quality adjustment on Sep. 1, 1998, and the replacement of the machine on Apr. 5, 1999. These data are also formed into database as additive data for all the digital composite machine 1. For respective digital composite machines 1 having other corresponding codes B-2 and B-3, the similar additive data are summarized in the database.

The data management device 4 (not shown in FIG. 14) at the service center 200 prepares the instruction data Md at the instruction data preparation section 43 as in the fifth embodiment. For example, in the case where the receiving end of the support is the digital composite machine 1 of the objective code B-1, the instruction data preparation section 43 prepares the instruction data Md at the support requesting end (contained in the apparatus data Mm as specific data), state (contained in the apparatus data Mm as self-diagnostic result Me), history data on the support performed in the past (extracted from the database), the installation place (extracted from the database, or included beforehand in the apparatus data Mm), etc.

Thereafter, in the present embodiment, the data management device 4 once transmits the instruction data Md to the dealer data terminal 2f (dealer 201) via the network 3. After receiving the instruction data Md, the dealer data terminal 2f transmits the instruction data Md to the S-data terminal 2e of the mobile (receiving end 2) which supports the zone (B zone) in which the user's address of the digital composite machine 1 having the corresponding code B-1 is located among the plurality of S-data terminals 2e (receiving ends 2). With this arrangement, it is possible for the corresponding mobile to immediately travel to the user (installation place) of the digital composite machine 1 having the corresponding code B-1 based on the instruction data Md received at the S-data terminal 2e, and it is therefore possible for the service personnel to still more appropriately deal with the current situation of the digital composite machine 1 to correct the failure.

In the present embodiment, as illustrated in FIG. 14, the instruction data Md is transmitted from the data management device 4 at the service center 200 to the predetermined S-data terminal 2e via the dealer data terminal 2f (dealer 201). Therefore, it may be arranged so as to further add the additive data to the instruction data Md at the dealer data terminal 2f.

As in the fifth embodiment, it may be arranged so as to transmit the instruction data Md directly from the data management device 4 at the service center 200 to the S-data terminal 2e. Here, it is preferable that the data of the same contents as the instruction data Md transmitted to the S-data terminal 2e be transmitted to the dealer data terminal 2f by the electronic mail.

In the case of the electronic mail, by setting a plurality of addresses, it is possible to transmit the same data all together to the plurality of S-data terminals 2e. It is therefore possible to significantly reduce the burden for the data transmission, and further by transmitting the instruction data of the same contents as the data transmitted to the S-data terminal 2e also to the dealer 201 (dealer data terminal 2f), it is possible to integrally manage the support state on the side of the dealer 201.

Further, in the present embodiment, it may be arranged so as to input other additive data from the management input section 44 of the data management device 4, or input the additive data from the input means (not shown) provided in the dealer data terminal 2f. For example, it is possible to input various data on the support history of respective digital composite machines 1 which cannot be recognized at the service center 200 but can be recognized at the dealer 201, when required as additive data to be transmitted to the S-data terminal 2e. As a result, it is possible to deal with the current state of the digital composite machine 1 in more efficient and accurate manner.

In the present embodiment, the digital composite machine 1 may be arranged so as to select a specific receiving end based on the time data obtained by the timer 15 as in the fifth embodiment.

For example, in the example explained earlier in the third embodiment, the dealer 201 is opened in the daytime from Monday to Friday, and thus in the digital composite machine 1, the electric mail should be transmitted to the dealer data terminal 2f on the priority. On the other hand, by arranging such that although the dealer 201 is closed on Saturday, Sunday and holiday, and nighttime, the service center 200 is open 24 hours, it is possible to arrange so as to transmit the electronic mail to the data management device 4 at the service center 200 on Saturday, Sunday, Holiday and nighttime.

Similarly, it may be arranged such that the data management device 4 selects the specific S-data terminal 2e based on the time obtained by the timer 45. For example, the following arrangement may be adopted. That is, in the open hours of the dealer 201, the electric mail of the instruction data Md is always transmitted to the dealer data terminal 2f. On the other hand, in closed hours of the dealer 201 but in the business hour of the service personnel, an electronic mail of the instruction data Md is transmitted directly to the S-data terminal 2e.

In the case of the digital composite machine 1, examples of the time obtained by the timer 15 include: preparation time of the self-diagnostic result Me, preparation time of the apparatus data Mm including self-diagnostic result Me, i.e., transmission time of the apparatus data Mm by electronic mail, etc. In the case of the data management device 4, examples of the time obtained by the timer 45 include: a time the apparatus data Mm is received from the digital composite machine 1, preparation time of the instruction data Md, i.e., time at which transmission of instruction data Md by electronic mail is almost ready.

As described, according to the foregoing structure, by arranging so as to transmit the apparatus data Mm to the receiving end 2 which is capable of dealing with the current situation according to the transmission of the electric mail, it becomes possible to deal with the current situation of the electronic apparatus in more efficient manner at any time of the day.

As described, in the present embodiment, since the dealer is set as the secondary receiving end, it is possible to further transfer the instruction data to the S-data terminal (service personnel). Namely, the S-data terminal serves as the tertiary receiving end. With this structure, it is possible to add additive data to the instruction data from the dealer data terminal (secondary receiving end).

As explained in the present embodiment, by adopting the history data on the digital composite machine on the transmitting end of the apparatus data for the additive data to be added to the instruction data, it is possible to more deal with a failure occurred in the digital composite machine in more accurate and efficient manner. Here, other data than the support history data may be used as history data.

[Seventh Embodiment]

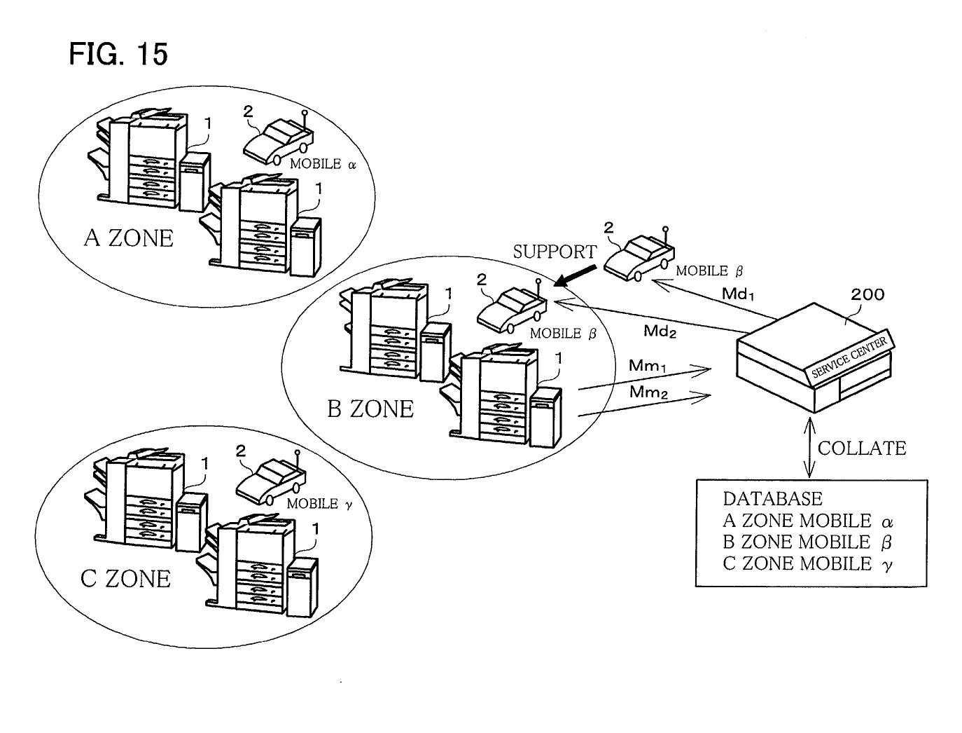

The following descriptions will explain the seventh embodiment of the present invention in reference to FIG. 15. It should be noted however that the present invention is not intended to be limited to the structure of the present embodiment. For ease of explanation, members (structures) having the same functions as those shown in the drawings pertaining to any of the first through sixth embodiments above will be given the same reference symbols, and explanation thereof will be omitted here.

In the present embodiment, in the data management device 4 at the service center 200, the previously received apparatus data Mm is designated as “former apparatus data”, and apparatus data Mm received from the same digital composite machine 1 after receiving the former apparatus data as “latter apparatus data”. Then, the management control section 42 transmits the latter instruction data prepared based on the received latter apparatus data as additive data to the specific S-data terminal 2e to which the former instruction data prepared based on the former instruction data has been transmitted.

For example, as illustrated in FIG. 15, assuming that a failure has occurred in the digital composite machine 1 in the B zone (the corresponding code B-2), and the previous instruction data Md1 is transmitted to the corresponding mobile β (receiving end 2) in the B zone, i.e., the data terminal of the mobile β (S-data terminal 2e, not shown in FIG. 15).

Here, from the digital composite machine 1 having the corresponding code B-2, the failed state, i.e., the self-diagnostic result Me (for example, the content b1 indicative of that a paper jam occurred at or above a predetermined frequency) is transmitted as the previous apparatus data Mm1, and is included in the previous instruction data Md1. Therefore, in the previous instruction data Md1 transmitted first to the data terminal (S-data terminal 2e) of the mobile β, self-diagnostic result Me of the contents b1 is included. Therefore, the service personnel on the way to the installation place of the digital composite machine 1 having the corresponding code B-2 prepares for the counter measurement according to the self-diagnostic result Me of the contents b1.

However, assuming that from the digital composite machine 1 having the corresponding code B-2, the latter apparatus data Mm2 including new self-diagnostic result Me (for example, the contents b2 indicative of that the transmission of sheet is now not permitted) is further transmitted. Then, the action to be taken by the service personnel in consideration of the self-diagnostic result Me having the contents b1 would not be sufficient, and thus, to be fully prepared for the problem indicated by the latter apparatus data Mm2, it is required for the service personnel to travel all the way back to the service center 200.

In the data management device 4, in the case where the apparatus data Mm is obtained successively from the same digital composite machine 1 (in this case, the corresponding code B-2), the management control section 42 controls such that the instruction data Md including new self-diagnostic result Me is always transmitted to the receiving end 2 selected first (in this case, mobile β), irrespectively of the contents of new self-diagnostic result Me or other conditions.

As a result, even if the state of the digital composite machine 1 has changed on the service personnel's way to the installation place of the digital composite machine 1 for which the support is needed, the instruction data Md would surely be transmitted successively to the specific receiving end 2. Therefore, it is possible for the receiving end 2 to appropriately recognize the state of the digital composite machine 1. Therefore, the management system of the present embodiment provides more appropriate services according to the current state of each digital composite machine 1 in more sufficient manner.

As described, in the management system of the present embodiment having the structures of the fifth or sixth embodiment, the former apparatus data previously received from the digital composite machine 1 is designated as “former apparatus data”, and the apparatus data Mm received from the same digital composite machine 1 later as “latter apparatus data”. Then, the management control device transmits the latter instruction data prepared based on the received latter apparatus data as additive data to the secondary receiving end to which the former instruction data prepared based on the former instruction data has been transmitted. Then, the digital management device transmits the latter instruction data prepared based on the former apparatus data received as additive data to the secondary receiving end to which the previous instruction data prepared based on the previous apparatus data is transmitted.

Therefore, even if the failed state in the digital composite machine is varied as time passes, the instruction data is surely transmitted successively to the specific secondary receiving end, and it is therefore possible for the service personnel of the receiver at the secondary receiving end to appropriately recognize the current failed state. As a result, it is possible to provide appropriate services for dealing with the current situation of the electronic apparatus in still more and efficient manner.

[Eighth Embodiment]

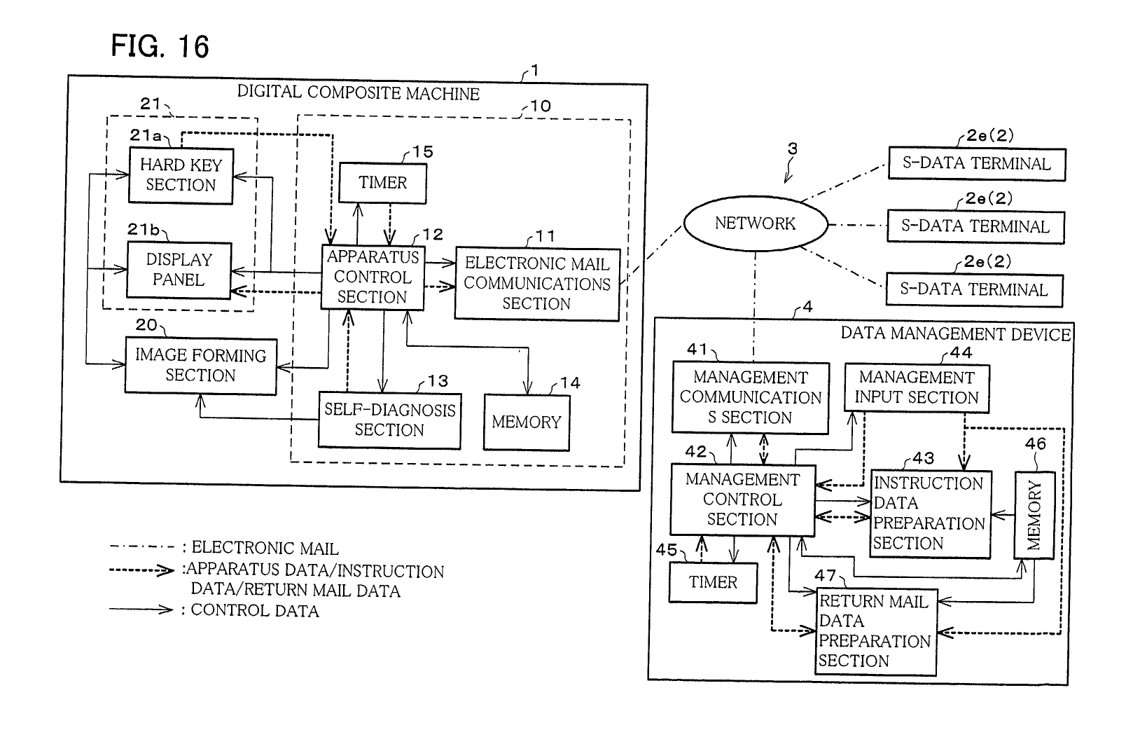

The following descriptions will explain eighth embodiment of the present invention in reference to FIGS. 16 through 20. It should be noted however that the present invention is not intended to be limited to the structure of the present embodiment. For ease of explanation, members (structures) having the same functions as those shown in the drawings pertaining to any of the first through seventh embodiment above will be given the same reference symbols, and explanation thereof will be omitted here.

In each of the previous embodiments, between the digital composite machine 1 and the data management device 4, an electronic mail of the apparatus data Mm can be transmitted only from the digital composite machine 1. In the present embodiment, however, the data management device 4 is capable of transmitting the specific electronic return mail data to the digital composite machine 1 upon receiving the apparatus data Mm from the digital composite machine 1.

As illustrated in FIG. 16, the management system of the present embodiment has almost the same structure as the management system of the fifth embodiment (see FIG. 10). However, in contrast to the structure of the fifth embodiment that the electronic mail is transmitted only from the side of the digital composite machine 1, in the present embodiment, the electronic mail can be transmitted also from the data management device 4 to the digital composite machine 1. Therefore, the electronic mail communications section 11 of the digital composite machine 1 is capable of not only transmitting the electronic mail but also receiving the electronic mail. Further, the data management device 4 is provided with a return mail data preparation section 47 for preparing the data for reply (return mail data Ma).

Further, in the digital composite machine 1, the return mail data Ma is transmitted from the data management device 4 by electronic mail, and thus, the apparatus data Mm and the return mail data Ma can be outputted bidirectionally between the apparatus control section 12 and the electronic mail communications section 11. Further, from the apparatus control section 12 to the display panel 21b, at least the return mail data Ma can be output. Namely, in the present embodiment, the digital composite machine 1 is capable of displaying the contents of the electronic mail (return mail data Ma) received from the data management device 4 on the display panel 21b under the control of the apparatus control section 12.

The return mail data preparation section 47 is provided for preparing not the instruction data Md to be transmitted to the S-data terminal 2e but the return mail data Ma to be transmitted to the digital composite machine 1. Basically, the digital composite machine 1 prepares the return mail data Ma to the digital composite machine 1 after transmitting the apparatus data Mm from the digital composite machine 1. For the structure of the data management device 4, the instruction data preparation section 43 and the return mail data preparation section 47 may be integrally provided.

In FIG. 16, the thick dashed line indicates the transmission/receiving path of the electronic mail to be communicated via the network 3, and an arrow of a thin line indicates an output path of the control data regarding the control operations of the digital composite machine 1 as in the case of the fifth embodiment (FIG. 10). However, the present embodiment differs from that of the fifth embodiment in that the data to be transmitted through the output path indicated by the arrow of the thick dotted line includes not only the apparatus data Mm and the instruction data Md but also the return mail data Ma.

As described, in the management system of the present invention, such data to be transmitted and received by the electronic mail as apparatus data Mm, instruction data Md and the return mail data Ma are referred to as the generic term “management system data”.

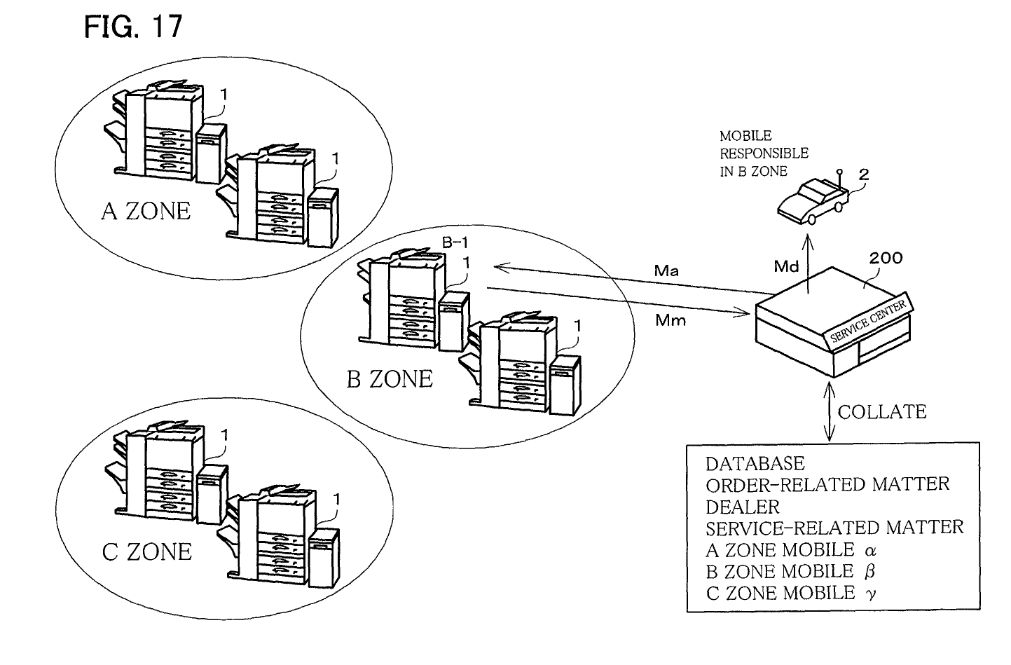

The present embodiment will be explained in more details. For example, as illustrated in FIG. 17, assuming that, among plurality of digital composite machines 1 in the B zone, a failure occurred in the digital composite machine 1 having the corresponding code B-1, and the image forming function cannot be used in that digital composite machine 1.

Here, in the basic management to be provided from the management system of the present invention, based on the self-diagnosis of the state of the digital composite machine 1 performed by the self-diagnosis section 13, the self-diagnostic result Me indicative of an abnormality in the image forming function is prepared, and further, the apparatus data Mm including this self-diagnostic result Me is prepared, to be transmitted to the data management device 4 (not shown in FIG. 17) at the service center 200 by the electronic mail.

At the service center 200, the instruction data Md including the apparatus data Mm and the support request, etc., is prepared by the instruction data preparation section 43 of the data management device 4, and the instruction data Md is transmitted by electronic mail from the management communications device 41 to the data terminal (S-data terminal 2e) possessed by the service personnel of the receiving end 2. As a result, it is possible for the service personnel of the receiving end 2 to promptly respond to the support request for the digital composite machine 1 having the corresponding code B-1.

In an event that abnormality occurred in the image forming function, it takes some time for the service personnel to arrive after transmitting the apparatus data Mm from the digital composite machine 1. Specifically, it takes sometime for the arrival of the service personnel as the following three steps need to be performed before the service personnel to arrive, i.e., \mathring{1} transmitting the apparatus data Mm from the digital composite machine 1; \mathring{2} transmitting the instruction data Md from the data management device 4 which received the apparatus data Mm to the service personnel, and \mathring{1} the arriving the service personnel of the receiving end of the electronic mail of the instruction data Md.

In the present embodiment, the return mail data Ma is prepared by the return mail data preparation section 47 in the digital management device 4, and the return mail data Ma is returned to the digital composite machine 1 (corresponding code B-1 in FIG. 17) of the transmitting end of the apparatus data Mm, and displays the return mail data Ma to the display panel 21b of the digital composite machine 1. As a result, the anxiety of the user before the arrival of the service personnel can be eased.

The return mail data Ma may be the receiving confirmation data indicative of that the apparatus data Mm including the self-diagnostic result Me has been surely received by the service center 200 (data management device 4).

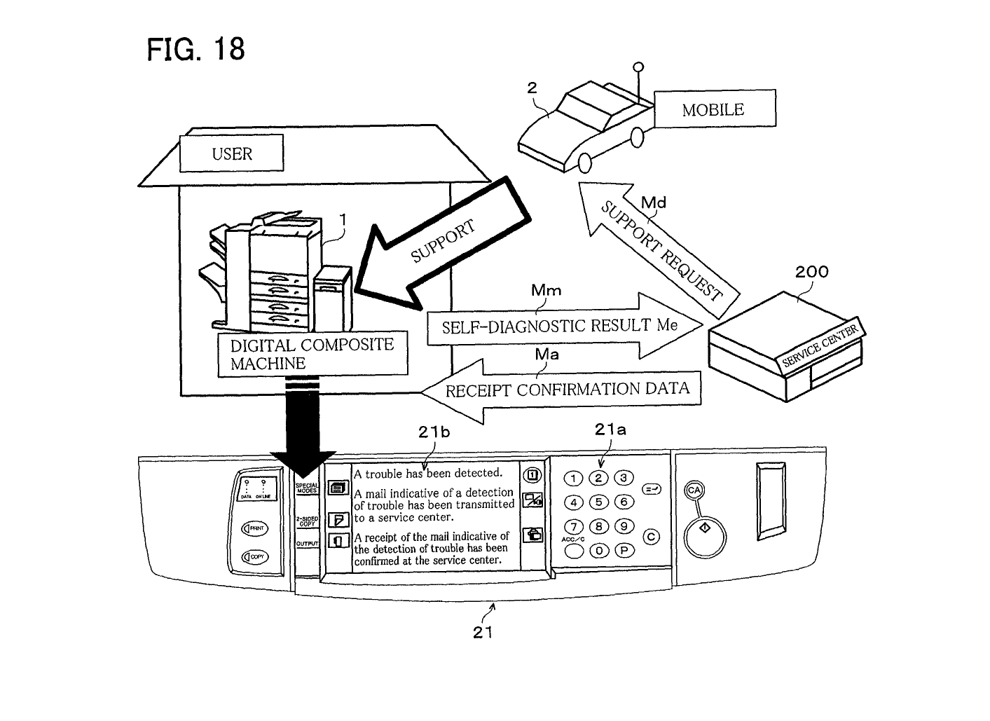

Specifically, as illustrated in FIG. 18, when the self-diagnostic result Me is prepared, for example, a message indicative of that “an abnormality detected” is displayed in the display panel 21b of the digital composite machine 1. Thereafter, the apparatus data Mm is transmitted to the service center 200, and, for example, a message indicative of that “the mail indicative of a detection of the abnormality has been transmitted to the service center.” is displayed. Then, the return mail data Ma is transmitted from the service center 200 to the digital composite machine 1, and, for example, a message indicative of that “the mail indicative of a detection of abnormality detection has confirmed to be received by the service center.” is displayed.

Further, in the present embodiment, the return mail data Ma may include the data on the service personnel in charge of the digital composite machine 1.

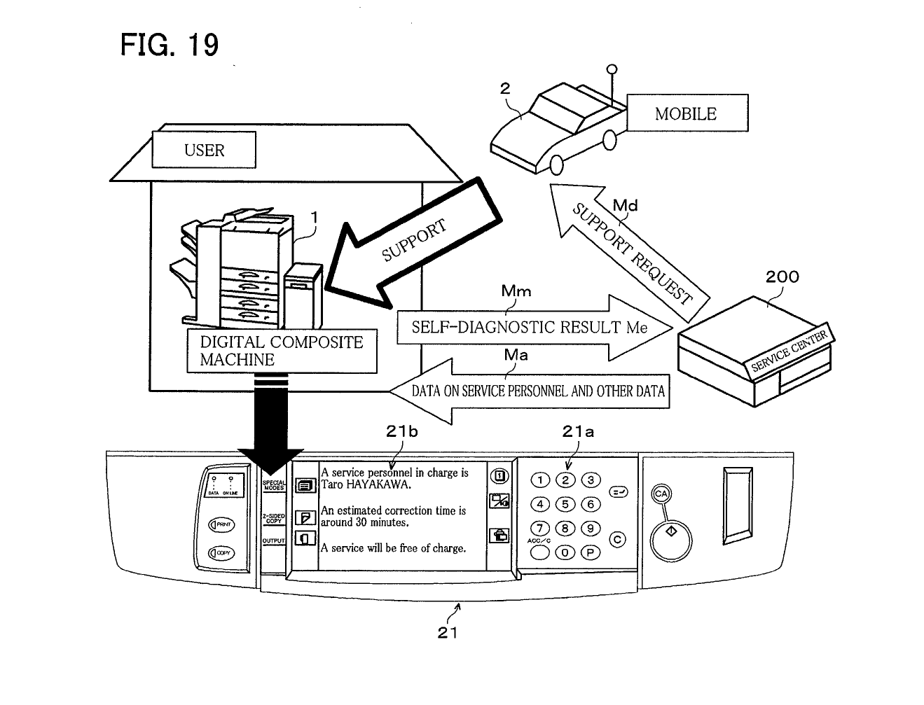

For example, as illustrated in FIG. 19, when a failure occurred in the digital composite machine 1, the apparatus data Mm including the self-diagnostic result Me is transmitted to the service center (data management device 4). Then, the data management device 4 selects from the database the service personnel (i.e., predetermined receiving end 2) in charge of the digital composite machine 1 subjected to the occurrence of a failure, and transmits the instruction data Md of the support request with respect to the S-data terminal 2e possessed by the service personnel (predetermined receiving end 2) in charge of the digital composite machine 1 from which the failure occurred. Here, various data on the service personnel in charge may be included in the return mail data Ma corresponding to the digital composite machine from which the failure occurred.

More specifically, in the data management device 4, when preparing the instruction data Md and the return mail data Ma based on received apparatus data Mm, data on the service personnel in charge such as the name of the service personnel, etc., are extracted from the memory 46 based on the apparatus data Mm of the digital composite machine 1. Then, the instruction data Md on the support request is transmitted to the S-data terminal 2e (see FIG. 16) as the receiving end 2, while the name of the service personnel in charge is transmitted to the digital composite machine 1 as return mail data Ma to be added to the receipt confirmation data.

On the side of the digital composite machine 1 which received the return mail data Ma, for example, as illustrated in FIG. 19, “The service personnel in charge is Taro HAYAKAWA” is displayed in the display panel 21b.

The data on the service personnel include not only the name of the service personnel but also the data such as mugshot, telephone number, etc. The data to be adopted as the data on the service personnel is not particularly limited, and may be changed depending on, for example, the display capacity of the display panel 21b.

As described, by incorporating the data regarding the service personnel in charge into the return mail data Ma, it becomes possible for the user of the digital composite machine 1 to have the data on the service personnel in charge such as the name of the service personnel beforehand. Therefore, such problem that the user feels suspicious about the service personnel visited at a later time can be eliminated.

Even in the case where the service personnel in charge has changed from the service personnel originally in charge for some reason, it is possible to inform the user of the change beforehand as return mail data Ma by electronic mail, and such problem that the user feels suspicious about the service personnel visited at a later time can be more surely prevented. The foregoing arrangement is desirable also for the service personnel in that since the user has already being informed of his/her data such as his/her name by the time he arrives at the user's place, it is possible for the service personnel to provide a necessary support management even in his first visit to the customer.

Further, in the present embodiment, various data indicative of the process of dealing with a failure may be included in the return mail data Ma.

The various data indicative of the process of dealing with a failure include the time required for correction, the cost for providing necessary service, etc. Specifically, in FIG. 19, as indicated on the display panel 21b of the digital composite machine 1, it is possible to inform beforehand the user of such data as “An estimated correction time is 30 minutes”, “A service will be free of charge.”, etc., in addition to the name of the service personnel (“The service personnel in charge is Taro HAYAKAWA”.)

As a result, it becomes possible for the user to have ideas on an estimated stoppage time of the digital composite machine 1, or costs for the correction of a failure beforehand. In this way, more appropriate action can be taken on the side of the user for the stoppage of the digital composite machine 1, and a sufficient time for the user to consider the costs can be ensured.

However, for the correction of the failure occurred in the digital composite machine 1, it is not necessarily that the support by the service personnel is always required. For example, even in the case where the cause of an inability of an image forming operation by the digital composite machine 1 is an incompletely closed front cover of the digital composite machine 1, the self-diagnosis section 13 prepares self-diagnostic result Me indicative of an occurrence of abnormality in the image forming function.

In this case, the failure can be corrected simply by closing the front cover properly without support by the service personnel. In response, the apparatus data Mm including the self-diagnostic result Me prepared by the self-diagnosis section 13 is transmitted to the data management device 4 at the service center 200, and upon confirming the incompletely closed state of the door at the data control device 4, the service center 200 can recognize that it is not necessarily to send a service personnel as the cause of the inability of an image forming operation is simply the incompletely closed door.

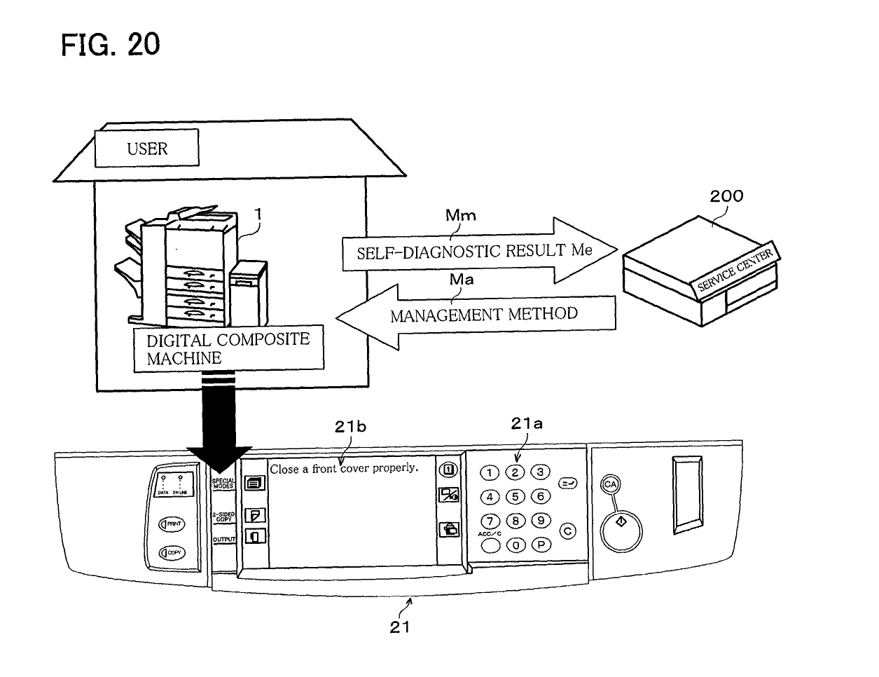

Therefore, it is possible to give an instruction to close the front cover properly by calling the user from the service center 200. In this case, in the arrangement where the electronic return mail can be transmitted as in the present embodiment, it may be arranged so as to add the data indicative of the process of dealing with a failure “close the front cover properly” to the return mail data Ma to be transmitted back to the digital composite machine 1 as a return mail. As a result, as illustrated in FIG. 20, the return mail data Ma “Close the front cover properly.” is displayed on the display panel 21b of the digital composite machine 1.

As described, when it is determined that the failure can be corrected by the user, the data indicative of the process of dealing with a failure can be added to the return mail data Ma to be transmitted from the data management device 4 by electronic mail to be displayed on the display panel 21b of the digital composite machine 1. As a result, such problem that the service personnel is send over even in response to the failure which can be corrected on the side of the user can be eliminated, and thus the cost for the necessary support management to correct the failure can be reduced.

As described, in the present embodiment, the return mail data can be transmitted from the image management device to the digital composite machine of the transmitting end of the apparatus data by the electric mail. Therefore, for example, in the wait time of the user to the completion of the correction of the failed state, by transmitting the return mail data, the anxiety of the user can be eased, thereby providing the management system more reliable to the customer.

It is preferable that in the return mail data, at least the receipt confirmation data for the acknowledgement of the receipt of the apparatus data be included, and more preferably at least one of the data indicative of the time required for the completion of the necessary action, the data on the person in charge, the data on the cost for the necessary service to correct the failure, and the data for providing direct instruction for the process of correcting the failure be included.

According to the foregoing arrangement, the user can confirm that the automatically transmitted apparatus data has been surely received by the service center. Further, by adding various data other than the receiving confirmation data return mail data, it is possible to inform the user of the rough idea of the necessary service to be received for the correction of the failure. As a result, the necessary service for the correction of the failure can be provided in more efficient manner.

[Ninth Embodiment]

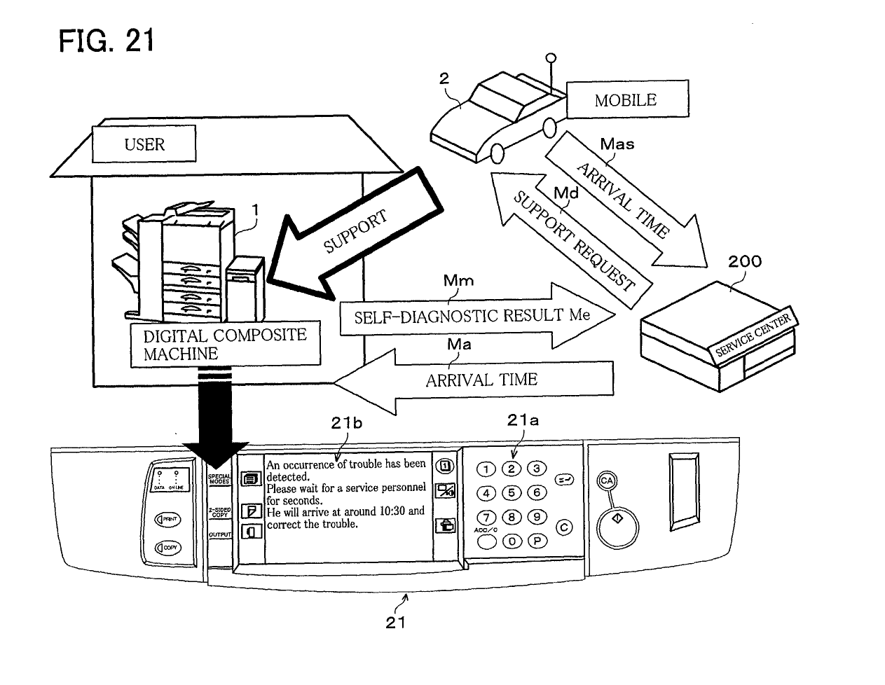

The following descriptions will explain ninth embodiment of the present invention in reference to FIG. 21. It should be noted however that the present invention is not intended to be limited to the structure of the present embodiment. For ease of explanation, members (structures) having the same functions as those shown in the drawings pertaining to any of the first through eighth embodiment above will be given the same reference symbols, and explanation thereof will be omitted here.

A management system in accordance with the present embodiment having the structure of the management system of the eighth embodiment is further arranged so as to be capable of transmitting an electronic return mail also from a S-data terminal 2e possessed by a service personnel, i.e., a receiving end 2 (secondary receiving end).

Namely, the management system in accordance with the present embodiment has almost the same structure as the eighth embodiment above (see FIG. 16). In the present embodiment, however, a reply by the electronic mail is permitted also from each of the S-data terminals 2e (FIG. 16) (data terminal at the service personnel).

For example, as illustrated in FIG. 21, when an electronic mail of the apparatus data Mm transmitted from the digital composite machine 1 is received by the data management device 4, the data management device 4 transmits the instruction data Md for the support request to the service personnel in charge (predetermined receiving end 2). In this state, on the side of the service personnel, an electronic return mail can be transmitted from the S-data terminal 2e possessed by the service personnel to the data management device 4 by the electronic mail.

Examples of the electronic return mail to be transmitted from the S-data terminal 2e (secondary reply data Mas) include address of the current position of the service personnel, the travel time of the service personnel from the current position to the place of installation of the digital composite machine 1 in which a failure occurred, estimated time of arrival of the service personnel at the installation place, etc.

On the side of the data management device 4, the return mail data Ma can be prepared by the return mail data preparation section 47 based on not only the contents of the apparatus data Mm received from the digital composite machine 1, and various additive data (the name of the service personnel) to be extracted from the database, etc., but also the contents of the received secondary return mail data Mas.

Specifically, for example, an estimated time of arrival of the service personnel at the user's place may be computed from the current position and the travel time of the service personnel to be added to the return mail data Ma. Further, in the case where the estimated time of arrival of the service personnel is originally contained in the secondary return mail data Mas, the return mail data Ma to which the above data as extracted is added may be transmitted.

As a result, as illustrated in FIG. 21, on the display panel 21b of the digital composite machine 1, in addition to the receipt confirmation data indicative of that an electric mail of the occurrence of failure has been received, such as “Abnormality has been detected.”, the estimated time of arrival of the service personnel such as “Please expect a service personnel to be arrived at around 10:30, for the correction of a failure.” can be displayed.

According to the foregoing structure, it is possible to provide services more reliable to the user, and further to eliminate the problem of receiving too many inquires from the user by telephone, etc., on the support request can be avoided in the period from the occurrence of failure till the arrival of the service personnel. As a result, the number of telephone support stuffs can be reduced, and it is therefore possible to provide delicate services at the minimum cost.

Here, for the estimated time of arrival, it is not necessarily be computed based on the contents of the secondary return mail data Mas nor extracted from the secondary return mail data Mas. For example, the travel time of the service personnel estimated from the Business area of the service personnel may be stored beforehand in the memory 46 of the data management device 4, and upon receiving the apparatus data Mm from the digital composite machine 1, his estimated time of arrival may be obtained by selecting or extracting the time data from the memory 46, or further computing the time data as required to be added to the return mail data Ma.

Further, in the case where the data on the digital composite machine 1 for which the service personnel is responsible is stored in the S-data terminal 2e possessed by the service personnel, the useful data for the service personnel can be transmitted to the data management device 4 as the secondary return mail data Mas. In the data management device 4, the secondary return mail data Mas can therefore be added to the return mail data Ma as additive data. As a result, services more reliable to the user who received the return mail data Ma can be achieved.

The data on the digital composite machine 1 stored in the S-data terminal 2e of the service personnel may be, for example, history data of failures occurred in the past, etc. Here, by transmitting the history record of failures occurred in the past to the service center 200 as secondary return mail data Mas, on the side of the service center 200, it becomes possible before the arrival of the service personnel to transmit from the data management device 4, the data for use in checking the detailed failed state on the side of the user as return mail data Ma, based on the history data. As a result, the digital composite machine 1 can be managed in more appropriate manner.

Additionally, although not shown, it may be arranged such that the S-data terminal 2e possessed by the service personnel is capable of transmitting and receiving electronic mail with respect to both the data management device 4 and the digital composite machine 1. With this structure, it is possible for the service personnel to provide support management by directly transmitting and receiving data with respect to the digital composite machine 1 without via the data management device 4. Further, by arranging the data management device 4 to be capable of managing the data which the service personnel directly transmitted and received with respect to the digital composite machine 1, even if the data are transmitted and received directly between the service personnel and the digital composite machine 1 (user), the support services can be managed systematically.

As described, the management system of the present embodiment having the structure of the management system of the eighth embodiment is arranged so as to be capable of transmitting an electronic mail from the secondary receiving end to the data management device. According to the foregoing arrangement, the data such as travel time of the service personnel to the user's place, etc., can be transmitted from the service personnel at the secondary receiving end. In the meantime, on the side of the data management device, the additive data attachable to the return mail data such as the estimated time of arrival of the service personnel prepared based on the data received from the secondary receiving end can be added to the return mail data to be transmitted to the digital composite machine. It is therefore possible to provide services more reliable to the user, and further to eliminate the problem of receiving too many inquires from the user by telephone. As a result, it is possible to provide delicate services at the minimum cost.

[Tenth Embodiment]

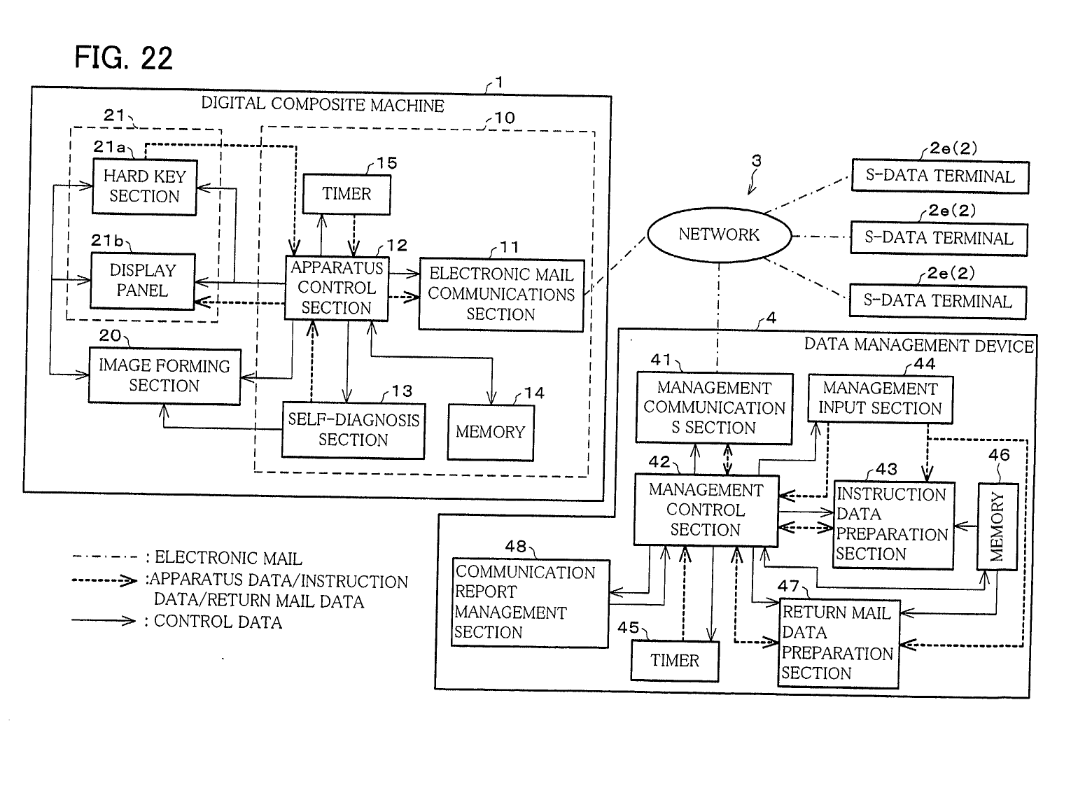

The following descriptions will explain the tenth embodiment of the present invention in reference to FIGS. 22 to 24. It should be noted however that the present invention is not intended to be limited to the structure of the present embodiment. For ease of explanation, members (structures) having the same functions as those shown in the drawings pertaining to any of the first through ninth embodiments above will be given the same reference symbols, and explanation thereof will be omitted here.

In the first through ninth embodiments, explanations have been given through the case where a failure if occurred can be always dealt with in an appropriate manner. However, it is possible that the digital composite machine 1, which has recovered from the failure occurred therein by the service performed by the service personnel in charge, is subjected to the same kind of failure again in a short period of time. In the present embodiment, explanations will be given through the case where the management system capable of dealing with such situation in the most efficient manner.

As illustrated in FIG. 22, the management system in accordance with the present embodiment has almost the same structure (see FIG. 16) as the management system of the ninth embodiment. However, the management system of the present embodiment is further arranged such that the data management device 4 includes a communication report management section 48.

The communication report management section 48 at least manages an electric mail of the apparatus data Mm transmitted from the digital composite machine 1. Namely, the communication report management section 48 manages so as to specify the receiving end of the apparatus data Mm from the plurality of digital composite machines 1, and the contents of the apparatus data Mm transmitted, etc. The communication report management section 48 then transmits the results of management to the management control section 42. Specifically, upon confirming that the apparatus data Mm including the similar self-diagnostic result Me have been transmitted twice or more times within a predetermined period, the communication report management section 48 prepares the management results based on the confirmed content.

The management control section 42 controls so as to alter the transmission process of the instruction data Md to the S-data terminal 2e based on the results of management. Specifically, the management control section 42 either controls the instruction data preparation section 43 to add detailed additive data to the instruction data Md or controls the management communications section 41 to change the S-data terminal 2e (secondary receiving end).

The management system of the present embodiment will be explained in more details. For example, in the fifth embodiment, explanations will be given through the case where a predetermined S-data terminal 2e is selected from the plurality of S-data terminals 2e based on the zone in which the digital composite machine 1 is installed, the kind of each digital composite machine 1, etc. However, in the foregoing structure, even if the same failure occurred within a short period of time, the support for the failure would be requested to the same service personnel who manages the failure occurred therein for the first time.

In the above case, the problem lies in that despite that necessary measurements have been taken by the service personnel in response to the failure occurred for the first time, the same failure occurred in the short period of time. It this case, even if the failure correction process performed in response to the failure occurred for the first time is repeated in response to the failure occurred again, it is very likely that the same failure would occur again.

In order to counteract the foregoing problem, the present embodiment is arranged so as to inform the service personnel of the detailed data on the failure as the instruction data Md to permit him to deal with the current situation of the digital composite machine 1 to correct the failure in more appropriate manner.

Namely, according to the present embodiment, if the same failure has occurred in the short period time, that would be managed by the communication report management section 48 which manages the transmitted electric mail of the apparatus data Mm. Then, based on the result of management, the management control section 42 controls the instruction data preparation section 43 to prepare detailed instruction data Md, and controls the management communications section 41 to transmit the resulting detailed instruction data Md to a predetermined S-data terminal 2e (see FIG. 22).

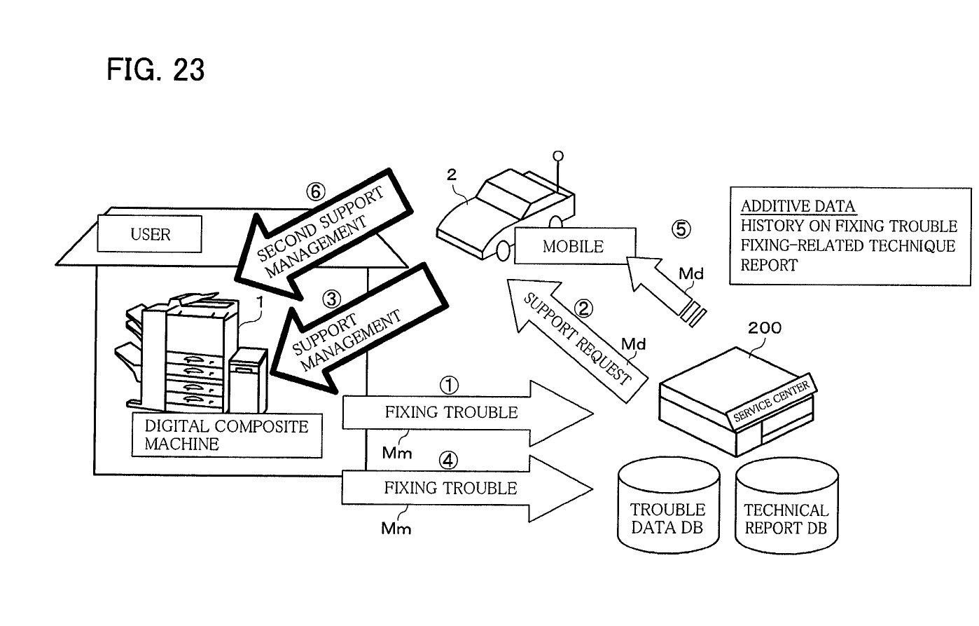

Specifically, as illustrated in FIG. 23, in response to the first request for the support service, the apparatus data Mm including the self-diagnostic result Me “\mathring{1} fixing trouble” is transmitted from the specific digital composite machine 1 to the data management device 4 of the service center 200 (not shown in FIG. 23). In the meantime, the data management device 4 transmits the instruction data Md “\mathring{2} support request” to the service personnel of the receiving end 2 (S-data terminal 2e).

In the case of instruction data Md “\mathring{2} support request”, the content of the self-diagnostic result Me may be “a trouble occurred in the fixing section is to be corrected”, and based on the above instruction data Md, the service personnel performs the “\mathring{3} support service” in response to the trouble occurred in the fixing section of the digital composite machine 1.

Here, assuming that the same kind of trouble has occurred again within one or two hours, or within a couple of days, and in response, the apparatus data Mm including the self-diagnostic result Me “\mathring{4} fixing trouble” has been transmitted to the data management device 4 at the service center 200. In this case, the communication report management section 48 in the data management device 4 determines that the same kind of failure has occurred within a short period of time (predetermined time) by collating the content of the trouble included in the apparatus data Mm with the history data on the failures occurred in the digital composite machine 1 of the transmitting end of the apparatus data Mm. The communication report management section 48 then prepares the management result.

In the data management device 4, based on the management result of the communication report management section 48, i.e., the result indicative of an occurrence of the same kind of failure in the same digital composite machine 1 within a short period of time, the management control section 42 instructs the instruction data preparation section 43 to prepare detailed instruction data Md.

The instruction data preparation section 43 selects the history data on the replacement of the fixing section in the corresponding digital composite machine 1 or the technical report prepared by the manufacturer on the fixing section from the database on failure (trouble data DB) or the data base on the technical report (report on the problem and solution of the digital composite machine) database (technical report DB). Then, the instruction data preparation section 43 adds the history data on the replacement of the fixing section or the technical report as selected to the instruction data Md as additive data to be transmitted to the service personnel.

Generally, the service personnel recognizes the support related technical contents such as the history data on the replacement of parts or the technical report on the parts. However, the service personnel may not recognize the technical content on the support i=for such reason as a continuing problem of a service personnel from the former service personnel in charge, etc. Further, even if the service personnel in charge fully recognizes the contents of the technical support, it is possible that the service personnel thinks of new ideas as to how to deal with the failure by checking the history data on failures, or the technical report once again.

In view of the foregoing, the present embodiment is arranged such that when the same kind of failure has occurred second time, in the instruction data Md “\mathring{5} second support management” to be transmitted to the service personnel (S-data terminal 2e) from the data management device 4, the technique related data such as history data on fixing trouble, fixing-related techniques, or technical report are added as additive data.

According to the foregoing structure, by referring to the additive data when dealing with a failure in response to the “\mathring{5} repetitive support request”, it is possible for the service personnel to deal with the failure occurred in the digital composite machine 1 in more appropriate manner as even the points he did not noticed in the first support management can be taken into consideration. As a result, the higher possibility that the digital composite machine 1 can be recovered from the failure can be expected.

The “short period” as the standard for the determination if the same kind of failure has occurred again is not particularly limited, and should be varied as necessary depending on various conditions. It is preferable, however, that the short period be set within a range of from one hour to two hours.

It may be arranged such that the communication report management section 48 determines the short period based on the time data obtained by the timer 45 explained earlier. Further, in the case where a rough classification is made as to the kind of failure beforehand, it may be arranged so as to set the short period for each kind of failure.

In the present embodiment, in response to the same kind of failure occurred in the short period of time, instead of providing more detailed instruction data Md, the service personnel in charge may be changed. Particularly, in the case where despite that the failure occurred second time has been corrected by the service performed by the service personnel in charge based on the more detailed instruction data Md, the digital composite machine 1 is subjected to the same kind of failure again, an improvement in the situation can hardly be expected if the same service personnel deals with the failure again (third time).

As another method of improving the possibility the digital composite machine 1 can be recovered from the failure occurred therein, it may be arranged so as to reconsider the standard for selecting the service personnel in the data management device 4. The reconsideration for the standard for selecting the service personnel can be realized, for example, by altering the standard for selecting the S-data terminal 2e in the management control section 42 (see FIG. 22) based on the result of management by the communication report management section 48.

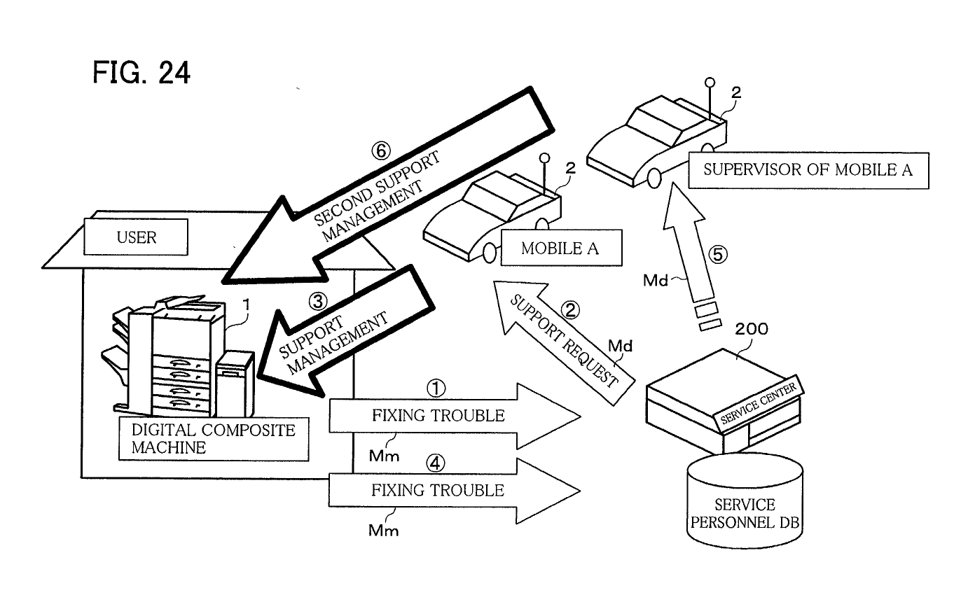

Specifically, as illustrated in FIG. 24, in the first support management, the processes as explained in reference to FIG. 23, i.e., the processes for \mathring{1} fixing trouble, \mathring{2} support request, and \mathring{3} support management will be explained.

Here, assuming that the similar fixing trouble has occurred within the short period of time, for example, within the predetermined time as in the above case, and the apparatus data Mm including the self-diagnostic result Me “\mathring{4} fixing trouble” is transmitted to the data management device 4 at the service center 200 (not shown in FIG. 24). In this case, as in the above-explained case, by collating the content of the failure (self-diagnostic result Me) with the history data on the failure of the digital composite machine 1 of the transmitting end of the apparatus data Mm, the communication report management section 48 of the data management device 4 determines that the similar trouble has occurred within the short period (predetermined time) and prepares a result of management.

Then, the management control section 42 of the data management device 4 selects based on the result of management, another service personnel (receiving end 2, secondary receiving end) capable of dealing with the failure occurred in the digital composite machine 1 from the service personnel database (service personnel DB) stored in the memory 46, and the instruction data Md \mathring{5} “support request” is newly transmitted to the S-data terminal 2e possessed by the service personnel as selected.

Here, if the support management is instructed to another service personnel who has about the same skill in dealing with the trouble, i.e., a service personnel whose technical level is about the same as the first service personnel, an improvement in the possibility for the digital composite machine 1 to recover from the failure can hardly be expected. Therefore, in the above case, the service personnel whose technical level is higher than that of the first service personnel in charge (mobile A in FIG. 24) such as a supervisor of the first service personnel (a supervisor in the mobile A in FIG. 24) is selected when selecting the receiving end 2. Then, \mathring{6} the second support management is performed by a new service personnel of higher technical level based on the instruction data Md at the S-data terminal 2e he possesses with respect to the digital composite machine 1 subjected to the same kind of failure again.

Namely, in order to realize a more appropriate selection of the service personnel, it is particularly preferable that the service personnel database of the present embodiment include data on the evaluated technical level of each service personnel (skill data). Specifically, it is desirable that the data on the engineer (service personnel) set for each secondary receiving end (S-data terminal 2e) and the data on the evaluated technical level of each engineer be stored in the memory 46 for each secondary receiving end (S-data terminal 2e). In this way, in the management control section 42, it is possible to surely select the service personnel with ease based on the data on the engineer and the data on the evaluated technical level of each engineer.

It is desirable that the instruction data Md to be transmitted to the new service personnel include the explanatory data on the continuing history of the service personnel so that the service personnel can be continued in more efficient manner.

As described, in the case where different service personnel from the former service personnel deals with the failure, it is preferable that the described support related techniques and the content of the first support management performed by the former service personnel be added to the instruction data Md to be transmitted for the \mathring{5} support request. In this way, it is possible for the new service personnel to fully recognize the contents of the first support management performed by the first service personnel, and it is thus possible to deal with the trouble which could not be solved by the first support management in more appropriate manner.

As described, according to the structure of the present embodiment, the data management device includes the communication report management section for collectively managing the apparatus data transmitted from the digital composite machine, and upon confirming that the apparatus data including the same self-diagnostic result twice or more times, the data management section controls to change the transmission process of the instruction data to the secondary receiving end.

Here, the transmission process is changed either by controlling the instruction data preparation section to add more detailed additive data to the instruction data or controlling the management communications section to alter the secondary receiving end of the instruction data, based on the management data obtained from the communication report management section.

According to the foregoing structure, in an event that the similar failure has occurred twice or more times, it is possible to prepare the instruction data which permits a failure to be corrected in more reliably manner, or to change the receiving end of the instruction data. As a result, it is possible to more surely deal with the current situation of the electronic apparatus to correct the failure in more reliable manner.

As described, the management system of the present invention which includes an electronic apparatus having a specific function and a predetermined receiving end connected to the electronic apparatus via the network and is arranged so as to adopt the management method of an electronic apparatus which at least includes the steps of i) preparing a diagnostic result of a self-diagnosis of a state of the electronic apparatus and ii) transmitting the data including at least the self-diagnostic result from the electronic apparatus to a predetermined receiving end by electronic mail.

According to the foregoing method, the self-diagnostic result is transmitted to the manager (predetermined receiving end) such as a service center, a dealer, etc., by electronic mail, and it is thus possible to surely obtain the data indicative of the current state of the electronic apparatus in digital data, and to store and reutilize the self-diagnostic result. As a result, for example, in an event that a failure has occurred in the electronic apparatus, consumable supply is used up, or the life of the exchangeable supply ends, it becomes possible on the side of the manager to provide more appropriate service to the electronic apparatus. As a result, it is possible to more reliably manage the digital composite machine as compared to the case of the conventional management system.

[Eleventh Embodiment]

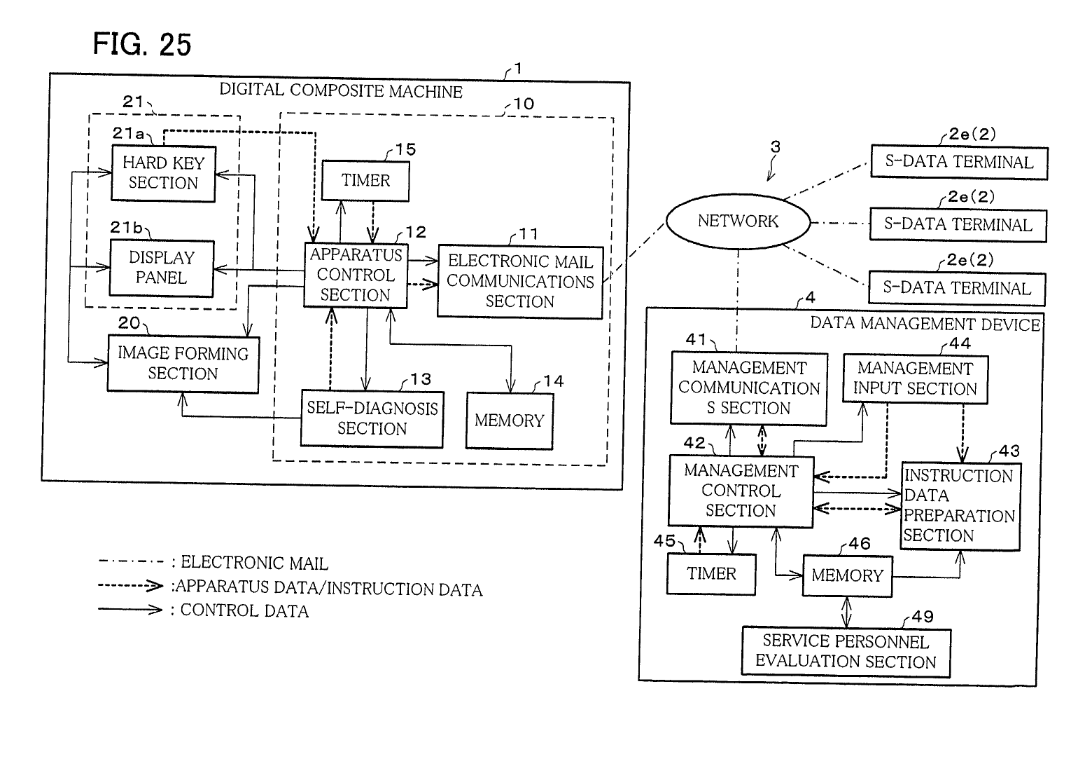

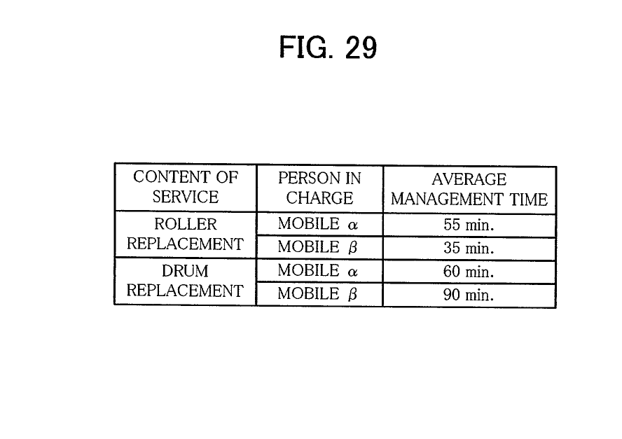

The following descriptions will explain the eleventh embodiment of the present invention in reference to FIGS. 25 to 29. It should be noted however that the present invention is not intended to be limited to the structure of the present embodiment. For ease of explanation, members (structures) having the same functions as those shown in the drawings pertaining to any of the first through tenth embodiments above will be given the same reference symbols, and explanation thereof will be omitted here.

In the fifth through tenth embodiments, explanations will be given through the case where the history data stored in the database in the memory 46 of the data management device 4 are used mainly for preparing the instruction data, more particularly for preparing the additive data in the instruction data to be transmitted to a S-data terminal 2e, etc., as the secondary receiving end 2.

In contrast, in the present embodiment, for the transmission and receiving of the apparatus data Mm and the instruction data Md, the history data to be automatically stored in the database is used for the evaluation of each service personnel.

As illustrated in FIG. 25, in the present embodiment, the electronic mail communications section 11 of the digital composite machine 1 is arranged so as to transmit a time at which an abnormality occurred as apparatus data Mm. Further, a time at which the service personnel completed the correction is informed to the data management device 4 as the apparatus data Mm to be transmitted by the electronic mail communications section 11 or the secondary return mail data Mas by the S-data terminal 2e. This correction completion time is stored in the database of the memory 46 as history data by the management control section 42.

In addition to the structure of FIG. 22, the data management device 4 is provided with a service personnel evaluation section 49. The service personnel evaluation section 49 computes the time required for the service personnel to correct the failure based on the history data in the database, and updates the described skill data of the service personnel in the SD database of the memory 46 based on the correction time. As a result, the data management device 4 automatically changes the skill data, and in the case where a plurality of service personnel are available, the instruction data Md can be transmitted to the S-data terminal 2e of the service personnel capable of dealing with the current situation to correct the failure in the shortest period of time. As a result, an average correction time of the service personnel can be reduced.

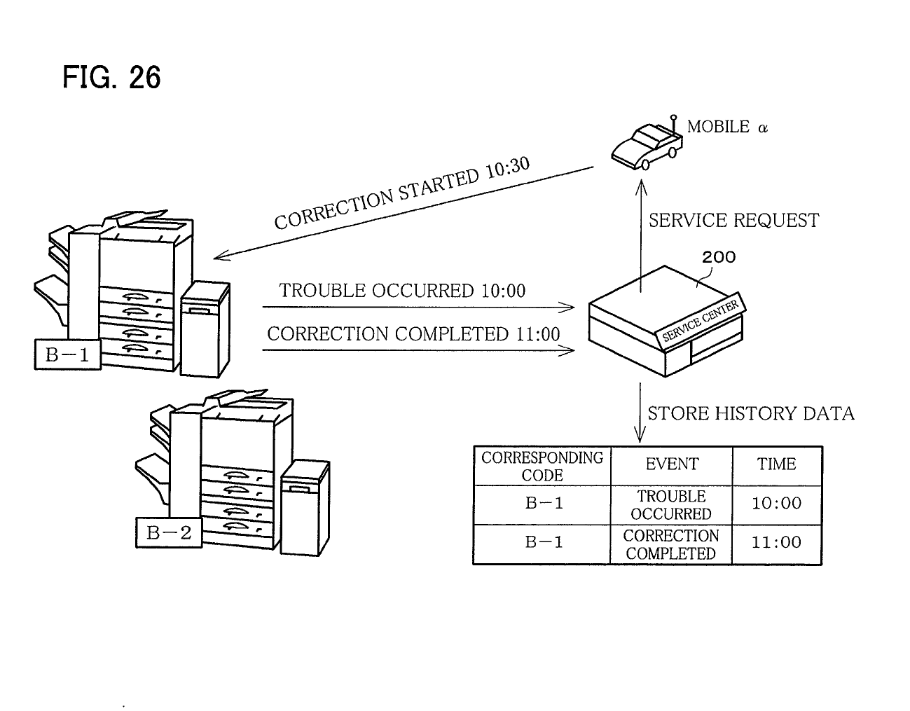

Specifically, as illustrated in FIG. 26, for example, when an abnormality has occurred at 10:00, the electric mail communications section 11 of the digital composite machine 1 (corresponding code B-1) transmits the apparatus data Mm indicating that “an abnormality has occurred at 10:00” is transmitted to the data management device 4 (service center). In this case, the data management device 4 transmits the instruction data Md to the S-data terminal 2e of the service personnel. In response, the service personnel in the mobile α travels to the place in which the failure occurred in the digital composite machine 1 can be corrected, such as the installation place of the digital composite machine 1. In this example, the service personnel arrives at 10:30.

Further, upon completing the correction by the service personnel, the apparatus control section 12 gives the electronic mail communications section 11 an instruction to transmit an electronic mail indicative of the failure has been corrected, according to the operation of the operation panel 21 by the service personnel, or the correction completion detection by the self-diagnosis section 13 of the digital composite machine 1, etc. On the other hand, the data management device 4 determines the time at which the correction has been completed based on the content, transmission time or receiving time of the electronic mail, and stores the correction completion time in the database of the memory 46. In the example shown in the FIG. 26, the correction completion time is at 11:00. In the Figure, explanations will be given through the case where the digital composite machine 1 transmits an electronic mail by the digital composite machine 1; however, in the case where an electronic mail indicative of the completion of correction can be transmitted, the S-data terminal 2e of the service personnel may transmit the electronic mail according to an instruction given by the service personnel.

Then, the history data indicative of that an abnormality occurred in the digital composite machine 1 at 10:00, and that the digital composite machine 1 (B-1) was recovered from the abnormality at 11:00 is stored in the memory 46.

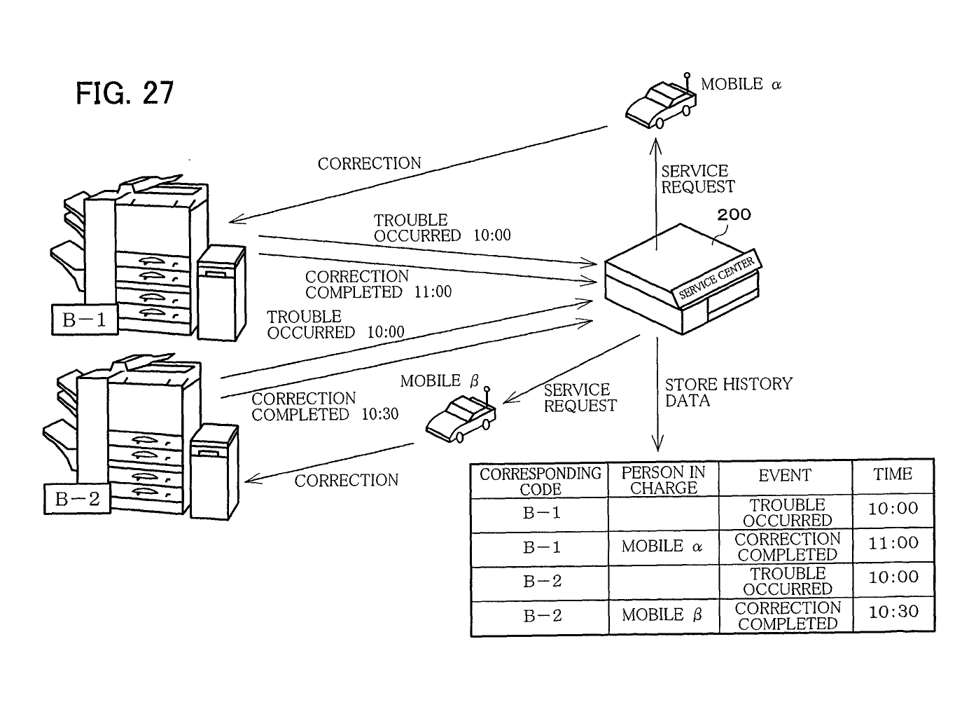

As illustrated in FIG. 27, the history data is stored every time an abnormality occurs in each digital composite machine 1 and the abnormality is corrected. In the memory 46, stored are the data (for example, corresponding code B-1, B-2) for use in identifying the digital composite machine 1 from which an event (occurrence of abnormality or completion of correction) has occurred, the data (mobiles α, β) for use in identifying the service personnel in combination with the occurrence time of each event.

In this case, the correction time required for the service personnel in the mobile α (hereinafter referred to as service personnel α) is around one hour, while the correction time required for the service personnel in the mobile β (hereinafter referred to as service personnel β) is around 30 minutes. Therefore, the skill data is updated such that the technical level for the service personnel β is higher than that of the service personnel α.

In the case where a plurality types of services, respective average times required for the completion of the services greatly differ, it is preferable that the skill data be prepared for each service in order to evaluate the technical level of each service personnel and deal with the failure in more appropriate manner.

Specifically, in the present embodiment, the skill data is prepared for each service content, and the electronic mail communications section 11 or the S-data terminal 2e transmits to the data management device 4, the service content included in at least either one of an electronic mail informing of an occurrence of abnormality or an electronic mail indicative of the completion of the correction of the abnormality. Then, the management control section 42 of the data management device 4 stores the received data of the above combination to which the service content is added as history data. Further, when the service personnel actually performs a service of some service content, the service personnel evaluation section 49 updates the skill data of the service content in the skill data of that service personnel.

According to the foregoing structure, when transmitting the instruction data Md of each service content, the data management device 4 can transmit the instruction data Md to an S-data terminal 2e of the service personnel who has high skill for the performance according to the content of the requested service and is capable of providing the requested service in the shortest period of time. As a result, an overall average correction time needed for the service personnel to provide requested service can be reduced despite that each service personnel has efficiency and deficiency depending on the field.

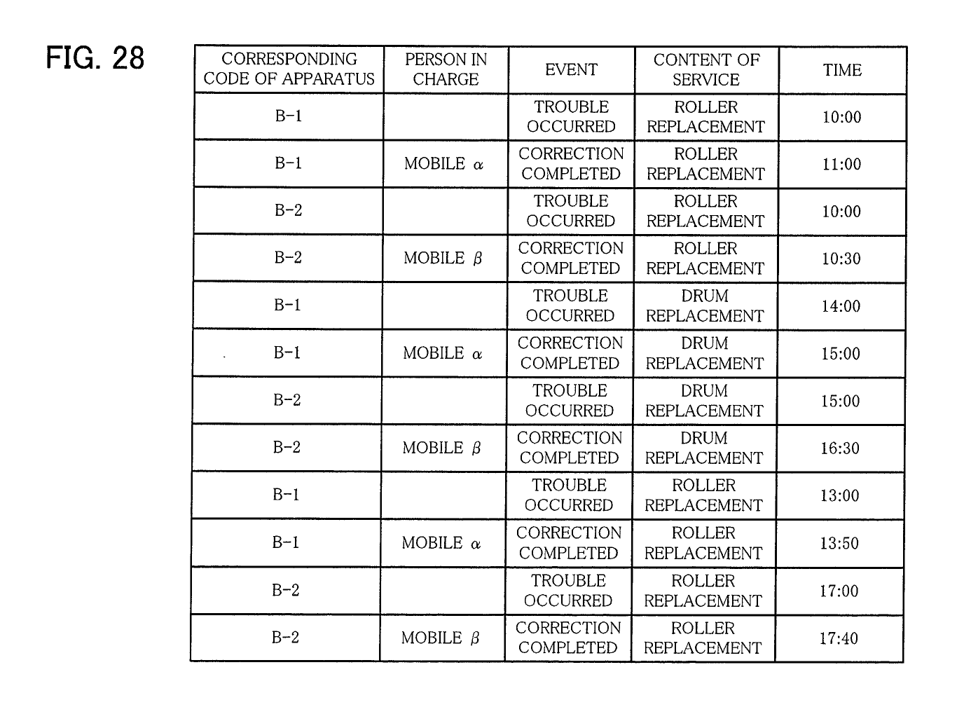

For example, as illustrated in FIG. 28, respective average management times for replacing used roller with new one by the service personnel α and β are 55 minutes and 35 minutes respectively. Therefore, in this example, in the case where the history data are stored, the service personnel evaluation section 49 sets respective skill data for the service personnel α and the service personnel β such that for the service of replacing roller, the skill data of the service personnel β is of higher level than that of the service personnel α, while for the service of replacing drum, the skill data of the service personnel α is of higher level than that of the service personnel β. Specifically, in the above example, the data management device 4 transmits the instruction data Md to the S-data terminal 2e of the service personnel α for the replacement of a feed roller while transmits to the S-data terminal 2e of the service personnel β for the replacement of a drum, in reference to the skill data stored in the memory 46. In this way, an average time required for the correction of failure can be reduced, and high quality customer service can be realized.

It should be noted here that, a correction time includes a travel time of each service personnel to the destination. Therefore, when preparing skill data by evaluating the skill of each service personnel based on his performances of only a few services performed in the past, it is likely that the skill data is prepared based on inappropriate evaluation. In practice, however, each service personnel generally provides services of the same kind many times, and thus storage of a large volume of history data in the data management device 4 can be expected. According to the foregoing management method of the present embodiment, it is therefore possible to appropriately evaluate the skill of each service personnel in each field of service and to automatically update the skill data.

[Twelfth Embodiment]

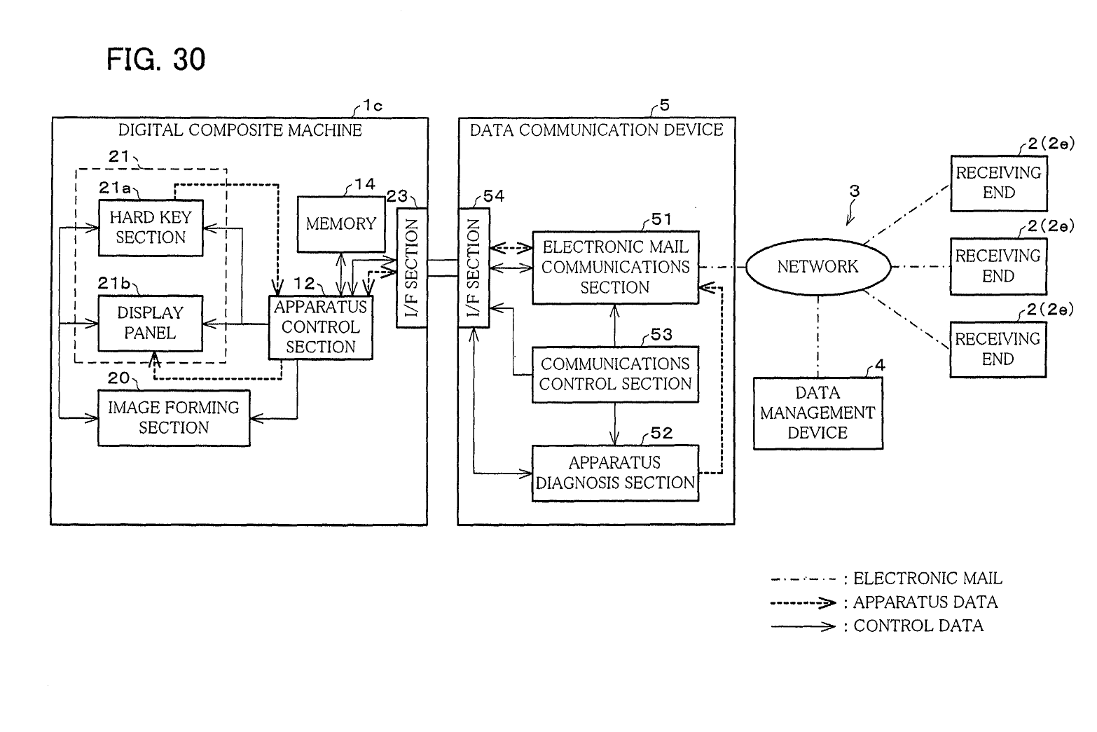

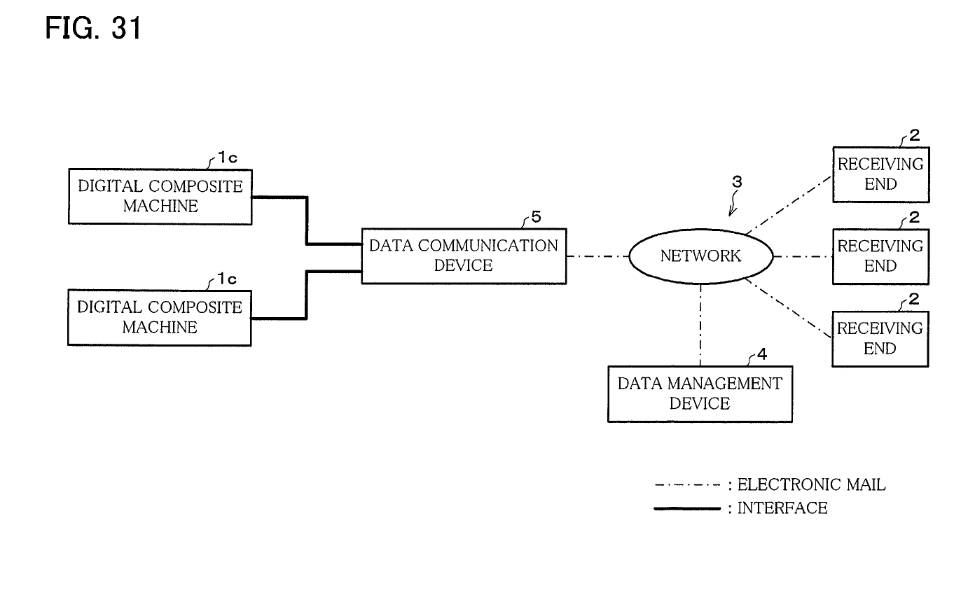

The following descriptions will explain the twelfth embodiment of the present invention in reference to FIGS. 30 and 31. It should be noted however that the present invention is not intended to be limited to the structure of the present embodiment. For ease of explanation, members (structures) having the same functions as those shown in the drawings pertaining to any of the first through eleventh embodiments above will be given the same reference symbols, and explanation thereof will be omitted here.

In the first through eleventh embodiments above, explanations have been given through the case where the digital composite machine 1 itself as an example of the electronic apparatus of the present invention stores therein the self-diagnosis section 13 and the electronic mail communications section 11 (see, for example, FIGS. 1 and 6) However, the present invention is not intended to be limited to the structure of these present embodiments. For example, as in the below-explained present embodiment, it may be arranged such that at least the self-diagnosis function and the electronic mail communication function may be integrated into an independently provided data communication device. Further, by mounting this data communication device onto the digital composite machine 1c (electronic apparatus) without the communication means, the digital composite machine 1c can consequently be provided with the data communication section 10 (see, for example, FIG. 1).

Specifically, for example, as illustrated in FIG. 30, in the management system in accordance with the present embodiment, the independently provided data communication device 5 is mounted on the digital composite machine 1c (without data communication function). Other than that the digital composite machine 1c is not provided with the structure corresponding to the data communication section 10, the digital composite machine 1c has the same structure as the digital composite machine 1. Specifically, the digital composite machine 1c of the present embodiment includes the image forming section 20, the hard key section 21a, the display panel 21b, the apparatus control section 12, the memory 14, various known structures (not shown) and the interface section (I/F section) 23.

On the other hand, the data communication device 5 includes an electronic mail communications section (communication means) 51, an apparatus diagnosis section (electronic apparatus diagnosis means) 52, a communication control section (communication means) 53, and an interface section (I/F section) 54.

The electronic mail communications section 51 functions as the communication means having the similar structure as the electronic mail communications section 11 for transmitting and receiving an electronic mail via the network 3. The apparatus diagnosis section 52 which corresponds to the self-diagnosis section 13 is provided for preparing the diagnostic result (corresponding to the self-diagnostic result Me) by the diagnosis of the state of the digital composite machine 1c. The I/F section 23 and the I/F section 54 are means for communicating various data between the digital composite machine 1c and the data communication device 5. The communication control section 53 controls overall operations of the data communication device 5, and particularly controls such that the apparatus data including the diagnostic result to be transmitted to the predetermined receiving end by the electronic mail communications section 51.

According to the foregoing structure, by connecting the I/F section 54 of the data communication device 5 and the I/F section 23 of the digital composite machine 1c, the digital composite machine 1c of the present embodiment can be functioned in the same manner as the digital composite machine 1 provided with the self-diagnosis function and the electronic mail communication function. The specific functions of the data communication device 5 are the same as those of the first through eleventh embodiments, and thus the explanations thereof shall be omitted here.

According to the foregoing structure, only by externally mounting the data communication device 5 on the digital composite machine 1c, it is possible to realize the management system of an electronic apparatus of the present invention even when adopting the digital composite machine 1c without the self-diagnosis function and the electronic mail communication function. Therefore, the management system of the present invention becomes applicable to a wider field, thereby improving the versatility of the present invention.

According to the structure of the present embodiment wherein the data communication device 5 is externally mounted to the digital composite machine 1c, in the case where a single user possesses a plurality of digital composite machines 1c, for example, as in the fourth embodiment above, it is possible to connect the single data communication device 5 to the plurality of digital composite machines 1c.

Namely, according to the structures of the first through eleventh embodiments, the data communication section 10 is needed for each of the digital composite machines (electronic apparatuses) 1. In the present embodiment, however, it is possible to provide only one data communication device 5 for the plurality of digital composite machines (electronic apparatuses) 1c.

Specifically, as illustrated in FIG. 31, in the case where a single user possesses two digital composite machines 1c, by connecting the single data communication device 5 to these digital composite machines 1c via the interface (thick line in the FIG. 31), it is possible to transmit the apparatus data by the single data communication device 5 with respect to both of the two digital composite machines 1c. Therefore, by separately providing the memory means (memory) in the data communication device 5, it is possible to collectively manage the history data of respective digital composite machines 1c.

The data communication device 5 may be arranged so as to transmit and receive the management system data such as apparatus data, return mail data, etc., via the I/F section 23 and the I/F section 54. For example, it may be arranged such that the apparatus data including the diagnostic result, which is prepared within the data communication device 5 and is transmitted to the receiving end 2 or the data communication device 4, is also transmitted to the digital composite machines 1c. Further, in the case where the return mail data is transmitted from the data management device 4 as in the eighth and ninth embodiments, the return mail data Ma may be displayed on the display panel 21b of the digital composite machine 1c via the I/F section 23 and the I/F section 54. Alternately, it may be arranged so as to transmit the apparatus data as input by means of the hard key section 21a of the digital composite machine 1c to the data communication device 5.

[Thirteenth Embodiment]

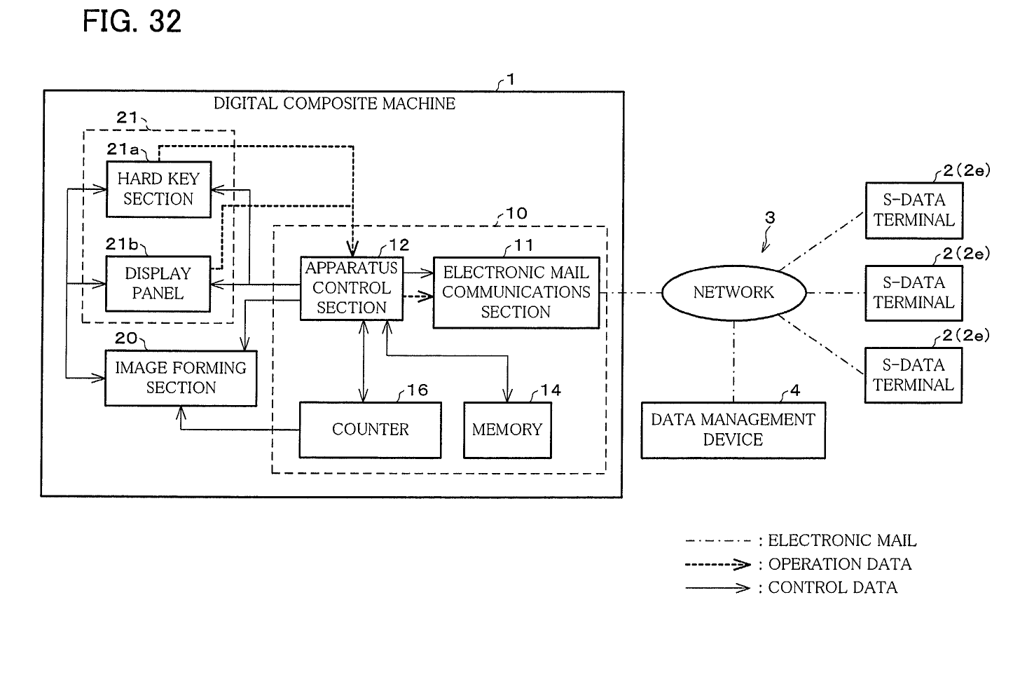

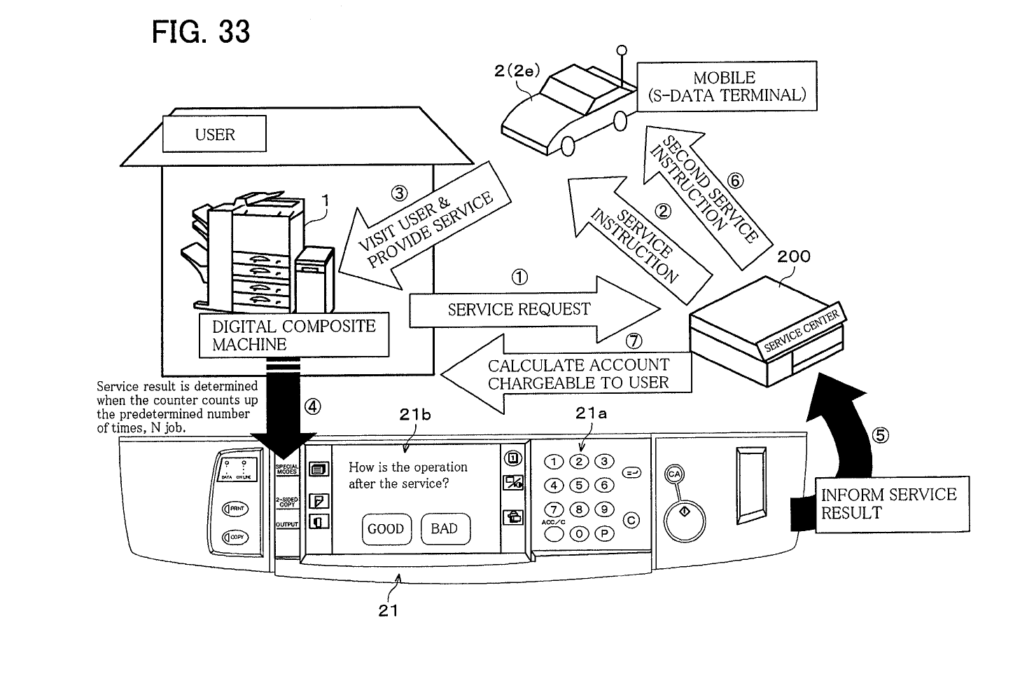

The following descriptions will explain the thirteenth embodiment of the present invention in reference to FIGS. 32 and 33. It should be noted however that the present invention is not intended to be limited to the structure of the present embodiment.

In the first to twelfth embodiments above, explanations have been given on the method of transmitting to the receiving end 2, the data related to the state of the digital composite machine 1, such as apparatus data Mm including the state, instruction data Md prepared based on the apparatus data Mm, etc., after detecting the state of the digital composite machine 1, by the self-diagnosis section 13 which performs a diagnosis periodically, or in accordance with the output form the sensor and the like. The data related to the state of the digital composite machine 1 are, for example, the apparatus data Mm indicative of the state of the digital composite machine 1, and the instruction data Md that is prepared in accordance with the apparatus data Mm. Further, it was explained that the transmission of appropriate data (such as Mm and Md) to an appropriate receiving end 2 can shorten the time required for supporting the digital composite machine 1 and improve the quality of the support.

On the other hand, in each of the below-explained embodiments, explanations will be given in the case where the state of the electronic apparatus is transmitted when operation of a specific function of the electronic apparatus is resumed after the electronic apparatus is serviced, as a suitable timing, among the timing to transmit the condition of the electronic apparatus, such as the digital composite machine 1, to a predetermined receiving end 2.

In short, in a management system of the electronic apparatus of the present invention, operation data (apparatus data), which is for showing how good the operation of the electronic apparatus is, that is, an operation condition of the electronic apparatus, is prepared upon resuming a specific function of the electronic apparatus after service is completed for the electronic apparatus. Then, the operations data is sent to a predetermined receiving end. On the other hand, the predetermined receiving end uses the operation data, at least, as a judgement reference for judging whether further service is required or not. This further ensures the management of the operation of the electronic apparatus, thereby providing still improved services.

It should be noted that, it is possible to employ any one of the methods used in the first to eleventh embodiments as to the method of selecting the receiving end and the method of preparing the electronic mail to the receiving end in accordance with the electronic mail sent from the electronic apparatus. However, in the following, mainly explained is an arrangement similar to the fifth embodiment, where the data management device 4 intermediates.

In short, the management system of a digital composite machine of the present invention (hereinafter, referred to simply as management system) has almost the same structure as that of the fifth embodiment (FIG. 10), and specifically includes the digital composite machine 1, a data management device 4 (primary receiving end) and an S-data terminal 2e (secondary receiving end) which are connected to the digital composite machine 1 via the network 3, as shown in FIG. 32. The management system may be provided with only one S-data terminal 2e, but plural S-data terminals 2e (three of them are provided in FIG. 32) are provided in the present embodiment as shown in FIG. 32.

Moreover, the digital composite machine 1 is provides with a built-in data communication section 10, which connects the digital composite machine 1 to the network 3, such as Internet.

The data communication section 10, which is connected to the network 3, is provided with an electronic mail communications section 11, an apparatus control section 12, memory 14, and a counter 16. The electronic mail communications section 11 transmits data to a predetermined receiving end via electronic mail, while the apparatus control section 12 controls the electronic mail transmission in accordance with operation of an image forming section of the digital composite machine 1. Note that, in the present embodiment, as explained later, apparatus data is prepared in accordance with an answer from a user for an inquiry, which is asked to the user at a timing that is designated by the counter 16. Therefore, the self-diagnosis section 13 is omitted in the present embodiment, on the contrary to the first to twelfth embodiments.

The electronic mail communications section 11 transmits machinery data, which will be discussed later, to a predetermined receiving end (the data management device 4) via electronic mail. The apparatus control section 12 control the electronic mail transmission of operation data, which has been input via an operation panel 21, to the predetermined receiving end (the data management device 4) as discussed later, while controlling operation of the whole digital composite machine 1, as a machine apparatus control section. In short, in the present embodiment, the apparatus control section 12 controls not only the data communication section 10, but also controls, as a machine apparatus control section, the operation of the whole digital composite machine 1.

In the memory 14, stored are various pieces of data on the control for the preparation of the machine data and the control of the electronic mail transmission. The counter 16 counts up how many times the image forming section 20 forms an image.

The operation panel 21 is provided with a hard key section 21a and a display panel 21b. The hard key section 21a and the display panel 21b are connected to the image forming section 20 and the data communication section 10 (the apparatus control section 12) so as to perform various input operation in regard of the operation of the digital composite machine 1. Especially, the operation panel 21 is, as discussed later, capable of receiving the operation data that shows the operation condition of the digital composite machine 1. For this reason, in the present invention, the operation panel 21 is not merely input means, but functions as operation data preparation means (an operation condition checking section and preparation section) that prepares the operation data in accordance with the input of the operation data on the operation condition of the digital composition machine 1.

As shown in FIG. 33, the hard key section 21a is structured with ten key for numbers and other keys (such as a start key and a clear key) so that various data can be input by operating the above keys.

The display panel 21b can display various data regarding the input operation and the electronic mail transmission in accordance with the control by the apparatus control section 12, while the display panel 21b can be used as input means as well as the display means because the display panel 21b is a touch panel. In other words, the display panel 21b can display a key that is operative on the display (denoted as a soft key, hereinafter) so that various data can be input by operating the soft key. Meanwhile, the display panel 21b functions as the notifying means and the trouble notifying means that notify the user, who has brought himself to the place where the digital composite machine 1 is installed, whether a function of the digital composite machine 1 operates normally.

It should be noted that, the present invention is not limited to the present embodiment where the operation data preparation means is the operation panel 21 provided with the hard key section 21a and the display panel 21b, but may include other means apart from the operation panel 21.

With the data management device 4, it is possible to transmit the data by electronic mail via the network 3 to the S-data terminals 2e as the secondary receiving ends. Specifically, the data management device 4 receives the operation data transmitted from the digital composite machine 1, while instruction data is prepared based on the operation data, so that the instruction data is transmitted to the S-data terminals 2e by electronic mail.

In the present embodiment, the operation data, which has been transmitted from the digital composite machine 1, regards the operation condition of the digital composite machine 1 as a result of the service (support and maintenance), that is, a service result. Moreover, upon the receipt of the service result, the data management device 4 transmits instructions for redoing service as the instruction data, to instruct a predetermined S-data terminal 2e to redo the service, based on what the service result says.

It should be noted here that, in FIG. 32, a thick dashed line indicates a transmission path of an electronic mail transmitted via the network 3, while a thick dotted-line arrow indicates an output path of the operation data. A thin-line arrow shows an output path of control data regarding the operation control of the digital composite machine 1 (including the display data regarding the display of the display panel 21b, and a counting result of a number of times of the image forming operation by the counter 16).

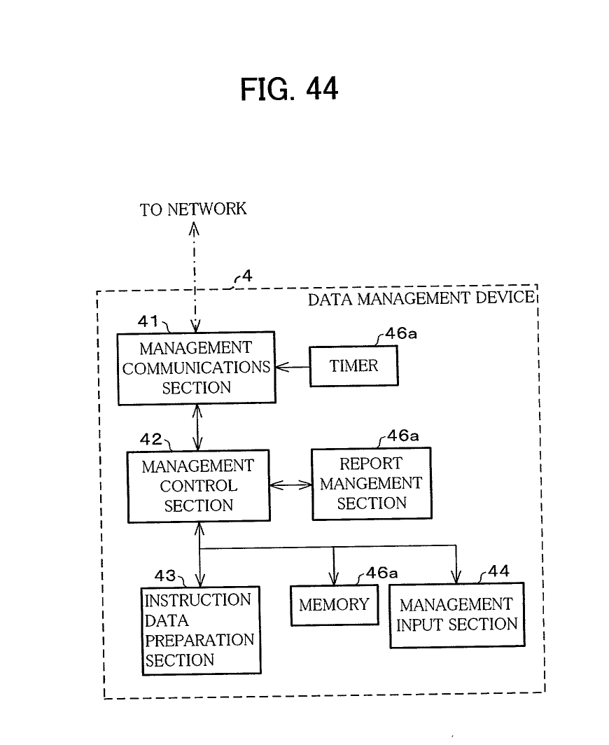

For example as shown in FIG. 44, the data management device 4 is provided with the management communications section 41, the management control section 42, the instruction data preparation section 43, the management input section 44, a timer 45a, and memory 46a. The management communications section 41 that receives an electronic mail via the network 3. The management control section 42 controls the operation of the data management device 4. The instruction data preparation section 43 prepares instruction data, which will be explained later. The management input section 44 receives instructions from a user of the data management device 4. The timer 45a acquires time and date of transmission and receipt of the electronic mail. Note that, in FIG. 44, the database, which is stored in the memory 46 in the fifth embodiment, and the communication report management section 48 shown in FIG. 22 are recited as a communication management section 48a, for convenience of explanation. The memory 46a is used as an operation region for the operation of the management control section 42.

The communication report management section 48a stores, data regarding communication between the data management device 4 and the digital composite machine 1, and between the data management device 4 and the S-data terminal 2e, such as operation data from the digital composite machine 1 by electronic mail, instruction data transmitted to the S-data terminal 2e by electronic mail, service history recording the previous services, or addressees of the digital composite machines 1 and S-data terminals 2e. Moreover, the management control section 42 stores the data regarding the communication in the communication report management section 48a, in accordance with the electronic mail transmitted and received by the management communications section 41. Further, the instruction data preparation section 43 prepares the instruction data for the S-data terminal 2e, in accordance with the instructions given by the management control section 42 that refers to the communication report management section 48a.

In this way, it is possible for the data management device 4 to instruct the S-data terminal 2e to provide an appropriate service with respect to the digital composite machine 1, in accordance with the operation data received from the digital composite machine 1.

It should be noted here that, in FIGS. 32 and 33, for convenience of the explanation, only one digital composite machine 1 is shown, but in reality there are plural users respectively having the digital composite 1 that is connected to the network 3.

In the present invention, the apparatus control section 12 controls the electronic mail management communications section 11 to transmit the service result to the data management device 4, upon the preparation of the service result as the operation data after the image forming operation by the image forming section 20 is resumed after the digital composite machine 1 has been serviced (supported or maintained).

In this way, transmitted to the data management device 4 by electronic mail after the service is the operation data that indicates the operation condition of the digital composite machine 1, for example, whether the image forming operation of the digital composite machine 1 is operated in an appropriate operation condition level, whether the digital composite machine 1 operates in an appropriate condition, or whether the digital composite machine 1 operates after the digital composite machine 1 is operated for a predetermined period.

The data management device 4 is installed in the service center 200 (the manager) for managing the digital composite machine 1. Therefore, it is possible to check accurately whether or not the service fully restores the functions of the digital composite machine 1, or whether or not the service is appropriate. In addition, in case there is still a trouble, it is possible to appropriately deal with a failure, thereby providing still improved services.

It should be noted that, in the present invention, the service (maintenance) includes correction, checking, replacement of the consumable supply and exchangeable parts for the digital composite machine 1 (electronic apparatus). Thus, in the present invention, the service includes those operations, namely: the repair of the electronic apparatus that has broken down, the check carried out regularly even if no failure occurs, and replacement of the consumable supplies, such as toner, and exchangeable parts. Moreover, the replacement may be replacement of a unit to expand the functions of the electronic apparatus, or replacement of a part composing the electronic apparatus or a unit of the electronic apparatus. Further, the service includes the expansion of the functions of the electronic apparatus by an addition of a unit. Of course, other types of operation may be included in the service, depending on a type of the electronic apparatus.

Next, a management system and a management method of the digital composite machine 1 of the present embodiment will be explained.

As shown in FIG. 33, when some failure has occurred in the digital composite machine 1, or it is time to perform maintenance of the digital composite machine 1 (maintenance time), firstly \mathring{1} the digital composite machine 1 sends a service request (for example, a request for correction or a request for checking) to the service center 200. The service request may be made by electronic mail by the electronic mail management communications section 11 provided in the digital composite machine 1 or by a user by telephone or by facsimile. However, similarly to the first to twelfth embodiments, the response can be prompt and appropriate when the service request is done by electronic mail. Even in this case, the digital composite machine 1 is proved with the electronic mail communications section 11 for reporting the operation condition after the service, while the data of the data management device 4 is stored as a receiving end. Therefore, even if the first service request is carried out by electronic mail, it is possible to utilize the sections for reporting the operation condition after the service, so as to deal with the service request by electronic mail, even though a few additional sections should be added. Therefore, it is possible to request the service by electronic mail without so many additional sections to be added in the arrangement.

After the receipt of the service request, the service center 200 \mathring{2} transmits by electronic mail service instructions to an S-data terminal 2e that is carried by a service personnel who is in charge of the digital composite machine 1, so as to instruct the service personnel to do service for the digital composite machine 1 that has sent the request.

In an example shown in FIG. 33, the service personnel is on the road, driving a mobile in his sales area. Therefore, \mathring{3} the service personnel visits the user by the mobile and provides various services for the digital composite machine 1 that requests the services, such as correction, checking and replacement of the consumable supply. It should be noted here that, in FIG. 33, for convenience of explanation, the mobile is numbered as 2, which is the reference number of the S-data terminal 2e.

After that, \mathring{4} the display panel 21b of the operation panel 21 displays a question for confirming the result of the service so that the user can answer whether or not a specific function (here, it is an image forming operation) is adequate (appropriate, or in order).

The user, after confirming the display, operates the operation panel 21 so as to input operation condition whether or not the image forming operation is adequate. As a result, a support result is prepared as the operation data of the image forming operation. The apparatus control section 12 controls the electronic mail management communications section 11 to make the data management device 4 to transmit the thus prepared service result. In this manner, \mathring{5} the service center 200 is notified of the service result judged by the user.

The service center 200 decides what to do next in accordance with what the service result says. In other words, if the support result says the image forming operation is adequate (appropriate, in order), it is judged that the user satisfies the service provided by the service personnel. Therefore, the data management device 4 \mathring{7} charges the user for the services provided.

On the other hand, if the service result says the image forming operation is still inadequate (inappropriate, or out of order), it indicates that the user is not satisfied with the service. Therefore, \mathring{6} the data management device 4 selects the service personnel in charge or another service personnel in some cases, so as to transmit instructions for redoing service by electronic mail to the S-data terminal 2e of the thus selected service personnel so as to instruct the service personnel to redo the service. Then, the service personnel visits the user again to redo the service for the digital composite machine 1 (the second visit is not shown here).

Note that, for Step \mathring{6}, there are some cases no service personnel needs to be dispatched to the user. For example, the failure of the digital composite machine 1 is solved while there is still a miner trouble to fix by adjustment, it is possible to solve the miner trouble by a remote operation by the service center 200 via the network 3, or by giving advice to the user, for example, by telephone. Therefore, the instructions for redoing service (the step \mathring{6}) is not limited to the dispatch of the service personnel.

As to Steps \mathring{4} through \mathring{5}, the display contents displayed on the display panel 21b of the operation panel 21 is not limited to a specific arrangement. For example, it may display an alternative question by means of the soft keys (touch keys) where or not the image forming operation is adequate or inadequate. This makes it easier for the user to select an answer; whether the operation condition of the image forming operation is adequate or inadequate.

Specifically, for example as shown in FIG. 33, a message “How is the operation after the service?” is displayed on the display panel 21b of the operation panel 21 of the digital composite machine 1 that has been serviced, while soft keys “Good” and “Bad” are displayed as the display to answer (input) whether the image forming operation is adequate (good) or inadequate (Bad), by means of the touch panel functions of the display panel 21b.

After confirming the display, the user may press (operate) the soft key for “Good” if the user judges the digital composite machine 1 works adequately and without a trouble. On the contrary, if the user judges the digital composite machine 1 is inadequate, the user may press (operate) the soft key for “Bad”. In accordance with which soft key is pressed (or the operation of the soft keys), prepared is the operation data whether the image forming operation is good (adequate) or bad (inadequate).

Furthermore, it is preferable in the present invention that the operation panel 21 displays the display for inputting the service result in accordance with the operation condition of the image forming operation that has been carried out until a specific condition set in advance is satisfied.

Right after the completion of the service, it is hard to properly determine if the digital composite machine 1 operates really appropriately without problem. Therefore, the specific condition may be set in advance so that the image forming operation is carried out until the specific condition is satisfied, so as to make a judgement on the operation condition of the digital composite machine 1 thereafter. This makes it possible to prepare operation data (a service result) that grasps the operation condition more precisely. Therefore, it is possible to provide more suitable service to the user.

The specific condition is not limited to a particular condition, but in the present embodiment, for example, a number of times of the use of the digital composite machine 1 after the service, that is, how many times the image forming operation is carried out after the service.

As shown in FIG. 32, the digital composite machine 1 is provided with the counter 16 that counts up how many times the image forming section 20 carries out the image forming operation (see the arrow pointing at the image forming section 20 from a position of the counter 16). Thus, the apparatus control section 12 sets in advance a specific number of times of the image forming operation, and controls the counter 16 to count up the number of times of the image forming operation carried out since the image forming operation by the digital composite machine 1 is resumed after the completion of the service, so that the message as shown in FIG. 33 is displayed on the display panel 21b, when the counting result reaches the specific number of times.

Specifically, where the counter 16 counts up one time of the image forming operation as 1 job, the specific number of times is set at N job (a specific numerical value, such as N=100). Then the apparatus control section 12 judges whether or not the counting result x job, which is obtained by the counter 16 counting the image forming operation, reaches the specific number of times N job (that is, x=N).

Then, at the time when the counter 16 obtains the counting result x job of the image forming operation that reaches the specific number of times N job, the display panel 21b of the operation panel 21 displays a message for confirming the result of service so as to ask the user whether or not the operation condition of the image forming operation is adequate since the completion of the service. In this manner, it is possible to prepare operation data (service result) that more precisely grasps the operation condition of the image forming operation.

Note that, it is preferable that it is possible to change the specific numerical value, such as the specific number of times N job as the specific condition, by operating the operation panel 21, for example. Depending on how the digital composite machine 1 is used, it is not constant how frequently the digital composite machine 1 is used. Therefore, it is arranged that the numerical value is altered considering how the user uses the digital composite machine 1. This makes it possible to prepare the operation data more surely, thereby more promptly responding to failures.

In this manner, the present embodiment makes the user confirm whether or not the digital composite machine 1 is restored by the service, and whether or not the appropriate service is provided. Therefore, it is possible to promptly deal with a failure, thereby providing still improved services. Moreover, because the cost of the services is charged only if the digital composite machine 1 is surely serviced, the cost is charged in a manner clear for both the manager and the user.

Note that, in the present embodiment, the data management device 4 is set as the primary receiving end, while the S-data terminals 2e are set as the secondary receiving end, so that the data management device 4 functions as a gateway for receiving the operation data from the digital composite machine 1 to transmit the service instructions to the S-data terminals 2e by electronic mail. However, the present invention is not limited to the above arrangement.

For example, if provided is a single S-data terminal 2e, but not the plurality of the single S-data terminal 2e, the digital composite machine 1 may transmit the service request or the service result directly to the S-data terminal 2e by electronic mail, without intermediation by the data management device 4. In short, the management system of the present invention may not include the data management device 4.

Moreover, the management system of the present invention may be so arranged that the digital composite machine 1 directly sends the electronic mail to the S-data terminal 2e even though the data management device 4 is included in the arrangement. For example, in Step \mathring{5}, the S-data terminal 2e may be the receiving end for the service result judged by the user.

However, even in the case where the service result is directly transmitted to the S-data terminal 2e, it is preferable that the service is managed by the service center 200 (that is the data management device 4). Therefore, for example, it may be arranged that the digital composite machine 1 transmits the service result to the S-data terminal 2e and the data management device 4 at the same time, or the service result is forwarded to the data management device 4 from the S-data terminal 2e that has received the service result.

[Fourteenth Embodiment]

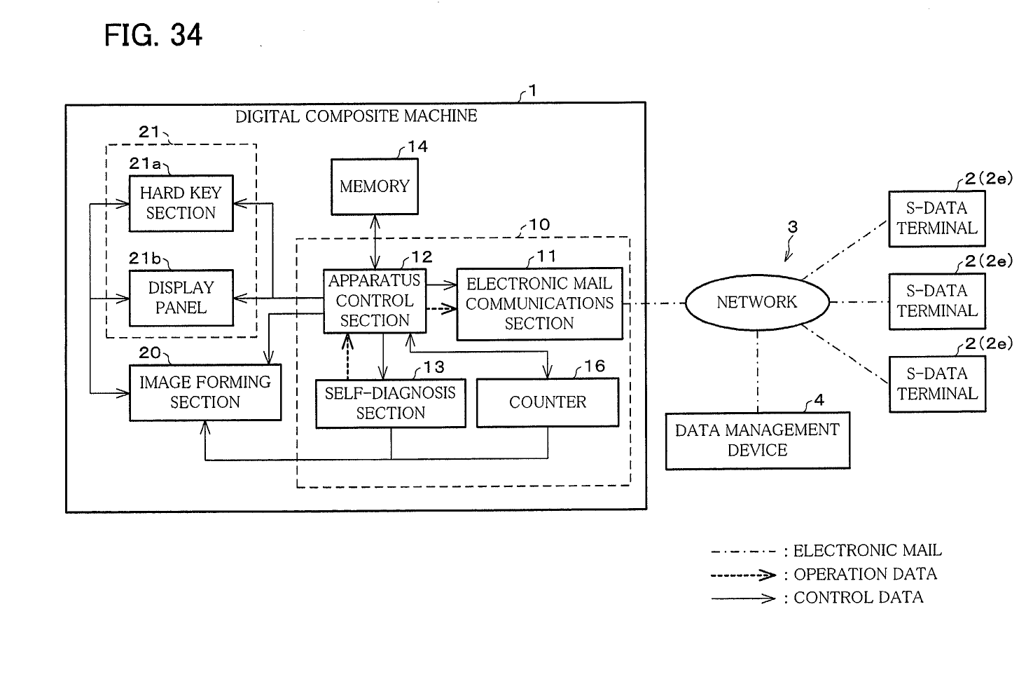

The following descriptions will explain the fourteenth embodiment of the present invention in reference to FIGS. 34 through 36. It should be noted however that the present invention is not intended to be limited to the structure of the present embodiment. For ease of explanation, members (structures) having the same functions as those shown in the drawings pertaining to the thirteenth embodiment above will be given the same reference symbols, and explanation thereof will be omitted here.

While the thirteenth embodiment employs the operation panel 21 as the operation data preparation means so that the user can operate the operation panel 21 so as to confirm the service result (the operation condition) after the service, the present embodiment has such an arrangement that a self-diagnosis section (self-diagnosis means) 13 as the operation data preparation means (the operation condition checking section and the preparation section), instead of the operation panel 21. The self-diagnosis section 13 diagnoses, by itself, the condition of a digital composite machine 1, and prepares a result of the self-diagnosis as operation data.

In other words, a management system of the present embodiment, as shown in FIG. 34, basically has the same arrangement as the thirteenth embodiment shown in FIG. 32, but differs in that the self-diagnosis section 13 is provided in the data communication section 10. It should be noted here that, the operation data is not outputted from a operation panel 21 in the present embodiment, as indicated by absence of the thick dotted-line arrow from the operation panel 21 to the apparatus control section 12, compared with FIG. 32. Meanwhile, as the other parts of the arrangement of the present embodiment is identical with that of the thirteenth embodiment, a detail explanation of the other parts is omitted here.

The self-diagnosis section 13 at least a diagnoses the condition of an image forming section 20 so as to prepare the self-diagnosis result, while an apparatus control section 12 controls the self-diagnosis section 13 to prepare the self-diagnosis result (the operation data) after the service so that the self-diagnosis result is transmitted by electronic mail to a data management device 4 as a primary receiving end. Of course, the apparatus control section 12 controls the whole operation of a digital composite machine 1, as the thirteenth embodiment.

In the following, the management system and the management method of the digital composite machine 1 of the present embodiment will be explained.

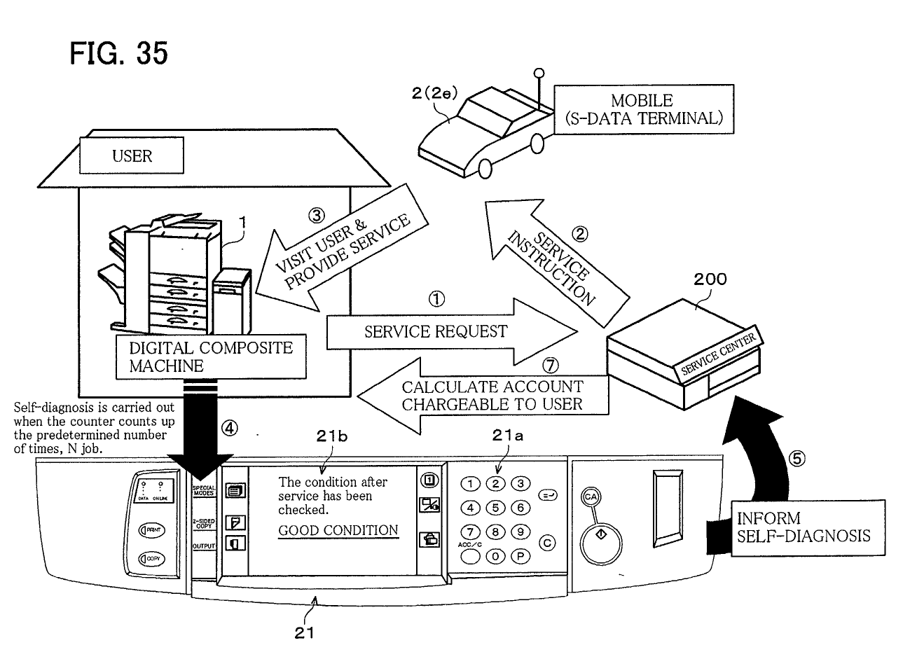

As shown in FIG. 35, in case the digital composite machine 1 has a trouble, or a time for maintenance has come for the digital composite machine 1, steps similar to those in the thirteenth embodiment are carried out. \mathring{1} The digital composite machine 1 sends a service request to a service center 200, then \mathring{2} the service center 200 transmits service instructions by electronic mail to an S data terminal 2e that is carried by a service personnel, so that \mathring{3} the service personnel visits a user of the digital composite machine 1 by a mobile for providing various services with respect to the digital composite machine 1 of the service requesting end. Until Step \mathring{3}, the procedure is identical with that of the thirteenth embodiment.

Further, in the present embodiment, the apparatus control section 12 controls the self-diagnosis section 13 to diagnose the condition of the digital composite machine 1. Then, \mathring{4} the self-diagnosis section 13 diagnoses to check whether or not the image forming operation is carried out normally, so as to check whether the service is adequate or not. Thereafter, the thus obtained self-diagnosis result is displayed on a display panel 21b of the operation panel 21, while \mathring{5} the service center 200 is notified of the self-diagnosis result via electronic mail.

The service center 200 decides what to do next, in accordance with the self-diagnosis result. Thus, if the self-diagnosis result says the service is satisfactory, it is judged that the user is satisfied with the service. Therefore, \mathring{7} the data management device 4 of the service center 200 charges the user for the services.

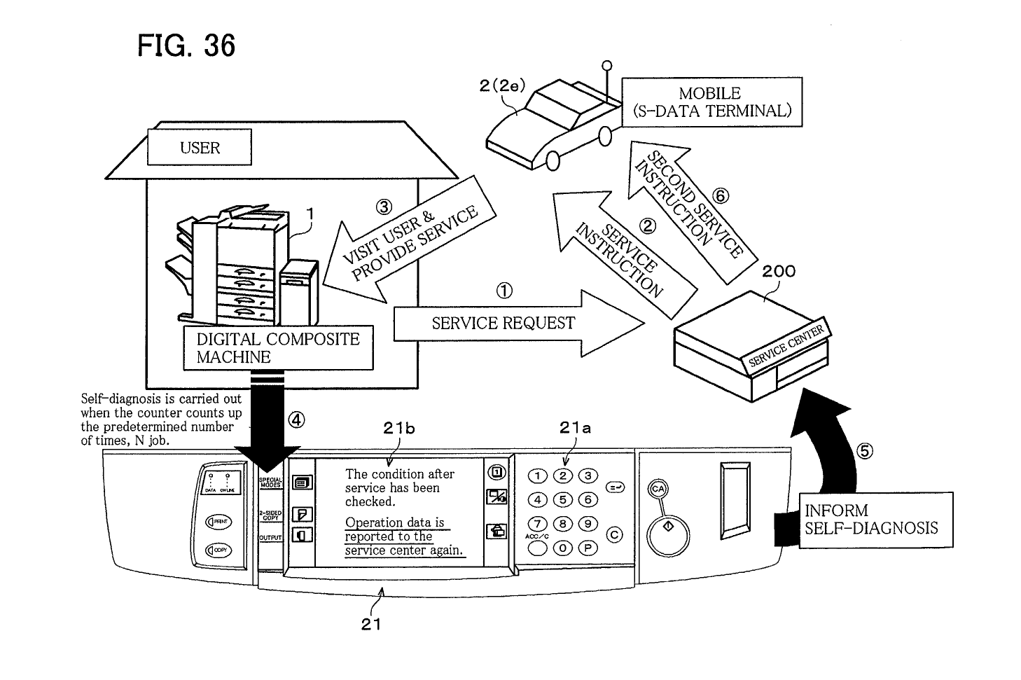

On the other hand, if the self-diagnosis result says the service is unsatisfactory, it indicates that the service is inadequate and the user is not satisfied with the service. Therefore, as shown in FIG. 36, \mathring{6} for example, the service personnel is instructed by electronic mail, to redo the service (service redoing instructions). Thus, the service personnel visits the user again for redoing the service.

In Steps \mathring{4} to \mathring{5}, a display message displayed on the display panel 21b of the operation panel 21 is not limited to a particular one, provided that at least the self-diagnosis result can be understood in outline.

For example, if the self-diagnosis result given by the self-diagnosis section 13 says “Good”, the display panel 21b displays a message “the condition after service was checked. GOOD CONDITION”, as shown in FIG. 35. After this, \mathring{5} an electronic mail management communications section 11 transmits the self-diagnosis result of “Good” (the condition is adequate) to the service center 200. Then, \mathring{7} the service center 200 charges the user for the services provided.

On the other hand, if the self-diagnosis result says “Bad”, the display panel 21b displays a message “The condition after service was checked. The service center is contacted again.”, as shown in FIG. 36. Then, the electronic mail management communications section 11 transmits the self-diagnosis result of “Bad” (the condition is inadequate) to the service center 200, so that \mathring{6} the service center 200 instructs the service personnel to redo the service.

In the same manner as the thirteenth embodiment, it is preferable again in the present embodiment that displayed is a message to input the service result in accordance with the operation condition of the image forming operation that has been carried out until a specific condition predetermined in advance is satisfied. In short, it is preferable that the self-diagnosis section 13 diagnosis when the specific condition predetermined is satisfied after the service is completed.

The specific condition is not limited, but just like the thirteenth embodiment, a preferable example is a number of times of use of the digital composite machine 1 after the service, that is, how many times the image forming operation is carried out after the service. Specifically, as shown in FIG. 34, a counter 16 is provided for counting how many times the image forming operation is carried out (x job). The number of times (x job) of the image forming operation is compared with the specific number of time (N job) predetermined in advance, so that the self-diagnosis section 13 diagnoses when the specific number of times is reached (x=N).

A specific example is provided here, where the digital composite machine 1 is provided with plural paper tray for feeding sheet, assuming that a second paper tray from the top has a paper jam when a sheet is fed from the second paper tray. It is assumed that the paper jam has been solved once by a service personnel who has provided various services to solve troubles that had caused the paper jam (Steps \mathring{1} to \mathring{3}).

After that, the self-diagnosis section 13 diagnoses whether or not the sheet is normally fed from the second paper tray in a period of time while the counting result x job by the counter 16 reaches the N job. If no paper jam is caused until the N job is reached, the display panel 21b displays the message “The condition after service was checked. GOOD CONDITION”, as shown in FIG. 35.

On the other hand, if paper jam is caused before the N job is reached, the display panel 21b displays the message “The condition after service was checked. The service department is contacted again.”, as shown in FIG. 36. Further, the service center 200 is notified of the self-diagnosis result so that the service center 200 decides what to do next in accordance with the self-diagnosis result, as discussed previously.

Note that, in case the self-diagnosis section 13 is provided so as to make all the judgement automatically, as in the present embodiment, the apparatus control section 12 may be so arranged that the apparatus control section 12 temporarily stops operation of a section of an electronic apparatus that causes the improper operation condition.

For example, in case the self-diagnosis section 13 prepares operation data that indicates the operation condition of the digital composite machine 1 is inadequate (the second paper tray has the paper jam), the apparatus control section 12 stops the second paper tray temporarily to feed the sheet, while controlling the electronic mail communications section 11 to transmit the operation data to the service center 200.

If the operation condition of the second paper tray is still inadequate even after providing the service, it is necessary to redo the service. Therefore, it is possible to suppress problems that are consequently caused, by stopping the second paper tray to feed the sheet at the same time when the operation data is transmitted to the service center 200. The problems, which are consequently caused, are for example, the trouble of the second paper tray gets more severe, or the trouble of the second paper tray adversely affects other sections.

In this way, the present embodiment makes the self-diagnosis section 13 to diagnose whether or not the service restores the digital composite machine 1 to function satisfactorily, and whether or not the service is adequate. This makes it possible to promptly respond to unsolved trouble or newly caused trouble after the service is done, thereby providing improved services.

Moreover, because the cost of the service is charged only if the adequate service is provided, it is possible to charge the cost in a manner that is clear to both the manager and the user.

[Fifteenth Embodiment]

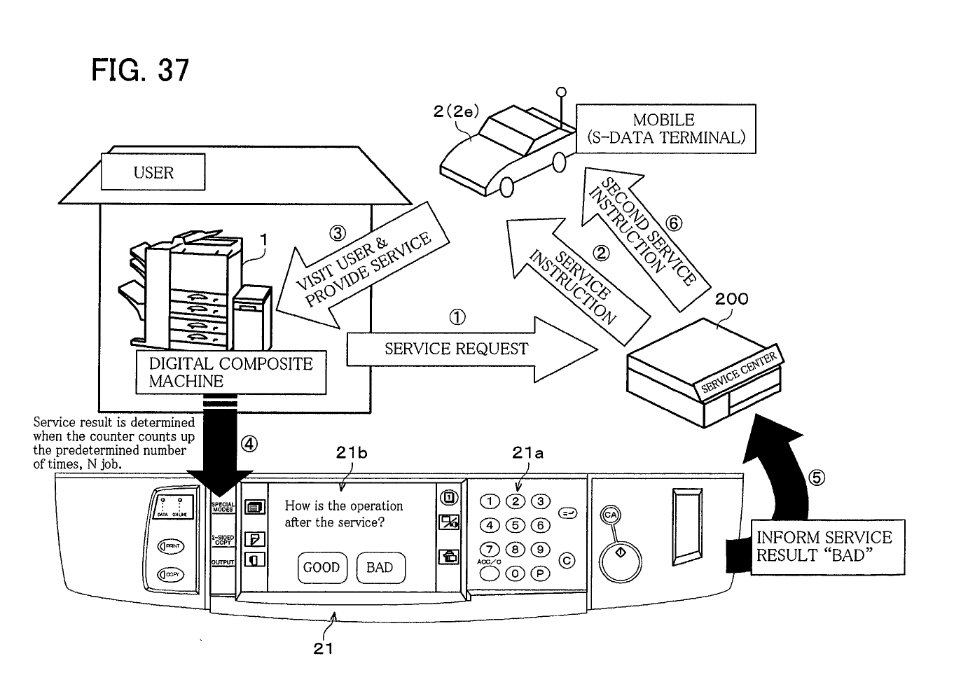

The following descriptions will explain the fifteenth embodiment of the present invention in reference to FIG. 37. It should be noted however that the present invention is not intended to be limited to the structure of the present embodiment. For ease of explanation, members (structures) having the same functions as those shown in the drawings pertaining to the thirteenth and fourteenth embodiments above will be given the same reference symbols, and explanation thereof will be omitted here.

On contrary to the thirteenth and the fourteenth embodiments where the service center 200 is notified of the operation data by electronic mail irrespective of what is said in the judgement of the user or the self-diagnosis result (whether or not the service is adequate or inadequate), the present embodiment has such an arrangement in which an apparatus control section 12 controls the electronic mail management communications section 11 to transmit the operation data to a service center 200, only when prepared is operation data to inform that operation condition of a digital composite machine 1 is inadequate.

For example, two types of contracts for the service of the digital composite machine 1 may be offered: a full service contract with a fixed rate that includes all services at the fixed rate, and a spot service contract with a variable rate that provides services when necessary and charges a cost of the services each time. The thirteenth and the fourteenth embodiments are the spot service contracts, because the service is charged for each trouble. However, the full service contract is not charged for each failure. In other words, Step \mathring{7} is unnecessary for the full service contract. In this case, Step \mathring{5}, in which the digital composite machine 1 notifies the service result, is unnecessary when the service result is good. Therefore, in the present invention, Step \mathring{5} is carried out only when a failure occurs.

Specifically, some failure has occurred as shown in FIG. 37, and in response, the step \mathring{1} through the step \mathring{3} are performed as in the thirteenth or fourteenth embodiment.

After that, for example as shown in FIG. 37, \mathring{4} operation data is prepared, where the message “How is the operation after the service?” and the soft keys “Good” and “Bad” on the display panel 21b of the operation panel 21 of the digital composite machine 1 that has been serviced, so that a user judges the result of the service. Alternatively, in \mathring{4}, the operation data is prepared by diagnosing the result of the service automatically by the self-diagnosis section 13 (not shown in FIG. 37) as shown in FIGS. 35 and 36 of the fourteenth embodiment.

In case the thus prepared operation data says the operation condition is inadequate, for example as shown in FIG. 37, a soft key of “Bad” is pressed (refer to the thirteenth embodiment), or the self-diagnosis result says the trouble is caused (the fourteenth embodiment), \mathring{5} the service center 200 is notified of the operation data by electronic mail. On the other hand, in case prepared is operation data of “Good”, Step \mathring{5} is not carried out.

Because the service center 200 receives by electronic mail only the operation data to tell the operation condition is inadequate (the service result is “Bad”) as shown in FIG. 37, \mathring{6} the data management device 4 of the service center 200 instructs, for example, a service personnel to redo the service. Therefore, Step \mathring{7} is not carried out, on contrary to the thirteenth and the fourteenth embodiments.

As discussed above, no more service is necessary when the operation is adequate, while additional service is needed if the operation is inadequate. Thus, the service center 200 is notified of the condition of the digital composite machine 1 only when the additional service is necessary, that is, the operation condition is inadequate. This makes it possible to deal with the failure promptly, thereby providing still improved services.

[Sixteenth Embodiment]

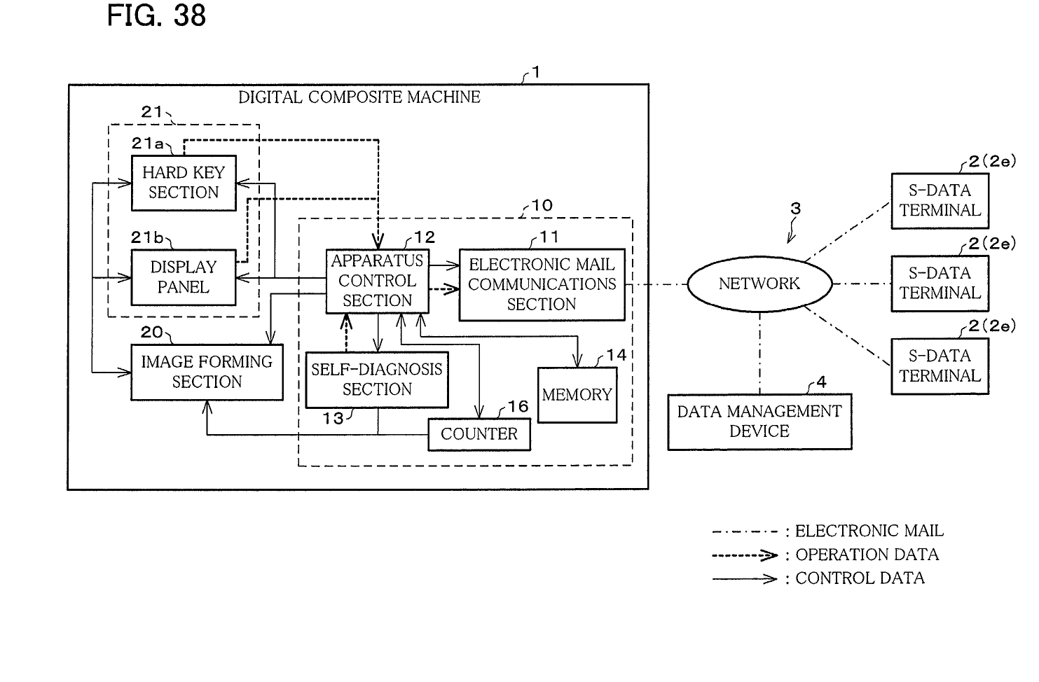

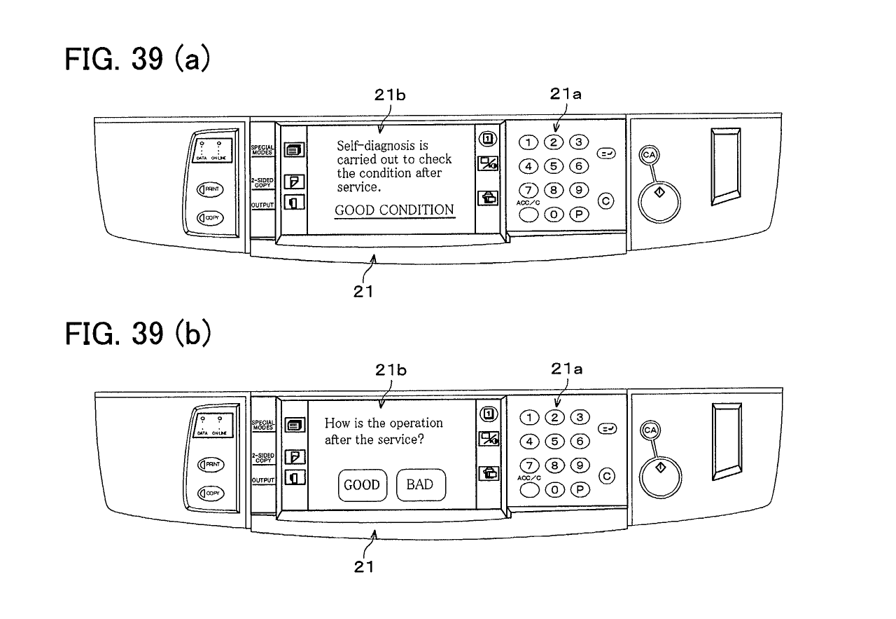

The following descriptions will explain the sixteenth embodiment of the present invention in reference to FIGS. 38 through 39(b). It should be noted however that the present invention is not intended to be limited to the structure of the present embodiment. For ease of explanation, members (structures) having the same functions as those shown in the drawings pertaining to any of the thirteenth through fifteenth embodiments above will be given the same reference symbols, and explanation thereof will be omitted here. The present embodiment has such an arrangement in which those of the thirteenth and fourteenth embodiments are combined together, that is, plural pieces of operation data are prepared.

In short, as shown in FIG. 38, a management system of the present embodiment has the arrangement that is basically identical with that of the fourteenth embodiment shown in FIG. 34, but the operation data is outputted to an apparatus control section 12, not only from a self-diagnosis section 13, but also by a operation panel 21 (see thick dotted-lined arrow in FIG. 38). Note that, other parts of the arrangement are identical with the arrangements of the thirteenth and fourteenth embodiments, thus detailed explanation of the parts is omitted here.

Next, the management system of the management method of the digital composite machine 1 in accordance with the present embodiment will be explained. Firstly, some failure has occurred, and in response, the step \mathring{1} through the step \mathring{3} are performed as in the thirteenth through fifteenth embodiments.

Then, in the step \mathring{4}, the operation data is prepared based on the self-diagnosis and the user's judgement on the service result. For example, as shown in FIG. 39(a), a display panel 21b of the operation panel 21 of the digital composite machine 1, which has been serviced, displays a massage “Self-diagnosis checked the condition after the service. GOOD CONDITION”, thereby indicating the outline of the self-diagnosis result, as Step \mathring{4} of the fourteenth embodiment. Then, as shown in FIG. 39(b), displayed are a message “How is the operation after the service?” and soft keys “Good” and “Bad” on the display panel 21b.

In other words, if the user judges the operation is inadequate while the self-diagnosis result is good, a further service is required. Therefore, when the user presses the soft key of “Bad” so as to prepare the service result to indicate the operation condition is inadequate, the user's judgement takes priority. Therefore, \mathring{5} the service center 200 is notified of the operation data by electronic mail. Note that, the following Steps \mathring{6} and \mathring{7} are same as those of the respective forgoing embodiments.

In this manner, the service center 200 can make more appropriate decision on what to do next, because both the service results prepared by the user's judgement and the self-diagnosis result are used as the operation data.

Noted that, in the above example, the self-diagnosis is carried out first, then the user judges the service result next. But it may be possible to have an inverse order in which the user's judgement is first and the self-diagnosis is second. For example, the soft keys as shown in FIG. 39(b) may be displayed first, then the self-diagnosis result as shown in FIG. 39(a) is displayed next.

In this case, it is preferable that user's judgement for “Bad” service result is surely given priority and the user's judgement is transmitted to the service center 200 as the operation data. On the other hand, even if the user judges the service result is “Good”, the self-diagnosis may find a trouble. In this case, it is preferable that the self-diagnosis result takes priority and is transmitted to the service center 200 as the operation data.

In this way, it is so arranged that, when the user judges the image forming operation is inadequate, the user's judgement is surely given priority, while the self diagnosis result takes priority if the self-diagnosis is inadequate even if the user judges the image forming operation is adequate. The above arrangement of the priority of the operation data further improves the reliability of the service, since a worst case is taken in consideration.

[Seventeenth Embodiment]

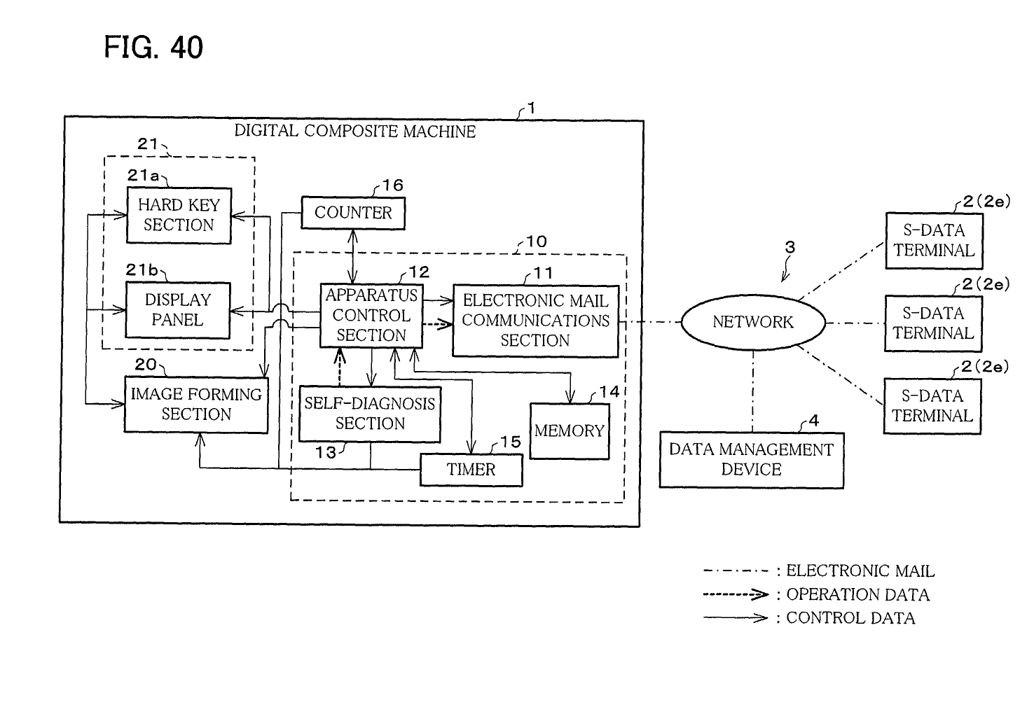

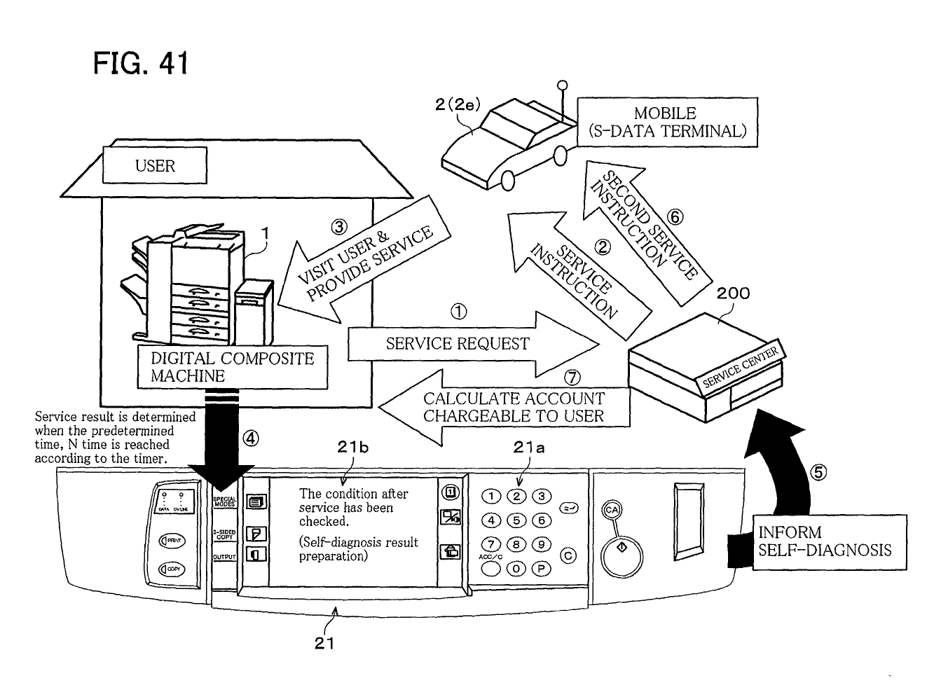

The following descriptions will explain the seventeenth embodiment of the present invention in reference to FIGS. 40 and 41. It should be noted however that the present invention is not intended to be limited to the structure of the present embodiment. For ease of explanation, members (structures) having the same functions as those shown in the drawings pertaining to any of the thirteenth through sixteenth embodiments above will be given the same reference symbols, and explanation thereof will be omitted here.

In the thirteenth through sixteenth embodiments, it is arranged that counter 16 is used to count the predetermined number of times, N job, of the image forming operation as the predetermined specific condition to be used as the reference to tell the timing to prepare the operation data. Meanwhile, the present embodiment uses a time obtained by a timer as the specific condition.

A management system of the present embodiment, as shown in FIG. 40, has an arrangement that is basically identical with that of the fourteenth embodiment shown in FIG. 34, except that a data management communications section 10 is provided with a timer 15 in addition to the counter 16. Note that, since other parts of the arrangement is identical with those of the thirteenth and the fourteenth embodiments, a detailed explanation of them is omitted here.

The timer 15 is for measuring time. Notification of the service result, which is controlled by an apparatus control section 12, is carried out based on the time obtained by the timer 15. In the present embodiment, as the fourteenth embodiment, explained is an example where the data management communications section 10 is provided with a self-diagnosis section 13. Thus, the apparatus control section 12 refers to the time obtained by the timer 15, and decides the timing when the self-diagnosis section 13 carries out self-diagnosis.

The present embodiment may, of course, utilize the timer 15 for deciding timing to display soft keys on a display panel 21b, similarly to the thirteenth embodiment, or may utilize the counting result by the counter 16, together with the time obtained by the timer 15, for timing to carry out the self-diagnosis or the display of the soft keys, similarly to each of the forgoing embodiments.

In the thirteenth through sixteenth embodiments, the number of times of the image forming operation is counted by the counter 16 and a period until the specific number of times, N job, is reached is a period for judging whether the service result is good or bad. Thus, when the counting result x job reaches the predetermined number of times, N job (x=N), the self-diagnosis result is prepared regarding the operation condition of the image forming operation that has been carried out in the period.

However, for example, when the N job is 100 jobs (N=100), a user who photocopies or prints out frequently and/or in a large quantity can achieve the 100 jobs for the counting result x job in a short time so as to make the judgement on the service result. Meanwhile, for example, for a user who makes only one or a few sheets of photocopy or printout each time he uses the digital composite machine 1, or a user who seldom uses the digital composite machine 1, it takes a very long time to achieve the 100 jobs for the x job.

Therefore, the time shown in FIG. 40 is used so as to set the specific period, N time, in advance so that the operation data is prepared at a time when x time, which is time measured by the timer 15, reaches the predetermined N time.

Next, the management system and the management method of the digital composite machine 1 in accordance with the present embodiment will be explained. Firstly, some failure has occurred, and in response, steps \mathring{1} to \mathring{3} are performed, as shown in FIG. 41 as in the thirteenth through fifteenth embodiments.

Then, the image forming operation is resumed after the service for the digital composite machine 1 is completed. When the image forming operation is resumed, the timer 15 starts measuring the time. In this case, predetermined is the N time so that \mathring{4} the self-diagnosis section 13 diagnosis the digital composite machine 1 when the x time measured by the timer 15 reaches the specific N time.

Thereafter, \mathring{5} a service center 200 is notified of the self-diagnosis result as the service result, so that, in accordance with the service result, \mathring{6} the service center 200 instructs a service personnel to redo the service, or \mathring{7} the service center 200 charges a user for the service.

Here, it is preferable that the specific numerical value of the predetermined N time is also changeable, as the predetermined N job. As explained in the thirteenth embodiment, depending how the digital composite machine 1 is used, frequency or a period of the use of the digital composite machine 1 is different. Therefore, it is arranged that the numerical value can be altered depending how the user uses the digital composite machine 1. This further ensures the preparation of the operation data, thereby being able to more promptly deal with the failure.

Note that, in the thirteenth to sixteenth embodiments, \mathring{1} firstly, the digital composite machine 1 requests the service, then \mathring{2} the service center 200 transmits the service instructions to the service personnel so as to provide the service to the digital composite machine 1. However, the present invention may be so arranged as no to include Steps \mathring{1} and \mathring{2}.

In other words, the present invention may have such an arrangement that, when the service request, such as correction, checking, and replacement of consumable supplies, is done by a conventional method, for example, by telephone, Step \mathring{4} the management method by electronic mail is carried out after Step \mathring{3} for providing service or regular check is performed. In short, the present invention may have any arrangement, provided that Step \mathring{4} and steps after Step \mathring{4} are carried out surely in the arrangement.

[Eighteenth Embodiment]

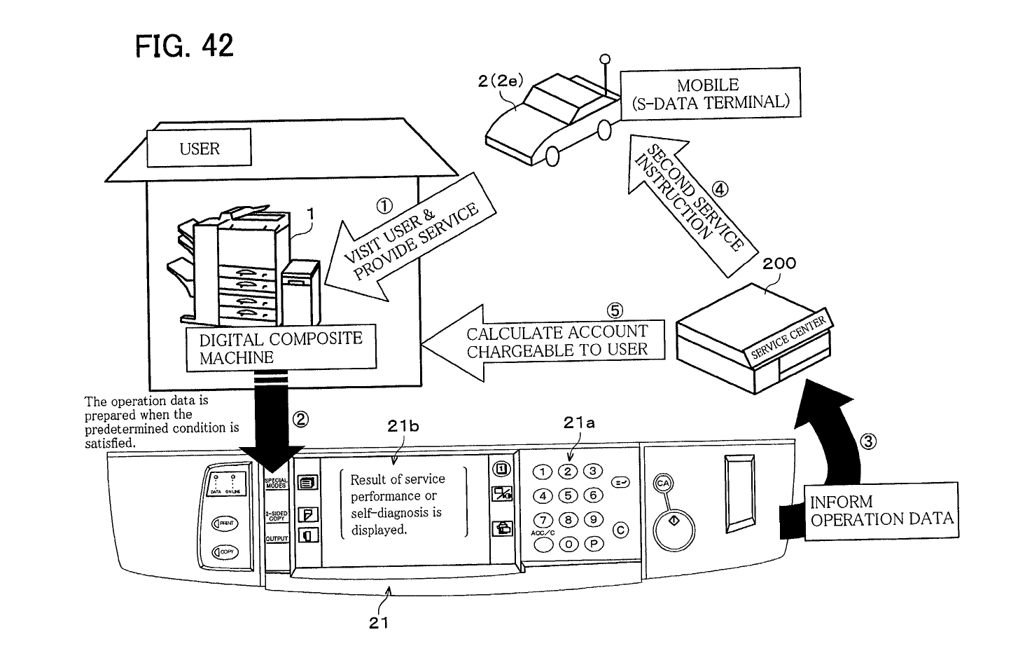

The following descriptions will explain the eighteenth embodiment of the present invention in reference to FIG. 42. It should be noted however that the present invention is not intended to be limited to the structure of the present embodiment. For ease of explanation, members (structures) having the same functions as those shown in the drawings pertaining to any of the thirteenth through seventeenth embodiments above will be given the same reference symbols, and explanation thereof will be omitted here.

On contrary to the thirteenth to seventeenth embodiments where the service center 200 and the service personnel response to the trouble, the present embodiment explain an example where a service center 200 and a service personnel response to a trouble after a service is provided.

A management system of the present embodiment has an arrangement similar to those of the thirteenth to seventeenth embodiments, except that an apparatus control section 12 requests, by electronic mail, the service center 200 to provide a service.

For example, in case of the arrangement provided with the counter 16 as shown in FIG. 32, 34 or 38, the predetermined number of times, N job, is set as the predetermined specific condition. Then, as shown in FIG. 42, \mathring{1} the service personnel visits a user and provides a service. Then, the digital composite machine 1 is used as usual until a counting result of a counter 16, x job, reaches N job (in other words, N sheets of photocopy or printout are made). Here, \mathring{2} automatically, operation data is prepared, and \mathring{3} the service center 200 is notified of the operation data.

Depending how often the digital composite machine 1 is used after the service, the digital composite machine 1 may have various troubles. Therefore, in case of the above arrangement where the counter 16 is used for counting how many times the image forming operation is carried out, the operation data is prepared each N job, and transmitted to the service center 200. In this manner, a regular check is provided to the digital composite machine 1 after the service, thereby more promptly managing a failure.

Moreover, regardless of the frequency of the use, various sections may be deteriorated or become malfunction after the predetermined N time is passed. Therefore, if the timer is provided for measuring the time as the seventeenth embodiment, it may be so arranged that, after the service, the operation data is prepared each time the predetermined N time is passed, so as to be transmitted to the service center 200. This also makes it possible to response more promptly to a trouble.

Note that, omitted here is explanation on Step \mathring{4} for instructing to redo the service, and Step \mathring{5} for charging the user a cost, which are carried out by the service center 200 (a data management device 4), because Steps \mathring{4} and \mathring{5} of the present embodiment are identical with Steps \mathring{6} and \mathring{7} of each of the foregoing embodiments.

Furthermore, even though it is not shown here, in case the self-diagnosis section 13 is provided for making all judgement automatically, as the fourteenth embodiment, in case the image forming operation is carried out in excessively low frequency, the apparatus control section 12 may control that the time measured by the timer 15 is used as a reference so that an image forming section 20 is made to carry out the image forming operation in the predetermined number of times, so as to perform the self-diagnosis.

[Nineteenth Embodiment]

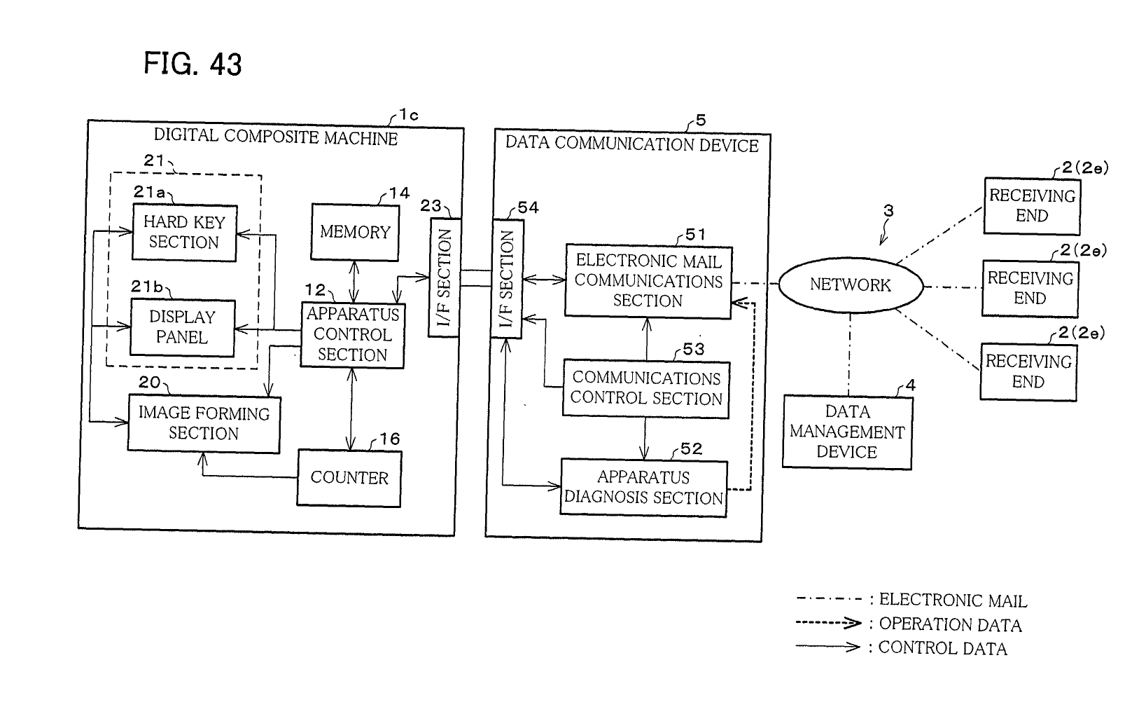

The following descriptions will explain the nineteenth embodiment of the present invention in reference to FIG. 43. It should be noted however that the present invention is not intended to be limited to the structure of the present embodiment. For ease of explanation, members (structures) having the same functions as those shown in the drawings pertaining to any of the thirteenth through eighteenth embodiments above will be given the same reference symbols, and explanation thereof will be omitted here.

While, in the thirteenth through eighteenth embodiments, the digital composite machine 1, as the specific example of the electronic apparatus, includes the self-diagnosis section 13 and the electronic mail management communications section 11 installed inside the digital composite machine 1 (see FIGS. 32, 34, 38 and 40), the present invention is not limited to this. For example, as the present embodiment, another data communications apparatus, which has at least a self-diagnosis function and an electronic mail communication function, is externally attached to a digital composite machine 1c (an electronic apparatus), so that the digital composite machine 1c is provided with data communications means that corresponds to that of the data management communications section 10 (see, for example, FIG. 32).

Specifically, for example, as shown in FIG. 43, a management system of the present embodiment is provided with the data communications device 5, which is externally attached to the digital composite machine 1c, which has no data communication function.

The digital composite machine 1c has an arrangement identical with that of the digital composite machine 1, except that the digital composite machine 1c has no section that corresponds to the data management communications section 10. Specifically, the digital composite machine 1c is provided with an image forming section 20, a operation panel 21 (including a hard key section 21a and a display panel 21b), an apparatus control section 12, a memory 14, a counter 16, other well-known sections, and an interface section (I/F section) 23.

On the other hand, the data management communications device 5 is provided with the electronic mail management communications section (apparatus communications means; notifying means; trouble notifying means) 51, an apparatus diagnosis section (self-diagnosis means; an operation condition checking section; a preparation section; operation data preparation means) 52, a communication control section (control means) 53 and an interface section (I/F section) 54.

The electronic mail management communications section 51 is communications means for transmitting and receiving an electronic mail via a network 3, which is identical with that for the electronic mail management communications section 11. The apparatus diagnosis section 52, which corresponds to the self-diagnosis section 13, diagnoses condition of the digital composite machine 1c so as to prepare a diagnosis result (operation data). The I/F sections 23 and 54 are means for communications between the digital composite machine 1c and the data communications apparatus 5 for various data. The communication control section 53 controls all operation of the data communications apparatus 5, especially for transmitting the diagnosis result (the operation data) to a predetermined receiving end by the electronic mail communications section 51.

Because the I/F section 54 of the data communications device 5 is connected to the I/F section 23 of the digital composite machine 1c, the digital composite machine 1c of the present embodiment has an identical function with that of the digital composite machine 1 that has the self-diagnosis function and the electronic mail communication function, as discussed in the fourteenth embodiment. Note that, the function of the data communication device 5 is specifically identical with those of the thirteenth to eighteenth embodiments. Thus, explanation of the function is omitted here.

The management system for the electronic apparatus of the present invention can be structured with the digital composite machine 1c, merely by externally attaching the data communication device 5 thereto, even though the digital composite machine 1c does not have the self-diagnosis function nor the electronic mail communication function. Therefore, it is possible to expand application of the management system of the present invention, thereby increasing the applicable range of the management system.

In addition, regarding the arrangement where the data communication device 5 is externally attached like the present embodiment, in case a sole user has a plurality of digital composite machines 1c, it is possible to connect a single data communication device 5 with each of the plural digital composite machines 1c (this arrangement is not shown here).

[Twentieth Embodiment]

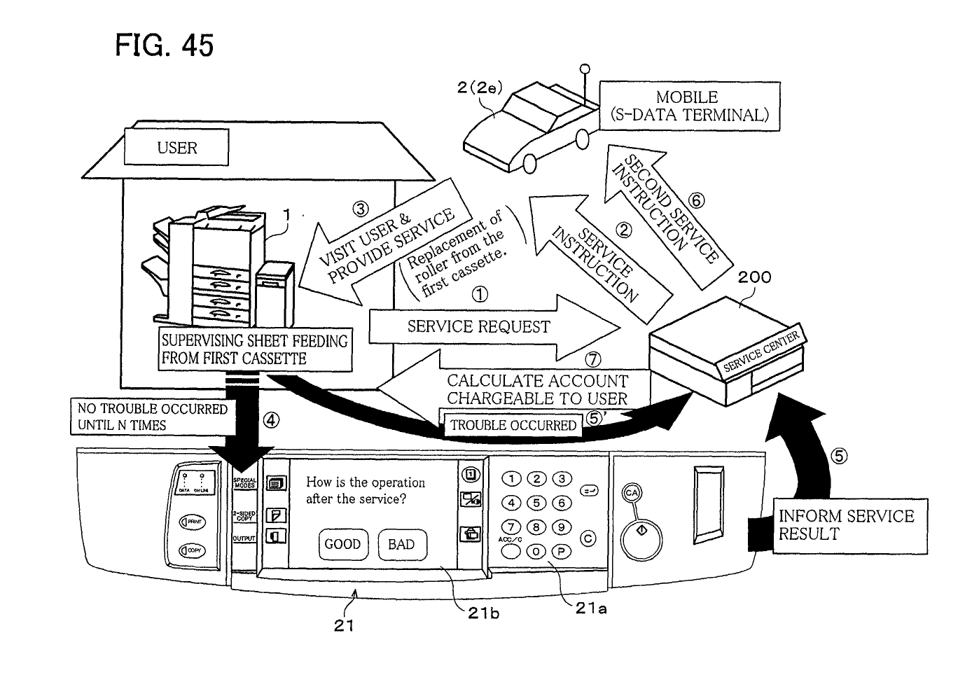

In the respective forgoing embodiments, explained are cases where the operation data is prepared on condition that the image forming operation is carried out in the predetermined number of times, or when the predetermined period of time is passed. On the contrary, in a present embodiment, operation data is prepared on another condition, that is, when a trouble is detected in supervision on the operation condition of a function. The present embodiment is explained below with reference to FIG. 45.

Note that, in the following, explained is a case where a hardware arrangement is substantially identical with that arrangement shown in FIG. 38, while it is also so arranged that a user is asked whether the operation is normal or not when the operation is carried out in the predetermined time after the service, then the user is charged for a cost of the service after it is confirmed that the operation is normal, as in the sixteenth embodiment. However, if a self-diagnosis section 13 is provided, it is also possible to adapt the present embodiment in other arrangements, such as an arrangement where the cost is charged at different timing, and an arrangement where the operation data is prepared only in accordance with the self-diagnosis result, without asking the user about the operation condition.

For example, the self-diagnosis section 13 of the digital composite machine 1 diagnoses, or a user judges that a first cassette of a digital composite machine 1 has paper jam quite often. Then, \mathring{1} the digital composite machine 1 or the user of the digital composite machine 1 requests a service center 200 for a service, as the respective forgoing embodiments. If the digital composite machine 1 spontaneously requests the service, included in an electronic mail are data for a receiving end to specify the receiving end (the digital composite machine 1), a message to specifically explain a type of the trouble “High occurrence of paper jam in the first cassette”, and a message for the service request “Request for checking”. Moreover, if the user requests the service, similar data is given to the service center 200 by telephone or by facsimile.

Meanwhile, \mathring{2} the service center 200, which has been notified of the request for checking, transmits service instructions to an S data terminal 2e carried by a service personnel. The “service instructions” includes data of the user who has sent the request for checking (for example, an address of the user, a type of the digital composite machine 1, and/or an optional unit arrangement), and the type of the trouble. Moreover, the service center 200 also transmits data of parts or goods that requires maintenance (such as a sheet feeding roller), and data of previous services (service history) to the S data terminal 2e, in accordance with the data of the user and the type of the trouble, for the sake of more efficient service. Note that, for example, if there is a database for correlating types of troubles with their causes and solutions, it is also possible to search a trouble similar to the notified trouble in the database, so that the cause and solution of the trouble searched out are given to the S data terminal 2e.

\mathring{2} The service personnel, who has received the service instructions, visits the user who is the receiving end of the request for checking, and \mathring{3} provides the service. Specifically, feeding operation condition of the first cassette is checked so as to identify a part (a section) causing the trouble. If necessary, the part is replaced. For example, if the trouble (high occurrence of the paper jam) is caused by “slipping” due to worn-out of a rubber of the sheet feeding roller, the service personnel replaces a sheet feeding roller mounted on the digital composite machine 1 with new one (a sheet feeding roller) that the service personnel brought with himself. The feeding operation of the first cassette is checked again after the replacement. Further, \mathring{3} the service is completed when it is checked that the trouble is solved.

However, sometimes more than one cause makes a trouble. Therefore, even if one cause is solved and apparently the trouble is solved, there may be another unnoticed trouble. Thus, it is important to continue to supervise the operation of the digital composite machine 1, after the service.

In the present embodiment, the digital composite machine 1 is put under supervision of the self-diagnosis section 13, until predetermined conditions are satisfied so as to judge the operation is normal. If a trouble is detected, the apparatus control section 12 simultaneously instructs the electronic mail management communications section 11 to transmit an electronic mail to the data management device 4 (the service center 200). The electronic mail contains the operation data to tell that the trouble is caused. For example, in case of the above example of trouble, the digital composite machine 1 supervises the feeding operation condition of the first cassette until the number of times of feeding paper from the first cassette reaches a specific value (N number of times). If paper jam is caused, as shown by \mathring{5}═ in FIG. 45, the digital composite machine 1 spontaneously sends a confirmation result, which indicates a trouble found during confirmation of the operation condition by electronic mail. In this way, the service center 200 can grasp the occurrence of the trouble when the trouble is caused. This enables the service center 200 \mathring{6} to take some measures, such as giving another service instructions.

On the contrary, if no trouble is detected until the conditions are satisfied, if necessary, the digital composite machine 1 displays, as shown in FIG. 39(a), a message regarding the operation condition on the display panel 21b, and while asking the user to confirm the operation condition as shown in FIG. 45 (\mathring{4}), then, transmits the confirmation result by the user and the self-diagnosis result by electronic mail (\mathring{5}). On the other hand, if the service center 200 receives user's confirmation result to tell that the operation condition is good, similarly to the respective forgoing embodiments, \mathring{7} a cost of the service is charged to the user. On the other hands, if the user's confirmation result or the self-diagnosis result informs that a trouble (malfunction) is detected, \mathring{6} the service center 200 responses to the trouble, for example, by giving instructions for providing another service.

The digital composite machine 1 of the present embodiment supervises the operation condition of the parts, which has been serviced, until the predetermined conditions are satisfied, after the service, such as the replacement of the parts. If a trouble is detected, the digital composite machine 1 automatically contacts the service center 200. This allows the service center 200 to grasp the occurrence of the trouble when the trouble is caused, and to promptly response to the trouble. Moreover, as object of the supervision, it is necessary to carefully supervise only the parts that have been replaced. Meanwhile, supervision is needed only until the condition for checking the normal operation is satisfied. Therefore, without too much load on the digital composite machine 1, it is possible to supervise the section that tends to have a trouble at that time.

Note that in the present embodiment, similarly to the sixteenth embodiment, the operation data is prepared based on both the user's confirmation and the self-diagnosis result. This improves the judgement to be more accurate, compared with the case where only one of them is used for the judgement.

[Twenty-First Embodiment]

By the way, in the above twentieth embodiment, explained is the example where constant is the condition to indicate when the judgement of the normality of the operation is to be made. On the other hands, in a present embodiment, the condition for making the judgement (for example, the number of times of the operation confirmation) is changed into condition of a trouble, for example, trouble frequency or trouble level, with reference to FIGS. 38, 46 and 47.

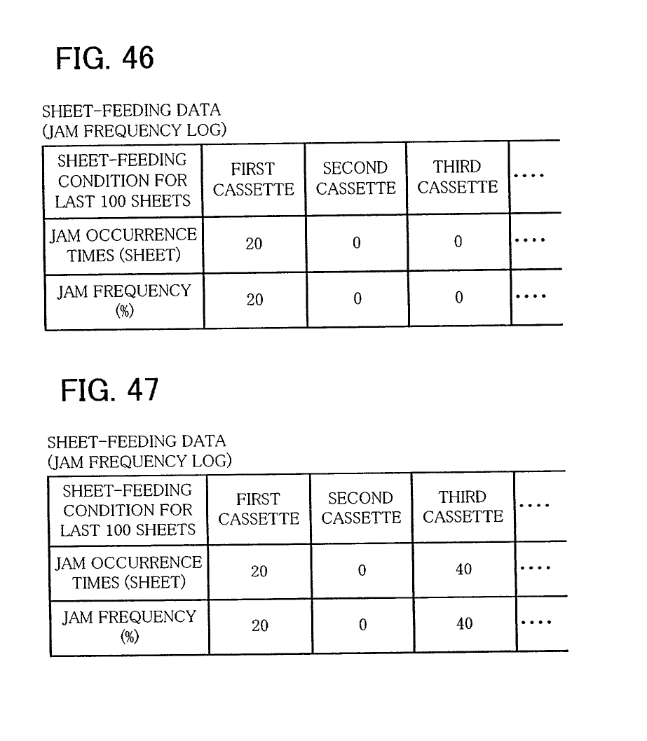

In short, a digital composite machine 1 of the present embodiment uses a memory 14 (shown in FIG. 38) to store data that indicates frequency of occurrence of troubles, such as, sheet-feeding data from each cassette (jam frequency log). In the present embodiment, as shown in FIG. 46, an apparatus control section 12 of the digital composite machine 1 counts, for each cassette, how many sheets are jammed out of 100-sheets that has been fed recently, so as to prepare the jam frequency log. Since the jam frequency log is updated all the time, jam frequency is suddenly increased when suddenly jam is caused more frequently.

Here, the jam frequency is not only a numerical value to show objectively a trouble sensed by a user, but also to indicate how much the user is dissatisfied (dissatisfaction level of the user; a level of a request for checking). Therefore, the jam frequency after a service should be at least lowered from that before the service, otherwise the user does not feel that the trouble has been solved yet, thus confidence and reliability of the service is deteriorated.

To avoid such problems, the digital composite machine 1 of the present embodiment refers to the jam frequency log stored in the memory 14, so as to decide how long the operation condition is supervised, in accordance with the jam frequency log. In this way, a length of a period of the supervision is so set that a trouble would occur during the period of supervision if the frequency of the trouble is at the same level as the frequency of the trouble at the time when the instructions for checking are issued.

Specifically, as shown in FIG. 46, in case where the jam frequency is 20% according to data stored in the memory 14 when the checking is requested, it means that one out of five sheets are jammed. Therefore, after the service, the supervision for the jam occurrence is carried out while five sheets are fed. If no jam is caused during the period, it is assumed that the frequency is improved.

In the present embodiment, considering a case where the frequency happens to be low during the period of the supervision, the period of the supervision is so set, just in case, to supervise the feeding of sheets until such a number of sheets are fed, the number of which is calculated by multiplying the frequency by a predetermined ratio (for example, 10 times) in accordance with the frequency. In the above example, because the log in the memory 14 says the frequency is one out of five sheets, a self-diagnosis section 13 supervises the feeding of sheets for jam occurrence until 50 sheets are fed.

This allows a service center 200 to surely detect the trouble if the trouble is caused at the frequency at the time the checking is requested. As a result, if the service fails to lower the frequency, the service center 200 is able to respond to the problem, for example, by redoing the service, without bothering the user. This can prevent the confidence and reliability of the service from being deteriorated.

In addition, it is preferable that apparatuses of a service provider, such as the service center 200 or an S-data terminals 2e, stores the frequency of failure (the jam frequency log) at the time when the checking is requested. By doing so, the service center 200 is enabled to indicate the user of the requesting end of checking that a failure has not occurred in the period of supervision and the frequency of an occurrence of failure at the time the checking is requested. Because the conditions (frequencies) of the failure before and after the service can be presented objectively, it is possible to confidently explain the concrete effect of service. This realizes a management system that can win confidence and reliability of the user.

By the way, in case the period during which the operation is supervised, as in the twentieth and twenty-first embodiments, if service is provided to solve more than one failure at once, each failure is supervised in a different period of time. Thus, the periods of supervision for the respective failures end at different time.

Shown in FIG. 47 is an example where jam frequently happens in two cassettes (for example, a first cassette and a third cassette), and a service is requested for both the first and third cassettes. In this case, if how many times the operation is carried out (how many sheets are fed) for confirming the result of the service is set in the same manner as above, 50 sheets for the first cassettes and 25 sheets for third cassettes are to be fed until the result of the service is confirmed. Therefore, the supervision for the first cassette is ended when the first cassette feeds 50 sheets, while that for the third cassette is finished when the third cassette feeds 25 sheets.

In this case, as a comparative example, if the digital composite machine 1 sends to the service center 200 the results respectively at each end of the period of the supervision, it is impossible for the service center 200 to judge whether each of the services are completed normally, when only one of the confirmation result is received. Thus, the service center cannot charge costs of the service at the time. Moreover, because some of the troubles are caused by plural factors (parts or units) that interrelate each other, only one of the confirmation results is not enough for making the judgement. Especially, when the service result is reported with reference to the judgement input by the user, it is necessary to ask the user to give instructions at each end of the periods of supervision. Thus, more operation by the user is required.

On the contrary, in case plural supervision periods are set, the digital composite machine 1 of the present invention inquires the user when all the supervision periods are ended, while transmitting to the service center 200 the service result including the results of the inquiry and the self-diagnosis results for the respective parts under supervision. Because the digital composite machine 1 reports, in this way, all the results together (at once) when all the results are obtained, the service center 200 can make a judgement the service result as a whole. For example, it is possible to perform effectively and promptly the next steps, such as instructing to redo the service or charging. In addition, in the present embodiment, because the service center 200 is notified of the trouble when the trouble occurs, even if a service result regarding a certain function is reported later, it is possible to promptly respond to the trouble.

[Twenty-Second Embodiment]

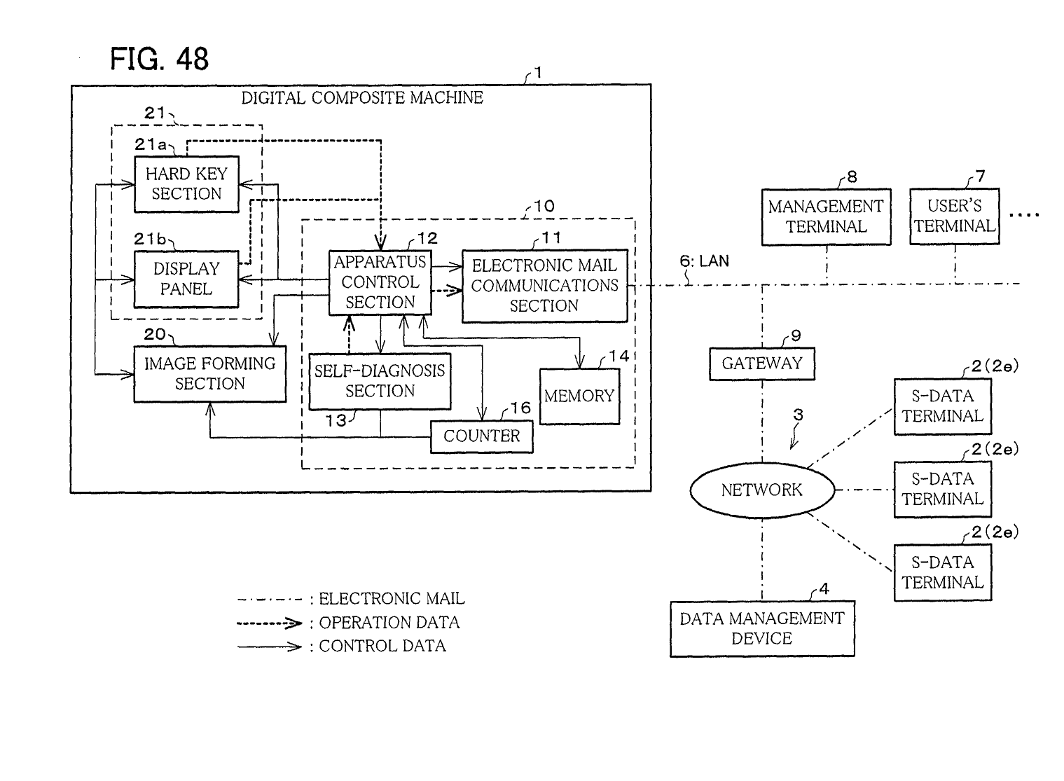

In the thirteenth through twenty-first embodiments, the explanations have been given through the case where the digital composite machine 1 transmits the operation data to the data management device 4 (service center 200) for managing the maintenance of the parts or units that cause trouble. In a present embodiment, however, explanations will be given through the case where a plurality of receiving ends of the operation data can be set and a receiving end can be changed (added) depending on a failed state even for a part or unit subjected to the failure is the same in an example where the digital composite machine 1 having mounted thereto a printer board 101 is used as a network printer in reference to FIG. 48.

In short, where the digital composite machine 1 is used as the network printer, the digital composite machine 1 is connected, as shown in FIG. 48, with a user's terminal 7 and a management terminal 8 via a local area network (LAN) 6 such as Ethernet (registered trade mark). The user's terminal 7 and the management terminal 8 are, for example, computers such as personal computers. The user's terminal 7 is used by a user (ordinary user) who uses the network printer (the digital composite machine 1). On the other hands, the management terminal 8 is a terminal used by a manager who manages the LAN 6. The manager 8 uses the management terminal 8 to perform network setting such as setting an address of each apparatus in the LAN 6. In addition, the LAN 6 is also connected with a gateway 9. The apparatuses in the LAN 6, such as the digital composite machine 1, can communicates with the data management device 4 via (service center 200) the gateway 9 and a network 3, which is another network.

In the above system in which the digital composite machine 1 and another machines (the user's terminal 7) communicate each other and operate, a trouble of the digital composite machine 1 may have a cause in the user's terminal 7 or the LAN 6, besides the digital composite machine 1 itself. Meanwhile, the manager is more familiar with apparatuses used in the LAN 6, compared with ordinary users, and may be able to solve the trouble without contacting the service center 200.

For example, in case the digital composite machine 1 does not detect the printer board 101, there are some cases where the service center 200 should respond, such as breakdown or improper installation of the printer board 101, while there are other cases in which the manager of the LAN 6 should respond, such as inadequate network setting. Moreover, in case a function which has not expanded yet is set in a printer driver of the user's terminal 7, it is desirable that the user, or the manager, who can give instructions to the user, deals with the trouble, instead of the service center 200, because the printer configuration is mistakenly set by improper operation of the user. On the other hands, in case data processing is not possible due to overcapacity of the memory 14, there are some cases where the service center 200 should respond to the trouble, such as a case the digital composite machine 1 is provided with a memory not having enough capacity for the printing process, while there are other cases that the user or the manager who can advise the user should respond to the trouble, such as a case where an output instruction data from the user's terminal 7 is extraordinarily large, or a case where a character impossible to output is requested for the printing out.

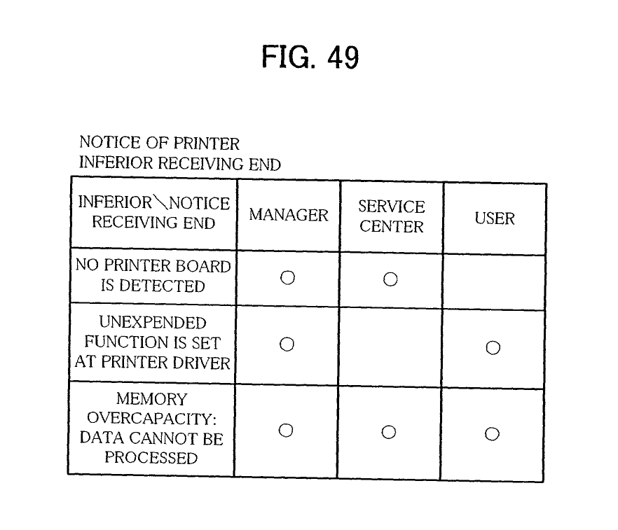

The digital composite machine 1 of the present embodiment, as shown in FIG. 49, stores in the memory 14 shown in FIG. 38 a table for response in which descriptions of troubles are corresponded to receiving ends. Thus, in case the self-diagnosis section 13 detects a trouble, the apparatus control section 12 refers to the memory 14, and controls the electronic mail communications section 11 accordingly to send an electronic mail, which contains the operation data, to a right receiving end for solving the trouble. In this way, the digital composite machine 1 transmits the operation data to the receiving end, thereby dealing with a failure timely and effectively.

For example, in case the digital composite machine 1 detects such a trouble “No printer board 101 is detected”, the digital composite machine 1 refers to the memory 14 and notifies of the trouble the management terminal 8 and the data management device 4 (the service center 200). In this way, the service center 200 checks whether the printer board 101 is broken down or not, or improperly installed or not, for example by dispatching a service personnel again, while the manager of the LAN 6 checks the network setting of the LAN 6. On the other hand, in case detected is such a trouble that “A function which has not expanded yet is set in a printer driver of the user's terminal 7”, the digital composite machine 1 transmits the operation data to the management terminal 8 and the user's terminal 7. In this way, the user checks the printer driver of the user's terminal by himself or in accordance with advice given by the manager, so as to properly set the printer configuration of the printer driver. Furthermore, in case detected is such a trouble that “Data cannot be processed due to the overcapacity of the memory”, the digital composite machine 1 transmits the operation data to the user's terminal 7, the management terminal 8, and the service center 200. In this way, the service center 200 (a) refers to a database in which a history of the service is stored, (b) checks the digital composite machine 1 via a network 3, or (c) checks the memory capacity in case the operation data includes data about the memory capacity, so as to check whether the memory capacity of the memory 14 provided in the digital composite machine 1 is large enough or not if the memory capacity is not enough, the service center 200 can increase the memory capacity of the memory 14 of the digital composite machine 1, for example, by dispatching a service personnel. Moreover, in accordance with his own precaution or the advice given by the manager, the user can be careful not to give the digital composite machine 1 instructions to output improper data (data that cannot be outputted by the digital composite machine 1), or extraordinarily large data, when the user operates the user's terminal 7.

Furthermore, the digital composite machine 1 of the present embodiment sends the receiving end, who is contacted when the trouble is detected, the operation confirmation result after the trouble is solved. In this way, each receiving end can choose the next step promptly and accordingly. For example, if the manager cannot respond to a trouble, the manager can contact the service center 200 for requesting the service, or if the operation of serviced parts is proved to be normal, the service center 200 charges the cost.

[Twenty-Third Embodiment]

By the way, for an electronic apparatus, for example a digital composite 1, which is able to expand its function by an optional unit attached thereto, attaching of the unit gives the electronic apparatus another function associated with the unit. In the present embodiment, explained is an arrangement whether operation data is transmitted when a unit is added, in addition to or instead of the arrangement in which the operation data is transmitted after the provision of the services, such as the renewal of the units or parts.

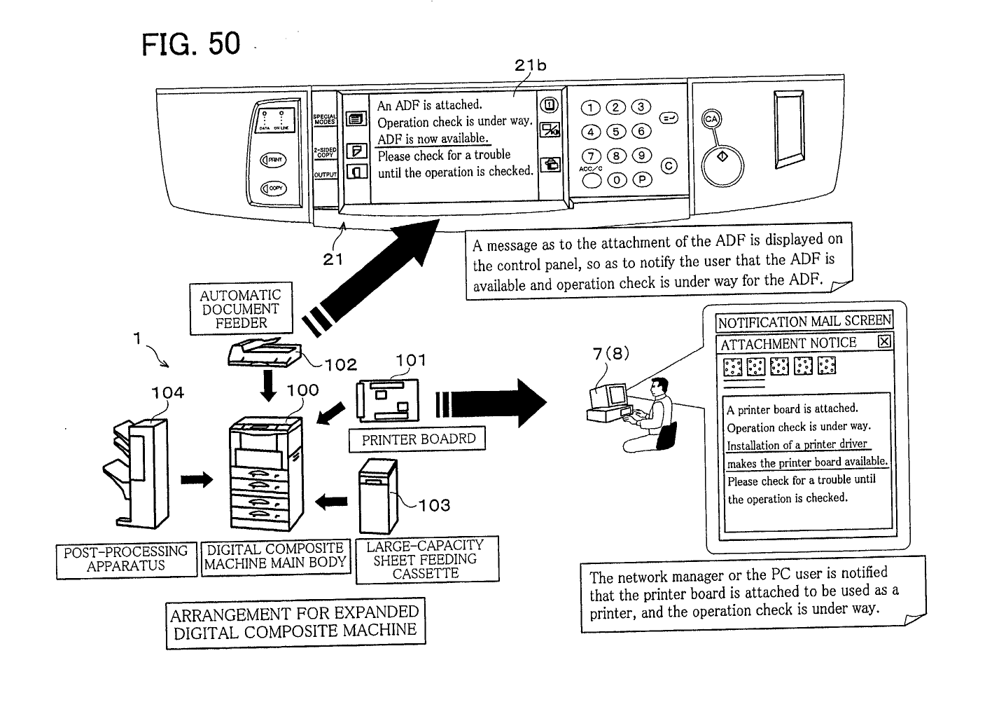

As shown in FIG. 50, as units attachable to the digital composite machine main body 100 to expand functions thereof, a digital composite machine 1 of the present embodiment is provided with a printer board 101, an automatic document feeder (ADF) 102, a large-capacity sheet feeding cassette 103, and a post-processing apparatus 104. The printer board 101 permits to print out a digital document (data) transmitted from a personnel computer such as the user's terminal 7 discussed above via an LAM 6 or a serial interface. The automatic document feeder 102 can automatically feed the document. The large-capacity sheet feeding cassette 103 can load a larger quantity of printing paper than the digital composite machine main body 100. The post-processing apparatus 104 carried out offset process of the outputted sheet or bookbinding process such as stapling.

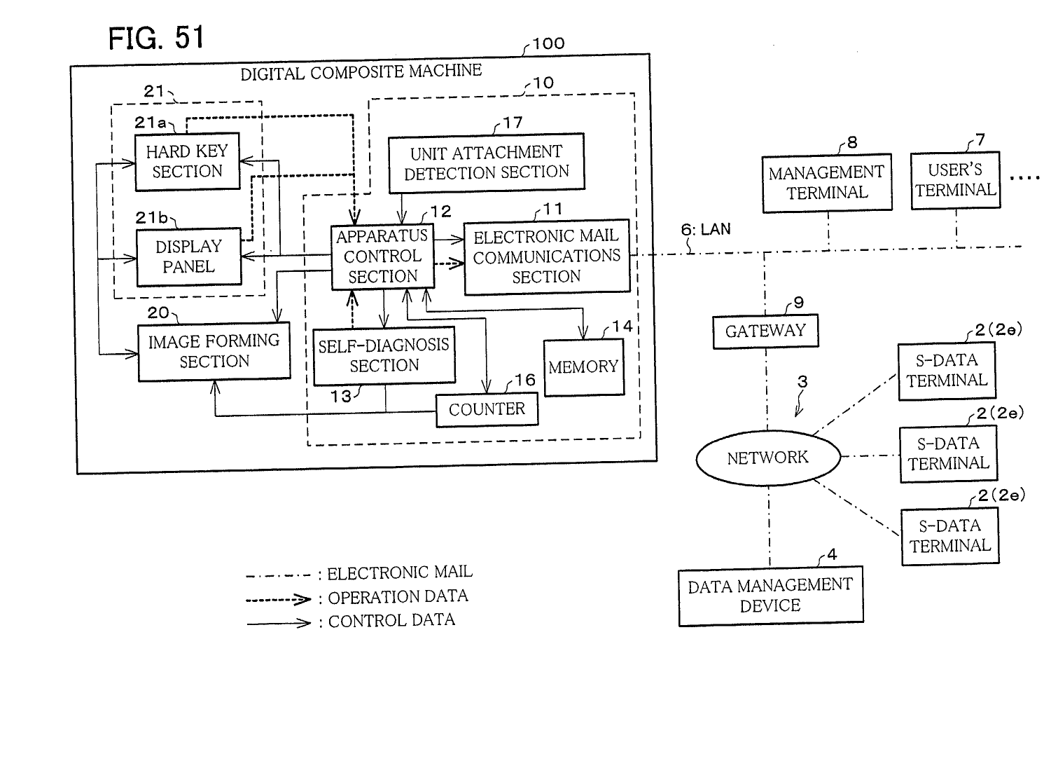

Meanwhile, the digital composite machine main body 100 l of the present embodiment is provided with, in addition to the arrangement of the digital composite machine 1 of any one of the respective forgoing embodiments, a unit attachment detection section (detecting means) 17, which detects whether an optional unit is attached or not, as shown in FIG. 51. Moreover, a memory 14 stores the receiving ends so that a right receiving end is contacted for each unit that has been attached.

In addition, FIG. 51 shows an example where the unit attachment detection section 17 is provided to the digital composite machine 1 of the twenty-first embodiment (see FIG. 38). Moreover, in case of the arrangement shown in FIG. 43, it is possible to provide the unit attachment detection section 17 in either of the digital composite machine 1c and the data communication device 5. Meanwhile, in case of the arrangement shown in FIG. 51, it is also possible to provide the unit attachment detection section 17 partially in both the digital composite machine 1c and the data communication device 5 so that the both of the digital composite machine 1c and the data communication device 5 communicate each other via the I/F sections 23 and 54 so as to cooperate, thereby realizing the unit attachment detection section 17.

In the above arrangement, when the unit attachment detection section 17 detects that a unit is attached, an apparatus control section 12 refers to the memory 14, and accordingly transmits operation data to a receiving end that is suitable for the unit attached thereto.

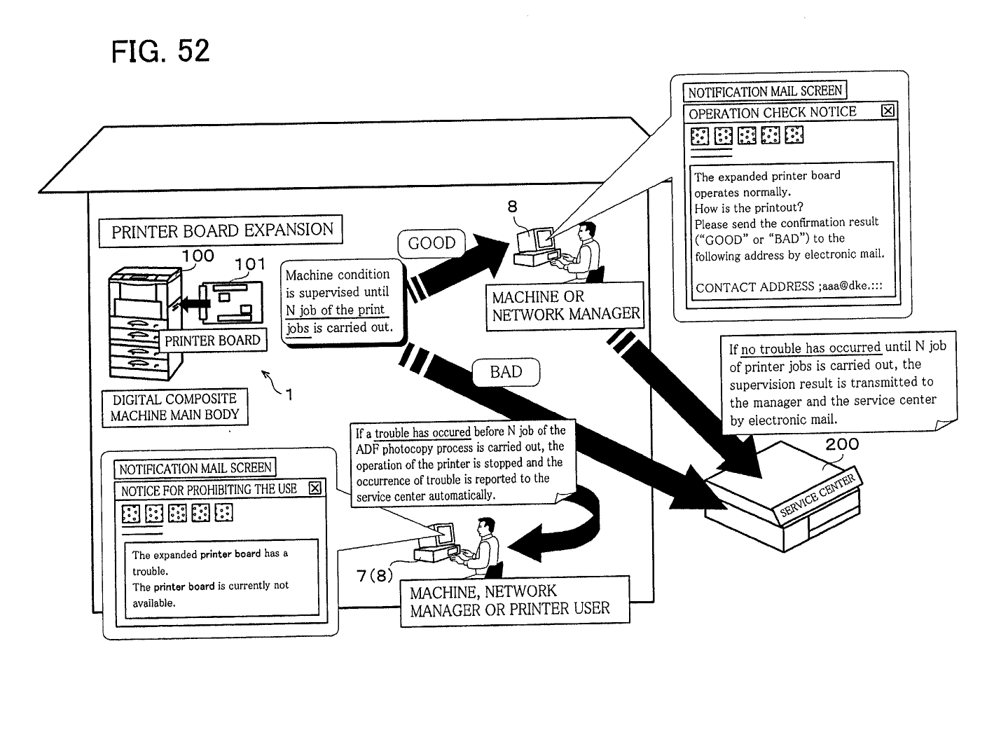

FIG. 52 shows an example, in which the unit attachment detection section 17 provided in the digital composite machine main body 100, detects attachment of the printer board 101 when the printer board 101 is attached to the digital composite machine main body 100. Consequently, the apparatus control section 12 reads out the receiving end for the printer board 101. The memory 14 of the present embodiment says that a user of the printer board 101 is the receiving end for the printer board 101. In this case, the apparatus control section 12 instructs an electronic mail communications section 11 to transmit an electronic mail to each user of the printer board 101, so as to inform the respective users of operation condition that the digital composite machine 1 can be used as a printer.

On the other hands, the users, who receives the notice, installs a printer driver into their user's terminal 7. In this way, the user's terminal 7 can utilize the digital composite machine 1 as a network printer.

Thereafter, the digital composite machine main body 100 supervises operation condition of the unit that has been attached thereto until satisfied is a condition set for judging that the operation of the unit is normal (for example, until the operation is carried out in a predetermined number of times), similarly to the case where the parts are renewed. Here, if a trouble is detected during the supervision period, for example, by referring to the memory 14, the apparatus control section 12 of the digital composite machine main body 100 learns a predetermined receiving ends as a receiving ends for that kind of trouble, such as a service center 200 or a management terminal 8 or the user's terminal 7. Meanwhile, the apparatus control section 12 instructs the electronic mail communications section 11 to transmit the receiving end an electronic mail that includes the operation data.

Upon receipt of the operation data, the service center 200 performs such services as instructing an S-data terminal 2e to provide services, thus dispatching a service personnel, or advising the user the process of correcting the failure. Meanwhile, when the management terminal 8 receives the operation data, the manager checks the network setting of the LAN 6 in accordance with the operation data, so as to solve the trouble, for example, by correcting an inadequate part of the network setting. Furthermore, when the user's terminal 7 receives the operation data, and the user is notified of the trouble in the unit, the user deals with the trouble, by cancelling the printout, or by using another printer to print out.

Moreover, if the trouble is detected, or if normal operation cannot be detected after the attachment of the unit, it is preferable that the control section 12 of the digital composite machine main body 100 stops the operation of the unit forcibly, by instructing the unit to stop its operation, or by stopping the instructions to operate the unit. In this case, it is possible to avoid that the unit having the trouble is operated until a consecutive trouble, such as further worsening the damage of the unit, is caused.

Here, in case the digital composite machine 1 is used as the network printer, assistance of the manager of the LAN 6 is indispensable for operating the network printer properly, because the network printer is largely affected by the setting of the network (the LAN 6). In most cases, the manager can solve the trouble associated with the network printer. In this case, it is possible to register only the management terminal 8 as the receiving end. Meanwhile, in case where requesting the service center 200 for a service costs the user, it is preferable that the digital composite machine main body 100 be arranged such that before transmitting the operation data to the service center 200 for the service request, a display is made on the display panel 21b to urge the user to input to confirm if the service is to be requested, and based on the input made on the operation panel 21, it is determined if a service is to be requested to the service center 200.

Furthermore, when the trouble is solved by renewing the printer board 101, or by correcting the network setting, as a result of the service or the response by the manager, the digital composite machine main body 100 transmits an electronic mail to notify the users of the network printer that the digital composite machine 1 can be used as a printer.

On the contrary, in case no trouble is detected during the supervision period, the control section 12 asks the user whether there is any trouble or not, by means of a display shown on a display panel 21b. When an answer as to whether there is any trouble or not is input into the operation panel 21, the control section 12 prepares operation data in accordance with a self-diagnosis result of the self-diagnosis performed by the self-diagnosis section 13 and the answer input by the user, so as to send the operation data, by controlling the electronic mail communications section 11, to a predetermined receiving end for a time when normal operation is confirmed. An example for such predetermined receiving end is the service center 200. In this way, the service center 200 can grasp that the printer board 101 is attached to the digital composite machine main body 100, and operates normally. Moreover, in case the user request a service of the digital composite machine main body 100 thereafter, the service center 200 can decide how to deal with the trouble for which the service is requested, considering the fact that the service center 200 has received a report that the printer board 101 operates normally.

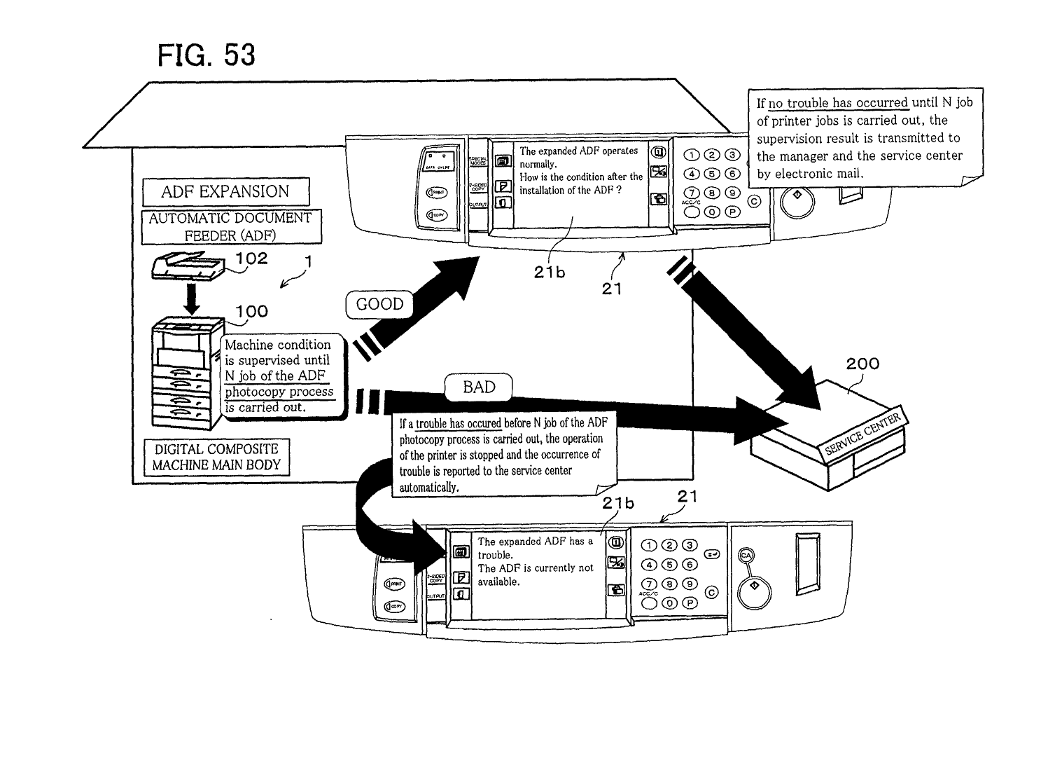

On the other hands, as shown in FIG. 53, if the digital composite machine main body 100 is provided with the automatic document feeder 102, the digital composite machine 1 is able to automatically feed the sheet, thereby, for example, automatically replacing the sheet when making a photocopy. Here, it is assumed that a user of the automatic document feeder 102 goes to where the digital composite machine main body 100 is located, in order to operate the digital composite machine main body 100, on contrary to the case the digital composite machine 1 operates as the network printer. Therefore, the control section of the digital composite machine main body 100 refers to the memory 14, and displays on the display panel 21b a message that the automatic document feeder 102 is available, as a notice to the user of the automatic document feeder 102.

In this case, after the automatic document feeder 102 is attached, a first user to use the digital composite machine 1 checks the display panel 21b of the digital composite machine main body 100, and operates, for example, the operation panel 21, so as to set various copy functions. Here, when the automatic document feeder 102 is attached, the digital composite machine main body 100 displays on the display panel 21b a message indicating that the automatic document feeder 102 is available. Therefore, the user can be informed that the digital composite machine 1 has a new function, by looking at the display panel 21b. In addition, the transmission is carried out in the same manner as the case where the printer board 101 is attached, when the operation data is transmitted in case of the trouble or in case of the end of the supervision period.

Note that, while the foregoing embodiments, including the present embodiment, uses the digital composite machine (the image forming apparatus) as the example of the electronic apparatus, the present invention is, of course, not limited to that example. As the electronic apparatus, a personnel computer can be another example. Alternatively, if various machines used in private or in business are electronically controlled, and are able to be connected to the Internet, it is possible to sufficiently employ the management system for the electronic apparatus of the present invention.

As other example of the electronic apparatus, for example, an automatic vending machine may be adopted. The automatic vending machine demands for delicate services for the periodic maintenance, the trouble occurred as in the case of the image forming apparatus. Furthermore, a failure which possibly occurs in the automatic vending machine is also not limited to a few types, i.e., an unexpected failure is possible to occur. Therefore, by adopting management system of an electronic apparatus of the present invention, it becomes possible for a vender who sells merchandise by an automatic vending machine to provide most delicate services with minimum support for correcting various failures or various maintenance operations.

In the fifth through twenty-third embodiments, each member which constitutes the data management device 4 may be a functional block which is realized by executing a program stored in a recording medium such as ROM, RAM, etc., by arithmetic processing means such as CPU, or a hardware which performs similar process. The data management device 4 may be constituted by a hardware which performs a part of the process in combination of the arithmetic processing means which performs a control of the hardware or executes the program for the remaining process. Further, the arithmetic means may be a single unit, or plural units connected via bus lines in the apparatus or various communication paths.

The above program is executed by the arithmetic means by storing the program itself or the data for use in preparing the program, and proving the recording medium, or transmitting the program data by cable or wireless communications means.

The recording medium for providing the program data is preferably detachable; however, whether or nor the recording medium after providing the program data is detachable does not matter. As long as the program data is stored in the recording medium, whether or not rewritable, volatile, or the recording method, the shape of the recording medium does not matter. Examples of the recording medium includes a tape such as a magnetic tape, a cassette tape, etc., a magnetic disk such as a floppy disk, a hard disk, etc., CD-ROM, a magneto-optical disk (MO), a minidisk (MD), a digital video disk (DVD), etc. The recording medium may be a card such as IC card, optical card, etc., or a semiconductor memory such as a mask ROM, EPROM, EEROM or a flash ROM, etc.

The program data may be codes for instructing all the steps for each of the above processes to the arithmetic processing means, or may be arranged so as to replace a part or the entire steps by codes or the pointer for instructing the arithmetic means to read out the basic program provided that the basic program which can execute a part of all of the above processes is provided, such as an operation system or library.

The program data may be stored in the recording medium so that the arithmetic processing means can access and execute the program, such as real memory. Or the program data may be stored in the format before being stored in the real memory and after being installed in a local recording medium (for example, the real memory, the hard disk, etc.) to which the arithmetic processing means can always access, or in the format before being installed in the local recording medium from a network or a transportable recording medium, etc. The program data is not limited to a corresponding code after being compiled, and may be stored as a source code, or an intermediate code to be prepared in the process of being interpreted or compiled, etc. Namely, as long as the program data can be converted in the format executable by the arithmetic means by combining such process as decompression, decoding, interpretation, compile, linkage, or recording in the real memory, the same effects of the present invention can be expected irrespectively of the format of storing the program data in the recording medium.

As described, a management method of an electronic apparatus for an electronic apparatus (1, 1c, 100) which has a specific function, and which is connected to a predetermined receiving end (2, 2a to 2f, 4, 7, 8, 200) via a network (3, 6) so that data can be transmitted to the receiving end by electronic mail, the management method is arranged so as to include the steps of:

(i) preparing operation data indicative of an operation state of the electronic apparatus with respect to which a service has been provided, after resuming the specific function; and

(ii) transmitting the operation data to the predetermined receiving end.

According to the foregoing method, the operation data is transmitted to the predetermined receiving end, and based on which, it is determined if the service is to be provided again. It is therefore possible to confirm if a service provided with respect to the electronic apparatus is appropriate whenever a service is provided. Therefore, by selecting a manager who manages the electronic apparatus as the predetermined receiving end, it becomes possible to always deal with a failure, if occurred, in an appropriate manner on the side of the manager. As a result, an improved service for the maintenance of the electronic apparatus can be provided by more surely managing the operation state of the electronic apparatus.

The electronic apparatus (1, 1c, 100) of the present invention which has a specific function is arranged so as to include:

an apparatus communications section (11, 51) for transmitting an electronic mail to a predetermined receiving end (2, 2a to 2f, 4, 7, 8, 200) connected to the electronic apparatus via a network (3, 6);

an operation data preparation section (13, 21, 52), which includes a) an operation state checking section (13, 21, 52) for checking an operation state of the specific function of the electronic apparatus with respect to which a service has been provided, and b) an operation data preparation section (13, 21, 52) for preparing operation data indicative of the operation state that has been checked by the operation state checking section; and

a control section (12, 53) for controlling the operation data preparation section so as to prepare the operation data after resuming the specific function of the electronic apparatus with respect to which a service has been provided, and for controlling the apparatus communications section so as to transmit the operation data to the predetermined receiving end.

With the above arrangement, after resuming the specific function of the electronic apparatus with respect to which the service has been provided, the operation data preparation section prepares the operation data, and by the control section, the operation data is transmitted to the predetermined receiving end by the control section by electronic mail. Therefore, by selecting the manager, who manages the electric apparatus (the service center, the service personnel) is set as the receiving end of the operation data, it is possible to check more reliably if the specific function has been corrected completely by the service provided with respect to the electronic apparatus, and if more appropriate service could have been provided. Further, in an event of an occurrence of some failure even after providing the service as required, by correcting the failure promptly, it is possible to manage the electronic apparatus appropriately with improved service.

Instead of transmitting the operation data of the electronic apparatus with respect to which the service has been provided after resuming the specific function, it may be arranged so as to transmit the operation data after an exchangeable part has been replaced. Specifically, the management method of an electronic apparatus which is connected to the predetermined end (2, 2a to 2f, 4, 7, 8, 200) via the network (3, 6), and is capable of transmitting data to the receiving end by electronic mail may be arranged so as to include the steps of:

preparing operation data indicative of the operation state of a specific function after an exchangeable part has been replaced; and

transmitting the operation data to the predetermined receiving end.

As described, an electronic apparatus (1, 1c, 100) of the present invention which includes an apparatus communications section (11, 51) for transmitting an electronic mail to a predetermined receiving end (2, 2a to 2f, 4, 7, 8, 200) connected to the apparatus communications section via a network (3, 6), is arranged so as to further include:

an operation data preparation section (13, 21, 52), which includes a) an operation state checking section (13, 21, 52) for checking an operation state of the specific function of an exchangeable part of the electronic apparatus after the replacement of the exchangeable part, and b) an operation data preparation section (13, 21, 52) for preparing operation data indicative of the operation state that has been checked by the operation state checking section; and

a control section (12, 53) for controlling the operation data preparation section so as to prepare the operation data after resuming the specific function of the electronic apparatus with respect to which a service has been provided, and for controlling the apparatus communications section so as to transmit the operation data to the predetermined receiving end.

With the above arrangement, as in the above management method of an electronic apparatus, and an electronic apparatus, after resuming the function (the specific function) of the exchangeable part which has been replaced, the operation data preparation section prepares the operation data, and by the control section, the operation data is transmitted to the predetermined receiving end by the control section by electronic mail. Therefore, by selecting the manager, who manages the electric apparatus (the service center, the service personnel) is set as the receiving end of the operation data, it is possible to check accurately if the specific function has been corrected completely by the service provided with respect to the electronic apparatus, and if more appropriate service could have been provided. Further, in an event of an occurrence of some failure even after providing the service as required, by correcting the failure promptly, it is possible to manage the electronic apparatus appropriately with improved service.

Further, it may be arranged so as to transmit the operation data after resuming the operation using the function of a detachable unit which has been installed in the apparatus, instead of preparing after the replacement of the exchangeable part. Specifically, the management method of the electronic apparatus (1, 1c, 100) of the present invention for an electronic apparatus, which is capable of expanding its function by an optional unit (101 to 104) attached to the electronic apparatus, and which is connected to a predetermined receiving end (2, 4, 7, 8, 200) via a network (3, 6) so that data can be transmitted to the receiving end by the electronic mail may be arranged so as to include the step of after the installation of the unit is detected and the function of the unit installed is started, preparing operation data indicative of operation data of the function; and transmitting the operation data to the predetermined receiving end.

As discussed above, an electronic apparatus (1, 1c, 100) of the present invention, which is capable of expanding its function by an optional unit (101 to 104) attached to the electronic apparatus, is arranged so as to include:

an apparatus communications section (11, 51) for transmitting an electronic mail to a predetermined receiving end (2, 2a to 2f, 4, 7, 8, 200) connected to the apparatus communications section via a network (3, 6);

a detecting section (17) for detecting the attachment of the unit;

an operation data preparation section (13, 21, 52), including \mathring{1} an operation condition checking section (13, 21, 52) for checking operation condition of, as a specific function, a function of the unit, which has been attached, and \mathring{2} a preparation section (13, 21, 52) for preparing operation data that indicates the operation condition that has been checked by the operation condition checking section; and

a control section (12, 53) for controlling the operation data preparation section so as to prepare the operation data after the attachment of the unit is detected and operation of the specific function is resumed, and for controlling the apparatus communications section so as to transmit the operation data to the predetermined receiving end.

With the above arrangement, similarly to the electronic apparatuses discussed previously, after the operation of the function (the specific function) expanded by the unit is resumed after the unit is attached, the operation data, which indicates the operation of the function is transmitted to the predetermined receiving end by electronic mail. Therefore, if the management personnel, who manages the electric apparatus (such as the service center or the service personnel), is set as the receiving end for the operation data, it is possible to surely check whether the function expanded by the unit is fully workable. Moreover, it is also possible to promptly response to a trouble, if any after the attachment of the unit, thereby providing improved services.

Meanwhile, when the user of the specific function is set as the receiving end, it is possible to use electronic mail to notify the user that the specific function is available. In this way, it is possible to notify timely the user that the specific function of the electronic apparatus is expanded, thereby effectively encouraging the user to use the specific function. Moreover, it is expected that a trouble can be early detected because the user consciously checks for the trouble.

In addition to the above arrangements, the electronic apparatus of the present invention may be further arranged that:

the detecting section is capable of detecting a replaced unit among the units that have been attached;

the operation data preparation section prepares the operation data that indicates the operation condition of, as the specific function, the function of the unit which has been replaced and thus newly attached; and

the control section controls the operation data preparation section so as to prepare the operation data, after resuming the specific function.

With the above arrangement, in case some of the attachable units to the electronic apparatus are replaced, for example, because of version up or a trouble, if the management personnel, who manages the electric apparatus (such as the service center or the service personnel), is set as the receiving end for the operation data, it is possible to surely check whether the function, which is resumed by the replacement of the unit, is fully workable. Moreover, it is also possible to timely notify the user, who uses the function, that the operation of the function, which has been temporally stopped during the replacement, is resumed after the replacement has been completed. In this way, the user is efficiently encouraged to use the function. Moreover, it is expected that a trouble can be early detected because the user, who is notified of the replacement of the unit, consciously checks for the trouble.

The electronic apparatus having the foregoing arrangement of the present invention may be further arranged that the operation data preparation section includes:

a self-diagnosis section (13, 52) for diagnosing condition of the electronic apparatus so as to prepare a self-diagnosis result, and (II) the control section (a) controls the self-diagnosis section so as to diagnoses the condition of the electronic apparatus after the provision of the service, the replacement of the part, or the attachment of the unit, and (b) controls the apparatus communications section so as to transmit the self-diagnosis result as the operation data to the predetermined receiving end.

With the above arrangement, after the provision of the service, the replacement of the part, or the attachment of the unit, the self-diagnosis section diagnoses whether the operation condition of the specific function of the electronic apparatus is above an appropriate level, whether the electronic apparatus operates in the appropriate operation condition, or how the operation condition of the electronic apparatus is after the electronic apparatus is operated for the predetermined period. Thereafter, the control section controls the apparatus communications section so as to transmit, by electronic mail, the self-diagnosis result as the operation data to the predetermined receiving end, such as the management personnel (for instance, the service center) who manages the electronic apparatus. In this way, it is possible for the electronic apparatus to automatically check the operation condition of the electronic apparatus after the provision of the service, the replacement of the part, or the attachment of the unit. Meanwhile, in accordance with the confirmation result, it is possible to response instantly if necessary, thereby providing improved services.

In addition to the above arrangements, the electronic apparatus of the present invention may be so arranged that (I) the self-diagnosis section supervises the operation condition until a predetermined condition is satisfied, and (II) the control section controls the apparatus communications section so as to transmit the self-diagnosis result as the operation data, irrespective of whether or not the predetermined condition is satisfied, in case the self-diagnosis section detects a trouble.

With the above arrangement, in case the trouble is caused, the electronic apparatus transmits the self-diagnosis result as the operation data, irrespective of whether the predetermined condition is satisfied or not. In this way, it is possible to response promptly to the trouble because the receiving end can be timely notified of the occurrence of the trouble, without bothering the user of the electronic apparatus.

By the way, in case the service is provided, or the part or the unit is replaced because of the trouble, the user of the electronic apparatus hopes the trouble is solved if possible. Even if the trouble cannot be fully solved, the user requests the condition resulted from the trouble is improved. Therefore, if the service or the replacement of the part or the unit made the condition worse, the user would be more dissatisfied, and it would lead to loss of confidence from the user, if no measures was taken.

Therefore, in addition to the above arrangements, the electronic apparatus of the present invention may be so arranged that the control section changes the predetermined condition in accordance with condition of a trouble at a time when the service is provided, when the part is replaced, or when the unit is replaced.

With the above arrangement, in accordance with the condition of the trouble, changed is the period during which the self-diagnosis section supervises the operation condition of the specific function. Therefore, where the supervision period is set to be long enough to surely detect an increase in the frequency of the occurrence of the trouble, in case the trouble occurs more frequently, and the operation data is transmitted when the trouble is detected, it is possible to promptly response to the trouble because it is possible to be timely notified that the occurrence frequency of the trouble is increased from a previous level. Moreover, in case no operation data is received, it is possible to assure that the occurrence frequency of the trouble is, at least, less than the previous level, thereby being able to clearly show the user the effect of the service, the replacement of the part, or the renewal of the unit. As a result, it is possible to establish a management system for the electronic apparatus, which can win the confidence and reliability of the user of the electronic apparatus.

In addition to the above arrangements, the electronic apparatus of the present invention may be so arranged that the operation data preparation section prepares the operation data in accordance with the operation condition of the specific function that has been carried out until the predetermined condition is satisfied.

With the above arrangement, the operation data, which indicates the operation condition of the specific function, is prepared after the specific function is operated until the specific condition is satisfied after the provision of the service. Therefore, the operation data appropriately explains the operation condition of the specific condition. In this way, it is possible to provide more appropriate service.

In addition to the above arrangements, the electronic apparatus of the present invention may be so arranged that the predetermined condition is at least one of (a) a number of times the specific function is operated after receiving the service, and (b) time passed since the provision of the service, the replacement of the part, or the attachment of the unit.

The electronic apparatus tends to have various troubles, after the service, the replacement of the part, or the attachment of the unit, according how frequently the electronic apparatus is used. With the above arrangement, however, it is possible to more promptly response to the trouble because the operation data is prepared and transmitted to the predetermined receiving end every time the operation is carried out in a certain number of times. Moreover, instead of the frequency of the usage, there are some cases the passage of time makes various parts inferior or ineffective. Therefore, it is possible to more promptly response to the trouble, with the above arrangement where the operation data is prepared and transmitted to the receiving end every time a certain period of time is passed after the service, the replacement of the part, or the attachment of the unit.

In addition to the above arrangements, the electronic apparatus of the present invention may be so arranged that the predetermined condition is changeable.

Depending how the electronic apparatus is used, the frequency of the usage and the period of the usage may be different. Therefore, in the above arrangement, it is so arranged that the predetermined condition is changeable, depending how the user uses the electronic apparatus. In this way, it is possible to more surely prepare the operation data, and thus to more promptly deal with the trouble.

In addition to the above arrangements, the electronic apparatus of the present invention may be so arranged that, in case plural parts are replaced or plural units are attached, the operation data is prepared in accordance with operation condition of a specific function of each part or unit, when all the predetermined conditions of the respective parts or units are satisfied.

With this arrangement, it is possible to transmit, at once, all pieces of the operation data of all the plural parts or units, even if the plural parts are replaced or plural units are attached, so that the parts or the units have different timing at which the predetermined condition is satisfied. As a result, the receiving end can easily move to a next step, referring to the pieces of the operation data transmitted at once. For example, the receiving end can stop to wait for the operation condition after the replacement of the parts or the attachment of the unit, so as to move to the stage to charge the cost. Moreover, in case of an arrangement where, at the time the operation data is prepared, the user is asked whether the trouble is solved, the user may be asked so many time if the operation data is transmitted separately every time each condition is satisfied. On the contrary, if all the pieces of the operation condition are transmitted at once, even with the arrangement, the user may not be asked so many time, thereby providing improved services.

In addition to the above arrangements, the electronic apparatus of the present invention may be so arranged that the operation data preparation section, at least, includes \mathring{1} a display section (21b) capable of displaying data and \mathring{2} an input section (21) capable of receiving data, and (II) the control section (a) controls the display section so as to display a message for asking to input data whether the condition of the electronic apparatus is adequate after the provision of the service, by means of the input section, and (b) controls the apparatus communications section so as to transmit, as the operation data, an input result, which has been input by means of the input section, to the predetermined receiving end.

With the above arrangement, after the provision of the service, the replacement of the part, or the attachment of the unit with respect to the electronic apparatus, the user judges whether the specific function of the electronic apparatus operates properly, whether the electronic apparatus operates properly, or how electronic apparatus operates after the electronic apparatus is operated for a predetermined period. Thereafter, the input result based on the user's judgement, as the operation data, is transmitted by electronic mail to the predetermined receiving end such as the management personnel (such as service center) who manages the electronic apparatus. In this way, it is possible to surely check whether the electronic apparatus becomes fully workable as a result of the service, the replacement of the part, or the attachment of the unit, and whether the service, the replacement of the part, or the attachment of the unit is appropriate. Meanwhile, it is possible to promptly response to a trouble, if any, thereby providing improved services.

In addition to the above arrangements, the electronic apparatus of the present invention may be so arranged that only in case the operation data preparation section prepares operation data that indicates inadequate operation condition of the electronic apparatus, the control section controls the apparatus communications section so as to transmit the operation data to the predetermined receiving end.

With the above arrangement, the management personnel (such as the service center) is notified of the operation condition (operation data) of the electronic apparatus, only in case the operation data preparation section prepares operation data that indicates operation condition which requires an additional service, that is, the inadequate operation condition, because the adequate operation condition requires no additional service, while the inadequate operation condition does. In this way, it is possible to promptly response to a trouble, if any, thereby providing still improved services.

In addition to the above arrangements, the electronic apparatus of the present invention may be so arranged that, in case the operation data preparation section prepares operation data that indicates inadequate operation condition of the electronic apparatus, the control section (a) controls the apparatus communications section so as to transmit the operation data to the predetermined receiving end, and (b) controls parts of the electronic apparatus, which causes the inadequate operation condition, so as to temporally stop to operate.

With the above arrangement, in case an additional service is required due to the inadequate operation condition, the parts, which causes the inadequate operation condition, is stopped to operate, while the operation data is transmitted to the management personnel (such as the service center). This avoids the part, which causes the trouble, from being operated continuously, thereby preventing an additional trouble such as, worsening the trouble or adversely affecting the other parts. Meanwhile, it is also possible to promptly response to a trouble, thereby providing still improved services.

In addition to the above arrangements, the electronic apparatus of the present invention may be so arranged that the control section includes a trouble notifying section (11, 21b, 51) for notifying a user, who uses the specific function, of unavailability of the specific function, when the part of the electronic apparatus, which causes the inadequate operation condition, is temporally stopped to operate.

With the above arrangement, when the part of the electronic apparatus is temporally stopped to operate so that the specific function is unavailable, the trouble notifying section notifies the user who uses the specific function. As a result, the user, who intends to use the specific function, is timely and efficiently notified that the specific function is unavailable. In addition, it is also possible to recommend the user to use an alternative apparatus, for example.

In addition to the above arrangement, the electronic apparatus of the present invention may be so arranged that the electronic apparatus is an image forming apparatus.

Because the image forming apparatus, such as a photocopying machine, requires an intensive service, it is preferable to employ the image forming apparatus as the electronic apparatus of the present invention, in accordance with the above arrangement.

In addition to the above arrangements, an electronic apparatus of the present invention may be further provided with a notifying section (11, 21b, 51) for notifying a user, who uses the specific function, of the operation condition which has been checked by the operation condition checking section, after the operation of the specific function is resumed or started.

With the above arrangement, the notifying section notifies the user how the specific function operates, so that the user, who intends to use the function, is notified timely and efficiently that the specific function becomes available, is resumed to be available, or becomes unavailable.

In addition to the arrangement, the electronic apparatus of the present invention may be so arranged that the notifying section notifies a user, who uses the specific function, at a time the operation condition is checked as normal by the operation condition checking section, after the operation of the specific function is resumed or started.

With the above arrangement, when the specific function is resumed to operate normally, the notifying section notifies the user that the specific function becomes available (is resumed to be available) so as to operate normally. In this way, the user, who intends to use the specific function, is notified timely and efficiently that the specific function becomes available or is resumed to be available, thereby being encourage to use the specific function. Meanwhile, confidence is given to the user, timely.

In addition to the above arrangements, the electronic apparatus of the present invention may be so arranged that the predetermined receiving end includes each user (7) of the specific function.

With the above arrangement, even in case the user of the electronic apparatus is distant from the location of the electronic apparatus, for example, when the electronic apparatus is used as the network printer, the operation data can be transmitted to the user so that the user is timely and efficiently notified that the specific function becomes available, is resumed to be available or becomes unavailable.

In addition to the above arrangement, the electronic apparatus of the present invention may be so arranged that, in order to transmit the operation data that indicates the operation condition, the control section selects the receiving end in accordance with the operation condition of the specific function checked by the operation condition checking section.

With the above arrangement, where the receiving end of the operation data is selected in accordance with the operation condition of the specific function, it is possible to flexibly select the receiving end for the operation data, in accordance with the operation condition. For example, the service center, the management personnel of the network including the electronic apparatus, or the user of the electronic apparatus may be selected as the receiving end for the operation data, in accordance with the operation condition. As a result, with respect to each operation condition, it is possible for the person or the apparatus that need grasp the operation condition, to grasp the operation condition promptly and precisely, in accordance with the operation data received by the person or the apparatus. In this way, even if a trouble occurs, it is possible to response to the trouble efficiently and timely.

By the way, in such an arrangement where the function of the electronic apparatus is expanded by attachment of a unit, for example, where a printer board, as the unit, is attached to the image forming apparatus so that the image forming apparatus operates as a network printer, or where an automatic document feeder is attached to the image forming apparatus so as to be able to carry out continuous photocopy, a different function is expanded depending on which unit is attached. Accordingly, a different receiving end for the operation data may have to be selected.

Therefore, in addition to the above arrangements, the electronic apparatus of the present invention may be so arranged that the control section selects the receiving end for the operation data, depending on which unit is attached.

With the above arrangement, where the control section selects the receiving end for the operation data, depending on which unit is attached, it is possible to transmit the operation data to the receiving end in accordance with the unit attached, even when the different receiving end should be selected for the operation data because the function expanded by the unit attachment is quite different. As a result, each receiving end can acquire the operation data timely and efficiently, thereby being able to promptly select a suitable response.

As discusses previously, an data communications apparatus (5) of the present invention, which is capable of being externally connected to an electronic apparatus (1c) having a specific function, is provided with (I) a communications section (51), connected to a network (3, 6), being capable of transmitting data to a predetermined receiving end (2, 4, 7, 8, 200) by electronic mail, (II) a control section (53) for controlling the transmission of the data in accordance with operation of the electronic apparatus, and (III) an operation data preparation section (21, 52) for preparing operation data that indicates operation condition of the electronic apparatus, wherein the control section (a) controls the operation data preparation section so as to prepare the operation data after operation of the specific function is resumed after the electronic apparatus is serviced, and (b) controls the communications section so as to transmit the operation data to the predetermined receiving end.

With the above arrangement, after the operation of the specific function is resumed after the electronic apparatus is serviced, the operation data preparation section prepares the operation data so that the control section transmits the operation data to the predetermined receiving end by electronic mail. Therefore, if the management personnel who manages the electronic apparatus is set as the receiving end for the operation data, it is possible to check whether or not the service is appropriate. Meanwhile, it is also possible to promptly response to a trouble, if any. Therefore, the serviceability is improved.

Especially, because the data communications apparatus can be attached externally with the electronic apparatus, it becomes possible to use the management system so as to manage the electronic apparatus having no operation data preparation function.

In addition to the above arrangements, the management system for the electronic apparatus of the present invention is provided with (I) the predetermined receiving end, and (II) the electronic apparatus having the operation data preparation section. Alternatively, the management system for the electronic apparatus of the present invention is provided with (I) the predetermined receiving end, (II) the electronic apparatus, and (III) the data communications apparatus.

In the above arrangement, the management system for the electronic apparatus is constructed with (I) the predetermined receiving end, and (II) the electronic apparatus having the operation data preparation section, or with (I) the predetermined receiving end, (II) the electronic apparatus, and (III) the data communications apparatus. This realizes a management system that can automatically transmit various data that is helpful for providing technical service, especially for an electronic apparatus (such as the image forming apparatus) that requires complicated technical service by the service personnel to solve a trouble.

In addition to the above arrangements, the management system for the electronic apparatus of the present invention may be so arranged that the predetermined receiving end includes a primary receiving end (4, 200) for receiving the operation data directly from the electronic apparatus, and a secondary receiving end \mathring{2} to which the first receiving end can transmit instruction data as to the service.

With the above arrangement, it is possible to use electronic mail so as \mathring{1} to forward to the secondary receiving end the operation data that has been transmitted to the primary receiving end, and \mathring{2} to transmit to the secondary receiving end newly prepared data for the secondary receiving end. In other words, the primary receiving end is used as a gateway so that the operation data is received at the primary receiving end first, and is transmitted to the secondary receiving end that is a terminal. Thus, if the service center is set as the primary receiving end, while the service personnel is set as the secondary receiving end, the primary receiving end can surely manage the operation condition of the electronic apparatus, while the secondary receiving end can systematically grasp how the condition of the electronic apparatus is. Therefore, it is possible to appropriately deal with a trouble, thereby providing still improved services.

In addition to the above arrangements, the management system for the electronic apparatus of the present invention may be so arranged that the primary receiving end charges for the service when receiving operation data indicative of an adequate operation of the electronic apparatus after the service.

With the above arrangement, the cost of the service is charged on condition that the electronic apparatus has been surely serviced. Therefore, the cost is charged in a manner clear to both the management personnel and the user.

In the foregoing, explanations have been given through the case where after providing the service, operation data of the electronic apparatus is transmitted to the predetermined receiving end by the electronic mail, whereby it is determined reliably if the specific function has been corrected completely by the service provided with respect to the electronic apparatus, and if more appropriate service could have been provided. Further, in an event of an occurrence of some failure even after providing the service as required, by correcting the failure promptly, it is possible to manage the electronic apparatus appropriately with improved service. However, the above effect can be achieved also by the arrangement where an electronic mail including the apparatus data indicative of the state of the electronic apparatus is transmitted to the receiving end as selected from among the plurality of predetermined receiving ends according to time and the state, so that the state of the electronic apparatus can be surely informed to the receiving end which can deal with the situation in an early stage, and an appropriate service required for dealing with the current situation of the electronic apparatus can be provided in an efficient manner, thereby managing the electronic apparatus appropriately with improved service.

Specifically, as described, the management method of an electronic apparatus of the present invention is arranged so as to include the steps of:

i) determining by the electronic apparatus (1, 1c, 100) a receiving end of a current communication process among a predetermined plurality of receiving ends (2, 2a to 2f, 4, 7, 8, 200) according to at least either one of a) a state of the electronic apparatus and b) a time at which the state of the electronic apparatus is to be informed; and

ii) preparing an electronic mail including apparatus data indicative of the state of the electronic apparatus and transmitting the electronic mail to the receiving end determined by the step i).

As described, the electronic apparatus (1, 1c, 100) of the present invention is arranged so as to include:

a mail preparation section (12) for preparing an electronic mail including apparatus data indicative of a state of the electronic apparatus;

a receiving end determination section (12) for determining a receiving end of a current communication process among a predetermined plurality of receiving ends (2, 2a to 2f, 4, 7, 8, 200) according to at least either one of a) the state of the electronic apparatus, and b) a time at which the state of the electronic apparatus is to be informed; and

a mail transmission section (11) for transmitting the electronic mail to the receiving end determined by the receiving end determination section.

The receiving end can be determined, for example, in such manner that a main receiving end and a subsidiary receiving end are set in advance, the apparatus data is transmitted to the main receiving end at every occurrence of failure, while the apparatus data may be transmitted to both of the main and subsidiary receiving ends or only the subsidiary receiving end instead of the main receiving end, in accordance with the failed state.

Examples of suitable receiving ends of the apparatus data of the electronic apparatus include a legal entity, its department (manager) which takes care of the maintenance of the electronic apparatus. By setting these managers as the respective receiving ends, it becomes possible for each of the receiving ends to appropriately manage the electronic apparatus, in response to such event as an occurrence of failure in the electronic apparatus, running out of consumable supply, an exchangeable supply being used up, etc., thereby managing the electronic apparatus more reliably as compared to the conventional management system. In many cases, however, the types of services to be provided and the opening hours differ among the receiving ends like the case of selecting a service center and a dealer as receiving ends. Therefore, although the apparatus data may be quickly transmitted by electronic mail, if the receiving end of the apparatus data is inappropriate, a longer time would be required consequently for dealing with the situation.

On the contrary, with the above arrangement, the receiving end of the current communication process is determined in accordance with at least one of the condition of the electronic apparatus and the time to notify. Moreover, the receiving end as selected receives the apparatus data of the electronic apparatus by electronic mail, i.e., in digital data.

According to the foregoing arrangement, it is possible to surely inform the state of the electronic apparatus in which, for example, a failure has occurred to the receiving end as selected from among the plurality of receiving ends, which is capable of promptly managing the failure of the electronic apparatus. It is therefore possible for each receiving end to provide an appropriate service such as to correct the failure of the electronic apparatus, for example, by sending a salesperson, or a service personnel, etc. As a result, the management system and the management method of the present invention can always provide an appropriate service required for dealing with the current situation of the electronic apparatus in an efficient manner, thereby managing the electronic apparatus in a prompt and appropriate manner.

Furthermore, by transmitting the apparatus data by electronic mail, even when setting a plurality of receiving ends, it becomes possible to transmit the apparatus data to respective receiving ends at once, and it becomes also possible to transmit the apparatus data to a receiving end at a remote location. Other effect achieved by transmitting the apparatus data in digital data is that the predetermined receiving end of the apparatus data becomes free from such problem that details of the received image (apparatus data) are blurred, unlike the case of facsimile transmission, etc., and further, it is possible to store the apparatus data for reutilization.

As described, the management system of an electronic apparatus of the present invention, which includes the electronic apparatus (1, 1c, 100) and a terminal (2e) as a receiving end, is arranged such that the receiving end (2e) includes a reply section (48) for transmitting an electronic return mail to the electronic apparatus upon receiving the electronic mail including the apparatus data from the electronic apparatus; and

the electronic apparatus includes an indication section (21b) for indicating the electronic return mail from the terminal. Here, the electronic return mail may be inductive of a receipt of the electronic mail, or may include the time required for a user at the terminal to perform the service with respect to the electronic apparatus, or the data on the user, etc.

According to the foregoing arrangement, in the wait time of the customer, for example, to the completion of the correction of a failure occurred in the electronic apparatus, the electronic return mail is transmitted from the terminal to the electronic apparatus to be indicated to a user (customer) of the electronic apparatus. It is therefore possible to transmit the data which eases the anxiety of the user, thereby providing the management system more reliable to the customer.

As described, the management method of an electronic apparatus of the present invention for an electronic apparatus (1, 1c, 100) which has a specific function, and which is connected to a predetermined receiving end (2, 2a to 2f, 4, 7, 8, 200) via a network (3, 6) so that data can be transmitted to the receiving end, the management method is arranged so as to include the steps of:

i) preparing a diagnostic result of a self-diagnosis of a state of the electronic apparatus and transmitting data including the diagnostic result from the electronic apparatus to a predetermined receiving end by electronic mail; and

ii) selecting at least one of a plurality of receiving ends as the predetermined receiving end according to the self-diagnostic result.

As described, a management system of an electronic apparatus (1, 1c, 100) of the present invention, which has a specific function, and which is connected to a predetermined receiving end (2, 2a to 2f, 4, 7, 8, 200) via a network (3, 6), is arranged such that the electronic apparatus includes:

a self-diagnosis section (13) for performing self-diagnosis and preparing a self-diagnostic result,

an apparatus communication section (11) for transmitting apparatus data including the self-diagnostic result to the predetermined receiving end, and

an apparatus control section (12) for controlling an operation of the electronic apparatus and preparing the apparatus data; and

the apparatus data control section selects at least one of a predetermined plurality of receiving ends and controls the apparatus communication section to transmit the apparatus data to the receiving end.

According to the foregoing arrangement, the state of the electronic apparatus being used, such as running out of consumable supply, an exchangeable supply being used up, an occurrence of failure in the electronic apparatus itself, which hinders a normal operation of the electronic apparatus, etc., is prepared as the self-diagnostic result of the self-diagnosis performed by the self-diagnosis section. Then, the apparatus data including the self-diagnosis result is transmitted to the predetermined receiving end by electronic mail.

In other words, the data regarding, for example, the failure occurred in the electronic apparatus is prepared based on the self-diagnosis result as accurate date, and the apparatus data of the electronic apparatus including the self-diagnosis result is transmitted by electronic mail, i.e., in digital data, so that the apparatus data is promptly and surely transmitted to the predetermined receiving end. When setting a plurality of receiving ends, it becomes possible to transmit the apparatus data to respective receiving ends at once, and it becomes also possible to transmit the apparatus data to a receiving end at a remote location.

Other effect achieved by transmitting the apparatus data in digital data is that the predetermined receiving end of the apparatus data becomes free from such problem that details of the received image (apparatus data) are blurred, unlike the case of facsimile transmission, etc., and further, it is possible to store the apparatus data for reutilization.

Therefore, by setting a legal entity or its department (manager) as respective receiving ends, it becomes possible for each manager to appropriately manage the electronic apparatus, in response to such event as an occurrence of failure in the electronic apparatus, running out of consumable supply, an exchangeable supply being used up, etc., thereby managing the electronic apparatus more reliably as compared to the conventional management system.

Furthermore, the apparatus data is transmitted to the receiving end, which is selected from among the plural predetermined receiving ends in accordance with the state of the electronic apparatus. Specifically, for example, a main receiving end and a subsidiary receiving end are set in advance, and it can be controlled such that the apparatus data is transmitted to the main receiving end at every occurrence of failure, while the apparatus data may be transmitted to both of the main and subsidiary receiving ends or only to the subsidiary receiving end instead of the main receiving end, in accordance with the failed state. It is therefore possible to always provide appropriate service for the electronic apparatus in an efficient manner.

Here, it may be arranged so as to select a receiving end of a current communication process by the data management device provided on the network from the electronic apparatus to the plurality of receiving end, instead of selecting by the electronic apparatus itself.

As described, the management method of an electronic apparatus of the present invention is arranged so as to include the steps of:

i) when a data management device receives from the electronic apparatus (1, 1c, 100) an electronic mail including apparatus data indicative of a state of the electronic apparatus, determining by the data management device (4) a receiving end of a current communication process among a predetermined plurality of receiving ends (2, 2e, 2f) according to at least either one of a) the apparatus data, and b) a time at which the apparatus data is to be informed; and

ii) preparing based on the apparatus data, an electronic mail including instruction data to be reported to the receiving end determined in the step i), and transmitting the electronic mail to the receiving end.

As described, the management system of an electronic apparatus is arranged so as to include:

a receiving end determination section (42) provided in a data management device (4), for determining a receiving end of a current communication process among a predetermined plurality of receiving ends according to at least either one of a) apparatus data indicative of a state of the electronic apparatus, and b) a time at which the apparatus data is to be informed, when receiving an electronic mail including the apparatus data indicative of the state of the electronic apparatus; and

an instruction data preparation section (43) for preparing an electronic mail including instruction data to be informed to the predetermined receiving end based on the received apparatus data.

According to the foregoing arrangement, the receiving end of the current communication process is determined not by the electronic apparatus but by the receiving end deciding section provided in the data management device, according to at least either one of a) the apparatus data indicative of the state of the electronic apparatus, and b) a time at which the apparatus data is to be informed.

As a result, as in the above-discussed electronic apparatuses and the management methods for the electronic apparatus discussed above, it is possible to surely inform the state of the electronic apparatus in which, for example, a failure has occurred to the receiving end which is capable of promptly dealing with a current situation of the electronic apparatus such as to correct the failure. It is therefore possible for each receiving end to provide an appropriate service such as to correct the failure of the electronic apparatus, for example, by sending a salesperson, or a service personnel, etc. As a result, the management system and the management method of the present invention can always provide an appropriate service for the current state of the electronic apparatus in an efficient manner, thereby managing the electronic apparatus in a prompt, appropriate and reliable manner.

The management method of an electronic apparatus having the foregoing arrangement of the present invention may be arranged so as to further include the step of: iii) extracting data related to the received apparatus data from database (46, 48, 48a) in which stored are data related to the apparatus data which are possible to be transmitted and adding the data as extracted to the instruction data. The management system of an electronic apparatus having the foregoing arrangement of the present invention may be further arranged such that the instruction data preparation section extracts data related to the received apparatus data from database (46, 48, 48a) in which stored are data related to apparatus data which are possible to be transmitted to be included in the instruction data. Examples of the data related to the apparatus data which are possible to be transmitted include history data of apparatus data or instruction data transmitted and received with respect to the same electronic apparatus, or data indicative of the correction process of a failure indicated by the apparatus data, technical data database, etc.

According to the foregoing arrangement, from the database for storing therein the data related to the apparatus data which are possible to be transmitted, the data related to the actually received apparatus data is extracted to be included in the instruction data. As a result, even if some effective data is not included in the apparatus data transmitted by the electronic apparatus which performs necessary services, the data can be compensated by extracting the necessary data from the database, and it is thus possible for the receiver of the secondary receiving end to obtain more useful instruction data to provide more appropriate services as compared to the case of receiving only the apparatus data.

Further, as long as the sufficient apparatus data for the preparation of the instruction data can be transmitted, it is not necessarily to transmit all the effective data for the necessary service. Generally, it is thus possible to reduce the required storage capacity for the electronic apparatus which are expected to be provided in larger numbers than the data management device or the database.

The management system of an electronic apparatus having the foregoing arrangement of the present invention may be further arranged such that:

the database stores therein history data of the electronic apparatus, and

the management system further includes a registration section (42) for registering in the database data related to the instruction data as history data. Examples of the data related to the instruction data include the data for use in making an access to the instruction data or the instruction data itself, etc.

According to the foregoing arrangement, the registration section registers as history data, the data related to the instruction data prepared according to the apparatus data received by the receiving end determination section. Therefore, even in the arrangement where a plurality of receiving ends are set, and thus the electronic apparatus is not necessarily be managed consistently by the receiver at the same receiving end, all the data related to the instruction data are collected in the database, and thus the electronic apparatus can be managed reliably. As a result, it is possible for the receiver at the receiving end to systematically recognize the current situation of the electric apparatus including the services performed by other receivers in the past.

The management system of an electronic apparatus having each of the foregoing arrangements of the present invention, may be further arranged such that in a case where a receiving end of data indicative of the state of a same electronic apparatus is changed, the receiving end determination section transmits the instruction data also to a previous receiving end.

According to the foregoing arrangement, even if the failed state of the electronic apparatus changes as time passes, the instruction data is continually transmitted always to the specific receiving end. It is therefore possible for the receiver of the receiving end to precisely recognize the state of the electronic apparatus. As a result, it is possible to deal with the current state of the electronic apparatus in still more appropriate and efficient manner.

The management system of an electronic apparatus having each of the foregoing arrangements may be further arranged such that upon receiving the electronic mail informing of the state of the electronic apparatus, the receiving end determination section determines an achievement level of a performance performed by a service personnel at a terminal of the previous receiving end, and if the achievement level is below a predetermined level, changes the receiving end to another terminal. The achievement level indicates, for example, the correction level of failure, a level of reduction in the frequency an failure occurs, etc.

According to the foregoing arrangement, when it is determined that the achievement level of a performance with regard to the required service is lower than the predetermined level, the electronic mail is transmitted to a terminal of another service personnel instead of the terminal of the service personnel previously in charge whose technical level is expected to be the same and thus an achievement level would still be low if requesting him to perform the service again to deal with the failure of the same kind. In this way, it becomes possible to more reliably deal with the failure of the same kind.

The management system of an electronic apparatus having the foregoing arrangement of the present invention may be further arranged so as to include:

an evaluation database (46, 48, 48a) for storing therein data on evaluated technical level of a service personnel at each terminal,

wherein the receiving end determination section determines a terminal of a service personnel as a service personnel currently in charge whose evaluated technical level is higher than that of a service personnel previously in charge.

According to the foregoing arrangement, when the achievement level of the performance with regard to the requested service is low, a service personnel whose technical level is higher than that of the service personnel previously in charge would be selected. It is therefore possible to deal with the current situation still more reliably to correct the failure of the same kind.

The management system of an electronic apparatus having the foregoing arrangement of the present invention may be further arranged so as to include:

an evaluation section (49) for storing time data indicative of time required for a service performed by the service personnel at the terminal of the receiving end of the instruction data and evaluating a technical level of each service personnel based on the time data.

According to the foregoing arrangement, in the case where an evaluated technical level of each service personnel is updated based on time data indicative of time required for a service performed by the service personnel at the terminal of the receiving end of the instruction data. It is therefore possible to recognize the current technical level of each service personnel, and thus to determine the receiving end more appropriately.

In replace of the structure of changing the receiving end, the management system of an electronic apparatus having the foregoing arrangement of the present invention may be arranged such that:

upon receiving the electronic mail informing of the state of the electronic apparatus, the instruction data preparation section determines an achievement level of a performance performed by a service personnel at a terminal of the previous receiving end, and if the achievement level is below a predetermined level, prepares more detailed instruction data than that of the instruction data used previously.

According to the foregoing arrangement, when it is determined that the achievement level of a performance with regard to the required service is lower than the predetermined level, more detailed instruction data is transmitted to the same terminal of the service personnel previously in charge whose technical level is expected to be the same. In this way, an achievement level would be low if the service personnel performs the service based on the same data as that used in the previously performed service, by providing him with more detailed instruction data, it becomes possible to more reliably deal with the failure of the same kind.

The management system of an electronic apparatus of the present invention having each of the foregoing arrangements may be arranged so as to further include:

a transmission section (11) provided in the electronic apparatus, for transmitting an electronic mail indicative of the state of the electronic apparatus,

wherein the transmission means transmits an electronic mail indicative of a performance of a specific function of the electronic apparatus, whose failure has been corrected by the service personnel, after resuming the specific function.

According to the foregoing arrangement, after resuming the specific function of the electronic apparatus with respect to which the service has been provided, it is possible to check reliably if the specific function has been corrected completely by the service provided with respect to the electronic apparatus, and if more appropriate service could have been provided. Further, in an event of an occurrence of some failure even after providing the service as required, by correcting the failure promptly, it is possible to manage the electronic apparatus appropriately with improved service. In the foregoing arrangement, the structure of transmitting an electronic mail, and the structure of checking the state of the electronic apparatus are almost the same as the arrangement of preparing an electronic mail including the apparatus data, and it is therefore possible to prevent the apparatus to have too complicated structure.

The management system of an electronic apparatus of the present invention having each of the foregoing arrangements, may be further arranged so as to include:

a reply section (48) provided at either one of the data management device and the receiving end, for transmitting an electronic return mail when the data management device receives an electronic mail from the electronic apparatus; and an indication section (21b) provided in the electronic apparatus, for indicating the electronic return mail. In this structure, in the case where the reply section is provided at a terminal, it may be arranged such that the reply section transmits the electronic return mail directly to the electronic apparatus, or an electronic return mail may be transmitted indirectly to the electronic apparatus via the data management device, etc.

According to the foregoing arrangement, in the wait time of the customer, for example, to the completion of the correction of a failure occurred in the electronic apparatus, the electronic return mail is transmitted from the terminal to the electronic apparatus to be indicated to a user (customer) of the electronic apparatus. It is therefore possible to transmit the data which eases the anxiety of the user, thereby providing the management system more reliable to the customer.

The management system of an electronic apparatus may be realized by a hardware, or by executing a program in a computer. Specifically, the program of the present invention operates a computer as:

a receiving end determination section (42) for determining a receiving end of a current communication process among a predetermined plurality of receiving ends (2, 2e, 2f) according to at least either one of a) apparatus data indicative of a state of the electronic apparatus (1, 1c, 100) and b) a time at which the apparatus data is to be informed; and

an instruction data preparation section (43) for preparing an electronic mail including instruction data to be informed to the receiving end, based on the received apparatus data. On the recording medium of the present invention, the foregoing program is recorded.

By executing the foregoing program in the computer, the system including the computer can be operated as the management system of the electronic apparatus including the data management device. Therefore, as in the management system of the electronic apparatus, it is possible to always provide an appropriate service required for dealing with the current situation of the electronic apparatus in an efficient manner, thereby managing the electronic apparatus quickly and appropriately.

A management method of an electronic apparatus for an electronic apparatus (1, 1c, 100) which has a specific function, and which is connected to a predetermined receiving end (2, 2e, 2f) via a network (3, 6) is arranged so as to include the steps of:

i) performing a self-diagnosis of a state of the electronic apparatus and preparing a diagnostic result;

ii) transmitting data including at least the diagnostic result from the electronic apparatus to the data management device by electronic mail;

iii) selecting a predetermined receiving end by the data management device among a plurality of secondary receiving ends based on the apparatus data received; and

iv) transmitting instruction data prepared based on the apparatus data to the receiving end selected in the step iii).

The management system of an electronic apparatus (1, 1c, 100) for an electronic apparatus which has a specific function and which is connected to a predetermined receiving end (2, 2a to 2f, 4, 7, 8, 200) via a network (3, 6), the management system may be arranged so as to include:

a data management device (4) serving as the predetermined receiving end, for receiving apparatus data from the electronic apparatus, the data management device being capable of transmitting the data to other receiving end by electronic mail; and

a plurality of secondary receiving ends (2e, 2f) serving as the other receiving end, to be connected to the data management device via a network,

wherein the electronic apparatus includes:

a self-diagnosis section (13) for performing a self-diagnosis and preparing a self-diagnostic result, and

an apparatus communication section (11, 51) for transmitting apparatus data including the self-diagnostic result; and

the data management device (4) includes:

a management communications section (41) for performing communication with the electronic apparatus and the secondary receiving end by electronic mail, an instruction data preparation section (43) for preparing instruction data to be transmitted to the secondary receiving end based on the apparatus data received by electronic mail from the electronic apparatus; and

a management control section (42) for controlling overall operations of the data management device and controlling so as to select a specific receiving end among the plurality of secondary receiving ends and transmitting by the management communications section prepared instruction data to the receiving end selected.

According to the foregoing arrangement, the apparatus data including the self-diagnosis result of the electronic apparatus is transmitted to the data management device by electronic mail in the form of digital data, to be temporarily stored therein. In the data management device, instruction data is prepared based on the apparatus data, and the resulting instruction data is transmitted to the secondary receiving end by electronic mail. Namely, the data management device which functions as the gateway transmits the apparatus data temporally stored therein to the secondary receiving end after processing the apparatus data into the instruction data.

According to the foregoing arrangement, it is possible for the receiver of the secondary receiving end to systematically recognize the current situation of the electronic apparatus, and for the data management device to reliably manage the electronic apparatus according to the current situation. Therefore, in an event of an occurrence of trouble in the electronic apparatus, the receiver of the secondary receiving end receives the instruction data obtained by further processing the apparatus data. It is therefore possible for the receiver of the secondary receiving end to provide more appropriate service for the current state of the electronic apparatus, thereby managing the electronic apparatus still more reliably with an improved accuracy as compared to the case of conventional management system.

Furthermore, with the above arrangement, the receiving end which can more appropriately deal with the current situation of the electronic apparatus is selected from among a plurality of secondary receiving ends according to the apparatus data, i.e., the state of the electronic apparatus, and the instruction data is transmitted to the receiving end as selected. It is possible to always provide an appropriate service required for dealing with the current situation of the electronic apparatus in an efficient manner.

The management system of an electronic apparatus having the foregoing arrangement of the present invention may be arranged such that:

the data management device further includes either an input section (44) which permits additive data to be input from an exterior section or a memory section (46, 48, 48a) for storing therein additive data; and

the instruction data preparation section of the data management device prepares instruction data by adding the additive data to the received apparatus data.

According to the foregoing arrangement, various additive data can be added to the instruction data, for example. It is therefore possible for the receiver of the secondary receiving end of the instruction data to more smoothly deal with the current situation of the electric apparatus. For example, advice for adjusting, checking the electronic apparatus can be input as additive data, and the received additive data as classified by the kind of the apparatus data can be stored in the memory section, thereby selecting the additive data as necessary from the memory section to be added to the instruction data.

The management system of an electronic apparatus having the foregoing arrangement of the present invention may be further arranged such that:

the additive data is history data on the electronic apparatus of a transmitting end of the apparatus data.

According to the foregoing arrangement, the history data such as support history, etc., is added to the instruction data, and it is therefore possible for the receiver of the instruction data to deal with the situation in reference to the history data on the adjustment or checking of the electronic apparatus performed in the past.

The management system of an electronic apparatus having the foregoing arrangement of the present invention may be further arranged such that:

the data management device further includes a timer (45, 45a) for keeping time; and

the data management device selects a specific receiving end among the plurality of secondary receiving ends based on a time at which the apparatus data is received from the electronic apparatus.

According to the foregoing arrangement, upon receiving the apparatus data from the electronic apparatus, the receiving end which can more appropriately deal with the current situation of the electronic apparatus is selected from among a plurality of secondary receiving ends, and the instruction data is transmitted to the receiving end as selected. It is possible to provide in any time period, an appropriate service required for dealing with the current situation of the electronic apparatus in an efficient manner.

The management system of an electronic apparatus having the foregoing arrangement of the present invention may be further arranged such that assuming that previously received apparatus data is “former apparatus data”, and apparatus data received from the same electronic apparatus after receiving the former apparatus data as “latter apparatus data”, then the management control section transmits latter instruction data prepared based on received latter apparatus data as additive data to the secondary receiving end of the former instruction data prepared based on the former apparatus data.

According to the foregoing arrangement, even if the failed state of the electronic apparatus changes as time passes, the instruction data is consistently transmitted always to the specific receiving end. It is therefore possible for the receiver of the receiving end to precisely recognize the state of the electronic apparatus. As a result, it is possible to deal with the current state of the electronic apparatus in still more appropriate and efficient manner.

The management system of an electronic apparatus having the foregoing arrangement of the present invention may be arranged such that:

the management communications section of the data management device is capable of transmitting an electronic mail to an electronic apparatus of a receiving end of the apparatus data; and

the data management device includes a return mail data preparation section (47) for preparing return mail data to be transmitted to the electronic apparatus of the receiving end.

According to the foregoing arrangement, in the wait time of the customer, for example, to the completion of the correction of a failure occurred in the electronic apparatus, the electronic return mail is transmitted from the data management device to the electronic apparatus. It is therefore possible to transmit the data which eases the anxiety of the user, thereby providing the management system more reliable to the customer.

The management system of an electronic apparatus having the foregoing arrangement of the present invention may be further arranged such that:

the return mail data includes receipt confirmation data for confirming receipt of apparatus data.

According to the foregoing arrangement, the apparatus data is almost automatically transmitted from the electronic apparatus. Therefore, although it would not be clear if the apparatus data has been received by the data management device of the receiving end, by transmitting the receipt confirmation data as return mail data, it becomes possible to clearly confirm on the side of the customer if the apparatus data has been received.

The management system of an electronic apparatus having the foregoing arrangement of the present invention may be arranged such that:

the return mail data includes management data including at least one of time data indicative of time required for management, data on person in charge of the management, account data indicative of a cost of receiving the management, and management method data for directly managing a state of the electronic apparatus.

According to the foregoing arrangement, by incorporating various data other than the receiving confirmation data, it is possible to inform the user beforehand of the rough idea of the necessary service for the correction of the failure. As a result, the necessary service for the correction of the failure can be provided in more efficient manner. Moreover, if it is possible to deal with the situation to correct the failure on the side of the user, the return mail data with the data indicative of the fixing process in detail may be transmitted. In this way, it is possible to reduce the cost required for the support service.

The management system of an electronic apparatus having the foregoing arrangement of the present invention may be further arranged such that:

the secondary receiving end is capable of transmitting an electronic mail at least to the data management device; and

the return mail data preparation section of the data management device prepares additive data attachable to the return mail data based on the data received from the secondary receiving end and adds the additive data to the return mail data.

According to the foregoing arrangement, for example, it is possible for the service personnel of the secondary receiving end to transmit to the data management device, his travel time to the place of installation of the electronic apparatus (i.e., at a location of the customer). Further, it is possible on the side of the data management device to inform the customer (electronic apparatus) of the estimated time of arrival of the service personal with the return mail data. Therefore, the reliability on the side of the user can be improved, and further, the problem of receiving too many inquires from the user by telephone, etc., on the support request can be avoided. As a result, it becomes possible to more reliably deal with the current situation at low cost.

The management system of an electronic apparatus having the foregoing arrangement of the present invention may be further arranged such that:

the data management device includes a communication report management section (46, 48, 48a) for collectively managing apparatus data transmitted from the electronic apparatus;

when confirming that the apparatus data including the self-diagnostic result is transmitted twice or more times within a predetermined time, the communication report management section prepares content confirmed as a management result and outputs the management result to the management control section, and the management control section controls so as to change a transmission process of instruction data to the secondary receiving end.

According to the foregoing arrangement, the process of transmitting the instruction data to the secondary receiving end is changed based on the result of management. Therefore, upon receiving the apparatus data including the self-diagnostic result twice or more times, the instruction data which permits the situation to be dealt with in more efficient manner to correct the failure may be prepared, or the receiving end of the instruction data to be changed. As a result, it becomes possible to more reliably manage the electronic apparatus.

The management system of an electronic apparatus having the foregoing arrangement of the present invention may be further arranged such that:

the transmission process of instruction data is changed by the management control section either i) by controlling the instruction data preparation section to add more detailed data to the instruction data or ii) by controlling so as to change the secondary receiving end of the instruction data.

With the above arrangement, where the more detailed data is added to the instruction data so as to give more information to the receiver of the secondary receiving end, it is possible to more reliably deal with the failure of the same kind. Moreover, it is also possible to change the secondary receiving end to a receiver who can more reliably deal with the failure. In this way, it becomes possible to still more reliably deal with the current situation of the electronic apparatus to correct the failure of the same kind.

The management system of an electronic apparatus having the foregoing arrangement of the present invention may be arranged such that:

the additive data is technique-related data on the electronic apparatus of a transmitting end of the apparatus data.

According to the foregoing arrangement, by adopting the technique-related data on the electronic apparatus as detailed additive data, it becomes possible on the side of the receiver to more reliably deal with the current situation of the electronic apparatus to correct the failure.

The management system of an electronic apparatus having the foregoing arrangement of the present invention may be further arranged such that:

the data management device includes memory means for storing therein engineer's data regarding an engineer set for each secondary receiving end and evaluation data on technical skills of each engineer; and

the management control section controls so as to change the secondary receiving end based on the engineer's data and the evaluation data.

According to the foregoing arrangement, it is possible to more clearly determine the technical level of each receiver of the secondary receiving end based on the evaluation data and the engineer's data. As a result, a receiver who can still more reliably deal with the current situation of the electronic apparatus to correct the failure can be selected with ease.

Irrespectively of whether the data management device is provided or not, the management system of the electronic apparatus having each of the foregoing arrangements may be arranged such that plural numbers of the electronic apparatus are provided, and the apparatus data includes electronic apparatus specific data for use in specifying each electronic apparatus.

According to the foregoing arrangement, the data for use in specifying the electronic apparatus is included in the apparatus data, and it is therefore possible to clearly identify the electronic apparatus of the receiving end of the apparatus data among the plurality of electronic apparatuses. With this structure, it is also possible to transmit the instruction data to the data terminal which can more reliably manage the specific electronic apparatus. Further, in the case where a plurality of data terminals are set, by selecting the data terminal which can more reliably manage the specific electronic apparatus and transmitting the instruction data to the data terminal as selected, it becomes possible to more reliably manage each electronic apparatus.

The management system of an electronic apparatus having each of the foregoing arrangements of the present invention may be arranged such that:

the electronic apparatus includes apparatus control section for controlling an operation of the electronic apparatus and preparing the apparatus data; and

the apparatus data control section determines if the apparatus data is to be transmitted to the predetermined receiving end based on the self-diagnostic result.

According to the foregoing arrangement, the apparatus control section determines if the transmission of the apparatus data by the apparatus communications section is permitted based on the self-diagnosis result. Therefore, for example, when the prepared self-diagnostic result is indicative of a failure which can be corrected on the side of the user in the electronic apparatus, it can be arranged so as not to transmit the electronic mail to the manager of a predetermined receiving end. On the other hand, in the case where the failure occurred in the electronic apparatus cannot be managed on the side of the user, the electronic mail can be transmitted to the manager to request him for the necessary service for the correction of the failure.

The management system of an electronic apparatus having the foregoing arrangement of the present invention may be arranged such that:

the electronic apparatus further includes a timer (15) for keeping time; and

the apparatus data control section controls to select a receiving end of the apparatus data among a plurality of receiving ends according to a time the self-diagnostic result is prepared.

According to the foregoing arrangement, the receiving end is determined according to a time at which self-diagnostic result is prepared. Therefore, by dividing one day into several time periods, and setting a receiving end for each time period, it is possible to transmit the apparatus data to an appropriate receiving end in any time period. As a result, the electronic apparatus can be managed according to its current situation in more appropriate and efficient manner.

The management system of an electronic apparatus having each of the foregoing arrangements of the present invention may be arranged such that:

plural numbers of the electronic apparatus and plural numbers of the receiving end are provided; and

each of the plural number electronic apparatuses is provided with a predetermined receiving end as a main receiving end.

According to the foregoing arrangement, by setting the corresponding receiving end for each electronic apparatus according to the kind (type, category, etc.) of the electronic apparatus, it becomes possible to set a predetermined person or department in charge of the specific electronic apparatus. It is therefore possible to provide consistent services to the specific electronic apparatus, also possible for the receiver of the receiving end to provide prompt, accurate and consistent services to the specific electronic apparatus.

The management system of an electronic apparatus of the present invention having the foregoing arrangement of the present invention may be arranged such that:

the electronic apparatus further includes a display section (21b);

the apparatus communication section is capable of receiving an electronic mail from a predetermined receiving end; and

the apparatus data control section controls the display section so as to display at least data regarding transmission and receiving of an electronic mail by the apparatus communication section.

According to the foregoing arrangement, various data regarding the transmission and receiving of electronic mail can be displayed in the display section, and thus, for example, the result of determination as to whether or not the apparatus data is to be transmitted, or the return mail data transmitted from the receiving end can be displayed in the display section.

The management system of an electronic apparatus having the foregoing arrangement of the present invention may be arranged such that:

the predetermined receiving end or secondary receiving end is a data terminal capable of inputting and outputting data.

According to the foregoing arrangement, data can be input and output at the predetermined receiving end or secondary receiving end as data terminal. It is therefore possible, for example, to transfer the received electronic mail (apparatus data) to be output to another receiving end, and further to add new data as input or as prepared based on the apparatus data to be added to the electronic apparatus when transferring the received electronic mail, when required. Namely, it is possible to utilize the apparatus data as processed as required for the management on the side of the receiving end, it is possible to more reliably manage the electronic apparatus as compared to the case of the conventional management system.

The management system of an electronic apparatus having the foregoing arrangement of the present invention may be further arranged such that:

the self-diagnostic result in the apparatus data includes at least one of a failed state, an adjustment state of an operation of the electronic apparatus, a remaining amount of a consumable supply, and a life of an exchangeable supply, according to a type and a kind of the electronic apparatus.

For the maintenance of the electronic apparatus, a failed state, an adjustment state of an operation of the electronic apparatus, a remaining amount of a consumable supply, and a life of an exchangeable supply are the most important matters. Therefore, by incorporating these data in the self-diagnostic result, it becomes possible to manage the electronic apparatus in more efficient manner according to the current situation of the electronic apparatus.

The management system of an electronic apparatus having the foregoing arrangement of the present invention may be arranged such that:

the apparatus data includes installation place data regrading an installation place of the electronic apparatus.

According to the foregoing arrangement, the installation place of the electronic apparatus can be clearly specified, and, it is therefore possible for the service personnel to surely visit the installation place in a short period of time. As a result, the electronic apparatus can be managed in still more appropriate manner.

The management system of an electronic apparatus having the arrangement of the present invention may be arranged such that:

the installation place data includes at least either one of address data of the installation place of the electronic apparatus, and customer data related to a user or a user manager of the electronic apparatus.

According to the foregoing arrangement, the installation place data includes at least either one of address data of the installation place of the electronic apparatus, and customer data related to a user or a user manager of the electronic apparatus. It is therefore possible for the receiving end of the instruction data including the installation place data to clearly recognize the installation place of the electronic apparatus. As a result, the electronic apparatus can be managed in still more appropriate manner.

The management system of an electronic apparatus having the foregoing arrangement of the present invention may be further arranged such that:

the electronic apparatus is an image forming apparatus.

The foregoing arrangement of the foregoing arrangement can be desirably applied to the image forming apparatus such as a copying machine, etc., which requires delicate maintenance service.

The data communication device of the present invention externally connectible to an electronic apparatus having a specific function, which includes a communication section connected to a network, which permits data to be transmitted to a predetermined receiving end by electronic mail, and a control section for controlling transmission of data according to an operation of the electronic apparatus may be arranged so as to further include:

an electronic apparatus diagnosis section for performing a self-diagnosis of a state of the electronic apparatus and preparing a diagnostic result,

wherein the control section selects at least one of a predetermined plurality of receiving ends, and controls so as to transmit the apparatus data including the self-diagnostic result by the communication section to the selected receiving end.

According to the foregoing arrangement, the state of the electronic apparatus is diagnosed by the electronic apparatus diagnosis section, and it is determined if the apparatus data including the diagnostic result is to be transmitted. Then, when it is determined that the apparatus data is to be transmitted, the apparatus data is transmitted to the predetermined receiving end by electronic mail using the network. Therefore, even in an event of an occurrence of failure in the electronic apparatus, the state of the electronic apparatus can be transmitted to the predetermined receiving end, and it is therefore possible for the receiving end to provide appropriate service to the electronic apparatus. As a result, the electronic apparatus can be managed still more reliably by means of the electronic mail as compared to the conventional management system.

Moreover, the apparatus data can be transmitted to the appropriate receiving end as selected from the plurality of receiving ends according to the state of the electronic apparatus. As a result, the electronic apparatus can be always managed appropriately as required for dealing with the current situation of the electronic apparatus in an efficient manner.

Furthermore, according to the foregoing arrangement, the data communication device is attachable onto the electronic apparatus, and thus the foregoing management system permits even the electronic apparatus without the self-diagnosis function to be managed.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A management method of an electronic apparatus, comprising the steps of:
i) determining by said electronic apparatus a receiving end of a current communication process among a predetermined plurality of receiving ends according to at least either one of a) a state of said electronic apparatus and b) a time at which the state of said electronic apparatus is to be informed; and
ii) preparing an electronic mail including apparatus data indicative of the state of said electronic apparatus and transmitting the electronic mail to the receiving end determined by said step i).

2. An electronic apparatus, comprising:
mail preparation means for preparing an electronic mail including the apparatus data indicative of a state of said electronic apparatus;
receiving end determination means for determining a receiving end of a current communication process among a predetermined plurality of receiving ends, according to at least either one of a) a state of said electronic apparatus and b) a time at which the state of said electronic apparatus is to be informed; and
mail transmission means for transmitting the electronic mail to the receiving end determined by said receiving end determination means.

3. A management system of an electronic apparatus, which includes an electronic apparatus and a terminal, wherein said electronic apparatus includes:
mail preparation means for preparing an electronic mail including apparatus data indicative of a state of said electronic apparatus,
receiving end determination means for determining a receiving end of a current communication process among a predetermined plurality of receiving ends according to at least either one of a) a state of said electronic apparatus and b) a time at which the state of said electronic apparatus is to be informed,
mail transmission means for transmitting the electronic mail to the receiving end determined by said receiving end determination means, and
indication means for positing an electronic mail from said terminal; and
said terminal includes:
reply means for transmitting an electronic return mail to said electronic apparatus upon receiving the electronic mail including the apparatus data from said electronic apparatus.

4. The management system of an electronic apparatus as set forth in claim 3, wherein:
a self-diagnostic result in the apparatus data includes at least one of a failed state, an adjustment state of an operation of said electronic apparatus, a remaining amount of a consumable supply, and a life of an exchangeable supply, according to a type and a kind of said electronic apparatus.

5. The management system of an electronic apparatus as set forth in claim 3, wherein:
the apparatus data includes installation place data indicative of an installation place of said electronic apparatus.

6. The management system of an electronic apparatus as set forth in claim 5, wherein:
said installation place data includes at least either one of address data of the installation place of said electronic apparatus, and customer data related to a user or a user manager of said electronic apparatus.

7. The management system of an electronic apparatus as set forth in claim 3, wherein:
said electronic apparatus is an image forming apparatus.

8. A management method of an electronic apparatus for an electronic apparatus which has a specific function, and which is connected to a predetermined receiving end via a network so that data can be transmitted to the receiving end, said management method comprising the steps of:
i) preparing a diagnostic result of a self-diagnosis of a state of said electronic apparatus and transmitting data including the diagnostic result from said electronic apparatus to a predetermined receiving end by electronic mail; and
ii) selecting at least one of a plurality of receiving ends as the predetermined receiving end according to the self-diagnostic result.

9. A management system of an electronic apparatus which has a specific function, and which is connected to a predetermined receiving end via a network so that data can be transmitted to the receiving end, wherein said electronic apparatus includes:
self-diagnosis means for performing self-diagnosis and preparing a self-diagnostic result,
apparatus communication means for transmitting apparatus data including the self-diagnostic result to the predetermined receiving end, and
apparatus control means for controlling an operation of said electronic apparatus and preparing the apparatus data; and
said apparatus control means selects at least one of a predetermined plurality of receiving ends and controls said apparatus communication means to transmit the apparatus data to the receiving end.

10. The management system of an electronic apparatus as set forth in claim 9, wherein:
plural numbers of said electronic apparatus are provided; and
the apparatus data includes electronic apparatus identification data for identifying each electronic apparatus.

11. The management system of an electronic apparatus as set forth in claim 9, wherein:
said electronic apparatus includes apparatus control means for controlling an operation of said electronic apparatus and preparing the apparatus data; and
said apparatus control means determines if the apparatus data is to be transmitted to the predetermined receiving end based on the self-diagnostic result.

12. The management system of an electronic apparatus as set forth in claim 9, wherein:
said electronic apparatus further includes a timer for keeping time; and
said apparatus control means controls to select a receiving end of the apparatus data among the plurality of receiving ends according to a time the self-diagnostic result is prepared.

13. The management system of an electronic apparatus as set forth in claim 9, wherein:
plural numbers of said electronic apparatus and plural numbers of said receiving end are provided; and
each of said plural numbers of said electronic apparatus is provided with a predetermined receiving end as a main receiving end.

14. The management system of an electronic apparatus as set forth in claim 9, wherein:
said electronic apparatus further includes display means;
said apparatus communication means is capable of receiving an electronic mail from a predetermined receiving end; and
said apparatus control means controls display means so as to display at least data regarding a transmission and receiving of an electronic mail by said apparatus communication means.

15. The management system of an electronic apparatus as set forth in claim 9, wherein:
said predetermined receiving end is a data terminal capable of inputting and outputting data.

16. The management system of an electronic apparatus as set forth in claim 9, wherein:
the self-diagnostic result in the apparatus data includes at least one of a failed state, an adjustment state of an operation of said electronic apparatus, a remaining amount of a consumable supply, and a life of an exchangeable supply, according to a type and a kind of said electronic apparatus.

17. The management system of an electronic apparatus as set forth in claim 9, wherein:
the apparatus data includes installation place data indicative of an installation place of said electronic apparatus.

18. The management system of an electronic apparatus as set forth in claim 17, wherein:
said installation place data includes at least either one of address data of the installation place of said electronic apparatus, and customer data related to a user or a user manager of said electronic apparatus.

19. The management system of an electronic apparatus as set forth in claim 9, wherein:
said electronic apparatus is an image forming apparatus.

20. A management method of an electronic apparatus, comprising the steps of:
i) when a data management device receives from said electronic apparatus an electronic mail including apparatus data indicative of a state of said electronic apparatus, determining by said data management device a receiving end of a current communication process among a predetermined plurality of receiving ends according to at least either one of a) the apparatus data and b) a time at which the apparatus data is to be informed; and
ii) preparing based on the apparatus data, an electronic mail including instruction data to be reported to the receiving end determined in said step i), and transmitting the electronic mail to the receiving end.

21. The management method of an electronic apparatus as set forth in claim 20, further comprising the step of:
iii) extracting data related to the received apparatus data from database in which stored are data related to the apparatus data which are possible to be transmitted and adding the data as extracted to the instruction data.

22. A management system of an electronic apparatus, comprising:
receiving end determination means provided in a data management device, for determining a receiving end of a current communication process among a predetermined plurality of receiving ends according to at least either one of a) apparatus data indicative of a state of said electronic apparatus and b) a time at which the apparatus data is to be informed, when receiving an electronic mail including the apparatus data indicative of the state of said electronic apparatus; and
instruction data preparation means for preparing an electronic mail including instruction data to be informed to the predetermined receiving end based on the received apparatus data.

23. The management system of an electronic apparatus as set forth in claim 22, wherein:
said instruction data preparation means extracts data related to the received apparatus data from database in which stored are data related to apparatus data which are possible to be transmitted, to be included in the instruction data.

24. The management system of an electronic apparatus as set forth in claim 23, wherein:
said database stores therein history data of said electronic apparatus, and
said management system further comprises registration means for registering in said database data related to the instruction data as history data.

25. The management system of an electronic apparatus as set forth in claim 22, wherein:
in a case where a receiving end of data indicative of a state of a same electronic apparatus has been changed, said receiving end determination means transmits the instruction data also to a previous receiving end.

26. The management system of an electronic apparatus as set forth in claim 22, wherein:
upon receiving the electronic mail informing of the state of said electronic apparatus, said receiving end determination means determines an achievement level of a performance performed by a service personnel at a terminal of the previous receiving end, and if the achievement level is below a predetermined level, changes the receiving end to another terminal.

27. The management system of an electronic apparatus as set forth in claim 26, further comprising:
an evaluation database for storing therein data on evaluated technical level of a service personnel at each terminal,
wherein said receiving end determination means determines a terminal of a service personnel as a service personnel currently in charge whose evaluated technical level is higher than that of a service personnel previously in charge.

28. The management system of an electronic apparatus as set forth in claim 27, further comprising:
evaluation means for storing time data indicative of time required for a service performed by the service personnel at the terminal of the receiving end of the instruction data and evaluating a technical level of each service personnel based on the time data.

29. The management system of an electronic apparatus as set forth in claim 22, wherein:
upon receiving the electronic mail informing of the state of said electronic apparatus, said instruction data preparation means determines an achievement level of performances performed by a service personnel at a terminal of the previous receiving end, and if the achievement level is below a predetermined level, prepares more detailed instruction data than the instruction data used previously.

30. The management system of an electronic apparatus as set forth in claim 22, further comprising:
transmission means provided in said electronic apparatus, for transmitting an electronic mail indicative of the state of said electronic apparatus,
wherein said transmission means transmits an electronic mail indicative of a performance of a specific function of said electronic apparatus, whose failure has been corrected by the service personnel, after resuming said specific function.

31. The management system of an electronic apparatus as set forth in claim 22, further comprising:
reply means provided at either one of said data management device and said receiving end, for transmitting an electronic return mail when said data management device receives an electronic mail from said electronic apparatus; and
indication means provided in said electronic apparatus, for indicating the electronic return mail.

32. The management system of an electronic apparatus as set forth in claim 22, wherein:
the self-diagnostic result of the apparatus data includes at least one of a failed state, an adjustment state of an operation of said electronic apparatus, a remaining amount of a consumable supply, and a life of an exchangeable supply, according to a type and a kind of said electronic apparatus.

33. The management system of an electronic apparatus as set forth in claim 22, wherein:
the apparatus data includes installation place data indicative of an installation place of said electronic apparatus.

34. The management system of an electronic apparatus as set forth in claim 33, wherein:
said installation place data includes at least either one of address data of the installation place of said electronic apparatus, and customer data related to a user or a user manager of said electronic apparatus.

35. The management system of an electronic apparatus as set forth in claim 22, wherein:
said electronic apparatus is an image forming apparatus.

36. A program for operating a computer as:
receiving end determination means for determining a receiving end of a current communication process among a predetermined plurality of receiving ends according to at least either one of a) apparatus data indicative of a state of said electronic apparatus and b) a time at which the apparatus data is to be informed; and
instruction data preparation means for preparing an electronic mail including instruction data to be informed to the receiving end, based on the received apparatus data.

37. A recording medium storing said program of claim 36.

38. A management method of an electronic apparatus which has a specific function, and which is connected to a predetermined receiving end via a network, said management method comprising the steps of:
i) performing a self-diagnosis of a state of said electronic apparatus and preparing a diagnostic result;
ii) transmitting data including at least the diagnostic result from said electronic apparatus to said data management device by electronic mail;
iii) selecting a predetermined receiving end by said data management device among a plurality of secondary receiving ends based on the received apparatus data; and
iv) transmitting instruction data prepared based on the apparatus data to the receiving end selected in said step iii).

39. A management system of an electronic apparatus for an electronic apparatus which has a specific function and which is connected to a predetermined receiving end via a network, said management system, comprising:
a data management device serving as the predetermined receiving end, for receiving apparatus data from said electronic apparatus, said data management device being capable of transmitting the data to other receiving end by electronic mail; and
a plurality of secondary receiving ends serving as said other receiving end, to be connected to said data management device via a network,
wherein said electronic apparatus includes:
self-diagnosis means for performing a self-diagnosis and preparing self-diagnostic result, and
apparatus communication means for transmitting apparatus data including the self-diagnostic result; and
said data management device includes:
management communication means for performing communication with said electronic apparatus and with said secondary receiving end by electronic mail,
instruction data preparation means for preparing instruction data to be transmitted to said secondary receiving end based on the apparatus data received by electronic mail from the electronic apparatus, and
management control means for controlling overall operations of said data management device and controlling so as to select a specific receiving end among the plurality of secondary receiving ends and transmitting by said management communication means, prepared instruction data to said receiving end selected.

40. The management system of an electronic apparatus as set forth in claim 39, wherein:
said data management device further includes either input means which permits additive data to be input from an exterior section or memory means for storing additive data; and
said instruction data preparation means of said data management device prepares instruction data by adding the additive data to the received apparatus data.

41. The management system of an electronic apparatus as set forth in claim 40, wherein:
said additive data is history data on said electronic apparatus of a transmitting end of the apparatus data.

42. The management system of an electronic apparatus as set forth in claim 39, wherein:
said data management device further includes a timer for keeping time; and
said data management device selects a specific receiving end among the plurality of secondary receiving ends based on a time at which the apparatus data is received from said electronic apparatus.

43. The management system of an electronic apparatus as set forth in claim 39, wherein:
assuming that previously received apparatus data is “former apparatus data”, and apparatus data received from the electronic apparatus after receiving the former apparatus data as “latter apparatus data”, then said management control section transmits latter instruction data prepared based on received latter apparatus data as additive data to the secondary receiving end of the former instruction data prepared based on the former apparatus data.

44. The management system of an electronic apparatus as set forth in claim 39, wherein:
said management communication means of said data management device is capable of transmitting an electronic mail to an electronic apparatus of a transmitting end of the apparatus data; and
said data management device includes return mail data preparation means for preparing return mail data to be transmitted to said electronic apparatus of the transmitting end.

45. The management system of an electronic apparatus as set forth in claim 44, wherein:
said return mail data includes receipt confirmation data for confirming receipt of apparatus data.

46. The management system of an electronic apparatus as set forth in claim 44, wherein:
said return mail data includes management data including at least one of time data indicative of time required for management, data on person in charge of the management, account data indicative of a cost of receiving the management, and management method data for directly managing a state of said electronic apparatus.

47. The management system of an electronic apparatus as set forth in claim 44, wherein:
said secondary receiving end is capable of transmitting an electronic mail at least to said data management device; and
said return mail data preparation means of said data management device prepares additive data attachable to the return mail data based on the data received from said secondary receiving end and adds the additive data to the return mail data.

48. The management system of an electronic apparatus as set forth in claim 39, wherein:
said data management device includes communication report management means for collectively managing apparatus data transmitted from said electronic apparatus;
when confirming that the apparatus data including the self-diagnostic result is transmitted twice or more times within a predetermined time, said communication report management means prepares content confirmed as a management result and outputs the management result to said management control section; and
said management control means controls so as to change a transmission process of instruction data to said secondary receiving end.

49. The management system of an electronic apparatus as set forth in claim 48, wherein:
the transmission process of instruction data is changed by said management control means either i) by controlling said instruction data preparation means to add more detailed data to the instruction data or ii) by controlling so as to change the secondary receiving end of the instruction data.

50. The management system of an electronic apparatus as set forth in claim 49, wherein:
said additive data is technique-related data on said electronic apparatus of a transmitting end of the apparatus data.

51. The management system of an electronic apparatus as set forth in claim 49, wherein:
said data management device includes memory means for storing therein engineer's data regarding an engineer set for each secondary receiving end and evaluation data on technical skills of the engineer; and
said management control means controls so as to change the secondary receiving end based on the engineer's data and the evaluation data.

52. The management system of an electronic apparatus as set forth in claim 39, wherein:
plural numbers of said electronic apparatus are provided, and the apparatus data includes electronic apparatus specific data for use in specifying each electronic apparatus.

53. The management system of an electronic apparatus as set forth in claim 39, wherein:
said electronic apparatus includes apparatus control means for controlling an operation of said electronic apparatus and preparing the apparatus data; and
said apparatus control means determines if the apparatus data is to be transmitted to the predetermined receiving end based on the self-diagnostic result.

54. The management system of an electronic apparatus as set forth in claim 39, wherein:
said electronic apparatus further includes a timer for keeping time, and
apparatus control means for controlling an operation of said electronic apparatus and preparing the apparatus data; and
said apparatus control means controls to select a receiving end of the apparatus data among the plurality of receiving ends according to a time the self-diagnostic result is prepared.

55. The management system of an electronic apparatus as set forth in claim 39, wherein:
plural numbers of said electronic apparatus and plural numbers of said receiving end are provided; and
each of said plural numbers of said electronic apparatus is provided with a predetermined receiving end as a main receiving end.

56. The management system of an electronic apparatus as set forth in claim 39, wherein:
said electronic apparatus further includes display means;
said apparatus communication means is capable of receiving an electronic mail from a predetermined receiving end; and
said apparatus control means controls display means so as to display at least data regarding transmission and receiving of an electronic mail by said apparatus communication means.

57. The management system of an electronic apparatus as set forth in claim 39, wherein:
said predetermined receiving end or secondary receiving end is a data terminal capable of inputting and outputting data.

58. The management system of an electronic apparatus as set forth in claim 39, wherein:
said self-diagnostic result in the apparatus data includes at least one of a failed state, an adjustment state of an operation of said electronic apparatus, a remaining amount of a consumable supply, and a life of an exchangeable supply, according to a type and a kind of said electronic apparatus.

59. The management system of an electronic apparatus as set forth in claim 39, wherein:
the apparatus data includes installation place data regrading an installation place of said electronic apparatus.

60. The management system of an electronic apparatus as set forth in claim 59, wherein:
said installation place data includes at least either one of address data of the installation place of said electronic apparatus, and customer data related to a user or a user manager of said electronic apparatus.

61. The management system of an electronic apparatus as set forth in claim 39, wherein:
said electronic apparatus is an image forming apparatus.

62. A data communication device externally connectiable to an electronic apparatus having a specific function, comprising:
communications means connected to a network, which permits data to be transmitted to a predetermined receiving end by electronic mail;
control means for controlling transmission of data according to an operation of said electronic apparatus; and
electronic apparatus diagnosis means for performing a self-diagnosis of a state of said electronic apparatus and preparing a diagnostic result,
wherein said control means controls so as to select at least one of the plurality of receiving ends as said predetermined receiving end, and controls so as to transmit the apparatus data including the self-diagnostic result by said communication means to the selected receiving end.
